(19) United States
(12) Patent Application Publication
(10) Pub. No.: US 2024/0036530 A1
(43) Pub. Date: Feb. 1, 2024

(54) INFRASTRUCTURE OPTIMIZATION CONTROLLED BY REINFORCEMENT-LEARNING-BASED AGENT CONTROLLERS

(71) Applicant: VMWARE, INC., Palo Alto, CA (US)

(72) Inventors: MARIUS VILCU, Arlington, MA (US); SHASHI KUMAR, Bangalore (IN); MADAN SINGHAL, Pune (IN); NICHOLAS MARK GRANT STEPHEN, Saint Martin d'Uriage (FR); Jad EI-Zein, Herndon, VA (US)

(21) Appl. No.: 17/970,697

(22) Filed: Oct. 21, 2022

(30) Foreign Application Priority Data
Jul. 26, 2022 (IN) 202241042725

(51) Int. Cl. G05B 13/02

(52) U.S. Cl. CPC G05B 13/027

(57) ABSTRACT

The current document is directed to reinforcement-learning-based controllers and managers that control distributed applications and the infrastructure environments in which they run. The reinforcement-learning-based controllers and managers are both referred to as “management-system agents” in this document. Management-system agents are initially trained in simulated environments and specialized training environments before being deployed to live, target distributed computer systems. The management-system agents deployed to live, target distributed computer systems operate in a controller mode, in which they do not explore the control-state space or attempt to learn better policies and value functions, but instead produce traces that are collected and stored for subsequent use. Each deployed management-system agent is associated with a twin training agent that uses the collected traces produced by the deployed management-system agent for updating and learning optimized policies and value functions, which are then transferred to the deployed management-system agent.

### RELATED APPLICATIONS

Benefit is claimed under 35 U.S.C. 119(a)-(d) to Foreign Application Serial No. 202241042725 filed in India entitled “INFRASTRUCTURE OPTIMIZATION CONTROLLED BY REINFORCEMENT-LEARNING-BASED AGENT CONTROLLERS”, on Jul. 26, 2022, by VMware, Inc., which is herein incorporated in its entirety by reference for all purposes.

The present application (Attorney Docket No. H729.03) is related in subject matter to U.S. patent application Ser. No. ______ (Attorney Docket No. H729.04), U.S. patent application Ser. No. ______ (Attorney Docket No. H729.05), which is incorporated herein by reference.

### TECHNICAL FIELD

The current document is directed to management of distributed computer systems and, in particular, to reinforcement-learning-based controllers and/or reinforcement-learning-based managers, both referred to as “management-system agents,” that control distributed applications and the infrastructure environments in which they run.

### BACKGROUND

During the past seven decades, electronic computing has evolved from primitive, vacuum-tube-based computer systems, initially developed during the 1940s, to modern electronic computing systems in which large numbers of multi-processor servers, work stations, and other individual computing systems are networked together with large-capacity data-storage devices and other electronic devices to produce geographically distributed computing systems with hundreds of thousands, millions, or more components that provide enormous computational bandwidths and data-storage capacities. These large, distributed computing systems are made possible by advances in computer networking, distributed operating systems and applications, data-storage appliances, computer hardware, and software technologies. However, despite all of these advances, the rapid increase in the size and complexity of computing systems has been accompanied by numerous scaling issues and technical challenges, including technical challenges associated with communications overheads encountered in parallelizing computational tasks among multiple processors, component failures, and distributed-system management. As new distributed-computing technologies are developed, and as general hardware and software technologies continue to advance, the current trend towards ever-larger and more complex distributed computing systems appears likely to continue well into the future.

As the complexity of distributed computing systems has increased, the management and administration of distributed computing systems has, in turn, become increasingly complex, involving greater computational overheads and significant inefficiencies and deficiencies. In fact, many desired management-and-administration functionalities are becoming sufficiently complex to render traditional approaches to the design and implementation of automated management and administration systems impractical, from a time and cost standpoint, and even from a feasibility standpoint. Therefore, designers and developers of various types of automated management and control systems related to distributed computing systems are seeking alternative design-and-implementation methodologies, including machine-learning-based approaches. The application of machine-learning technologies to the management of complex computational environments is still in early stages, but promises to expand the practically achievable feature sets of automated administration-and-management systems, decrease development costs, and provide a basis for more effective optimization Of course, administration-and-management control systems developed for distributed computer systems can often be applied to administer and manage standalone computer systems and individual, networked computer systems.

### SUMMARY

The current document is directed to reinforcement-learning-based controllers and managers that control distributed applications and the infrastructure environments in which they run. The reinforcement-learning-based controllers and managers are both referred to as “management-system agents” in this document. Management-system agents are initially trained in simulated environments and specialized training environments before being deployed to live, target distributed computer systems. The management-system agents deployed to live, target distributed computer systems operate in a controller mode, in which they do not explore the control-state space or attempt to learn better policies and value functions, but instead produce traces that are collected and stored for subsequent use. Each deployed management-system agent is associated with a twin training agent that uses the collected traces produced by the deployed management-system agent for updating and learning optimized policies and value functions, which are then transferred to the deployed management-system agent.

### BRIEF DESCRIPTION OF THE DRAWINGS

FIG. 1 provides a general architectural diagram for various types of computers.

FIG. 2 illustrates an Internet-connected distributed computer system.

FIG. 3 illustrates cloud computing. In the recently developed cloud-computing paradigm, computing cycles and data-storage facilities are provided to organizations and individuals by cloud-computing providers.

FIG. 4 illustrates generalized hardware and software components of a general-purpose computer system, such as a general-purpose computer system having an architecture similar to that shown in FIG. 1.

FIGS. 5A-B illustrate two types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates virtual-machine components of a virtual-data-center management server and physical servers of a physical data center above which a virtual-data-center interface is provided by the virtual-data-center management server.

FIG. 9 illustrates a cloud-director level of abstraction. In FIG. 9, three different physical data centers 902-904 are shown below planes representing the cloud-director layer of abstraction 906-908.

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds.

FIGS. 11A-C illustrate an application manager.

FIG. 12 illustrates, at a high level of abstraction, a reinforcement-learning-based application manager controlling a computational environment, such as a cloud-computing facility.

FIG. 13 summarizes the reinforcement-learning-based approach to control.

FIGS. 14A-B illustrate states of the environment.

FIG. 15 illustrates the concept of belief.

FIGS. 16A-B illustrate a simple flow diagram for the universe comprising the manager and the environment in one approach to reinforcement learning.

FIG. 17 provides additional details about the operation of the manager, environment, and universe.

FIG. 18 provides a somewhat more detailed control-flow-like description of operation of the manager and environment than originally provided in FIG. 16A.

FIG. 19 provides a traditional control-flow diagram for operation of the manager and environment over multiple runs.

FIG. 20 illustrates certain details of one class of reinforcement-learning system.

FIG. 21 illustrates learning of a near-optimal or optimal policy by a reinforcement-learning agent.

FIG. 22 illustrates one type of reinforcement-learning system that falls within a class of reinforcement-learning systems referred to as “actor-critic” systems.

FIG. 23 illustrates the Open Systems Interconnection model (“OSI model”) that characterizes many modern approaches to implementation of communications systems that interconnect computers.

FIGS. 24A-B illustrate a layer-2-over-layer-3 encapsulation technology on which virtualized networking can be based.

FIG. 25 illustrates virtualization of two communicating servers.

FIG. 26 illustrates a virtual distributed computer system based on one or more distributed computer systems.

FIG. 27 illustrates components of several implementations of a virtual network within a distributed computing system.

FIG. 28 illustrates a number of server computers, within a distributed computer system, interconnected by physical local area network.

FIG. 29 illustrates a virtual storage-area network (“VSAN”).

FIG. 30 illustrates fundamental components of a feed-forward neural network.

FIGS. 31A-J illustrate operation of a very small, example neural network.

FIGS. 32A-C show details of the computation of weight adjustments made by neural-network nodes during backpropagation of error vectors into neural networks.

FIGS. 33A-B illustrate neural-network training.

FIGS. 34A-F illustrate a matrix-operation-based batch method for neural-network training.

FIG. 35 provides a high-level diagram for a management-system agent that represents one implementation of the currently disclosed methods and systems.

FIG. 36 illustrates the policy neural network II and value neural network V that are incorporated into the management-system agent discussed above with reference to FIG. 35.

FIGS. 37A-C illustrate traces and the generation of estimated rewards and estimated advantages for the steps in each trace.

FIG. 38 illustrates how the optimizer component of the management-system agent (3416 in FIG. 34) generates a loss gradient for backpropagation into the policy neural network II.

FIG. 39 illustrates a data structure that represents the trace-buffer component of the management-system agent.

FIGS. 40A-H and FIGS. 41A-F provide control-flow diagrams for one implementation of the management-system agent discussed above with reference to FIGS. 35-39.

FIGS. 42A-E illustrate configuration of a management-system agent.

FIGS. 43A-C illustrate how a management-system agent learns optimal or near-optimal policies and optimal or near-optimal value functions, in certain implementations of the currently disclosed methods and systems.

FIGS. 44A-E provide control-flow diagrams that illustrate one implementation of the management-system-agent configuration and training methods and systems discussed above with reference to FIGS. 43A-C for management-system agents discussed above with reference to FIGS. 35-41F.

### DETAILED DESCRIPTION

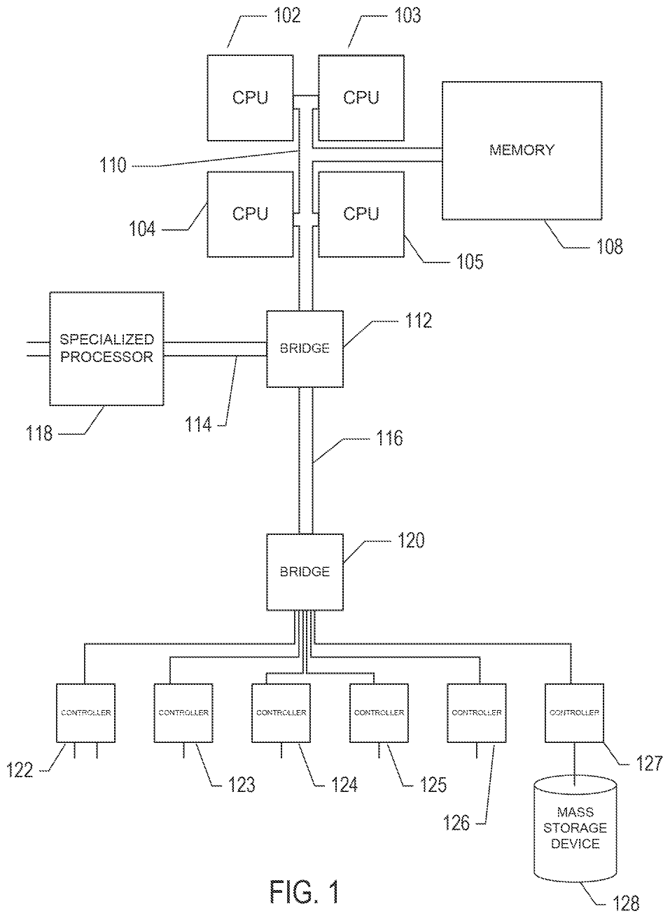

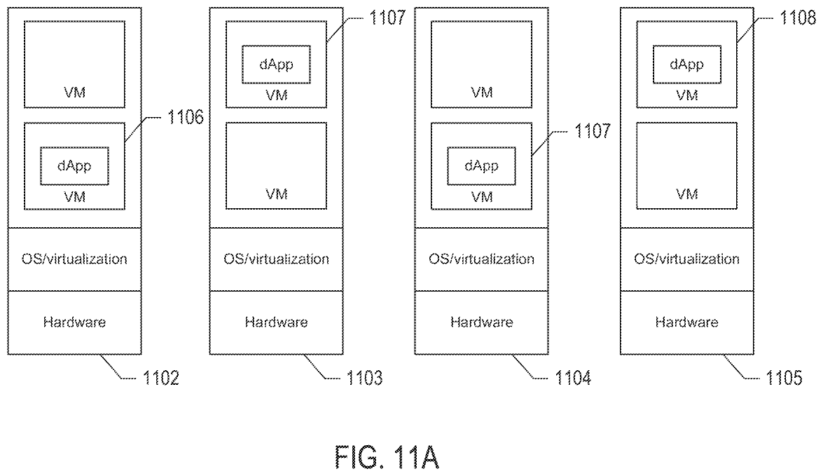

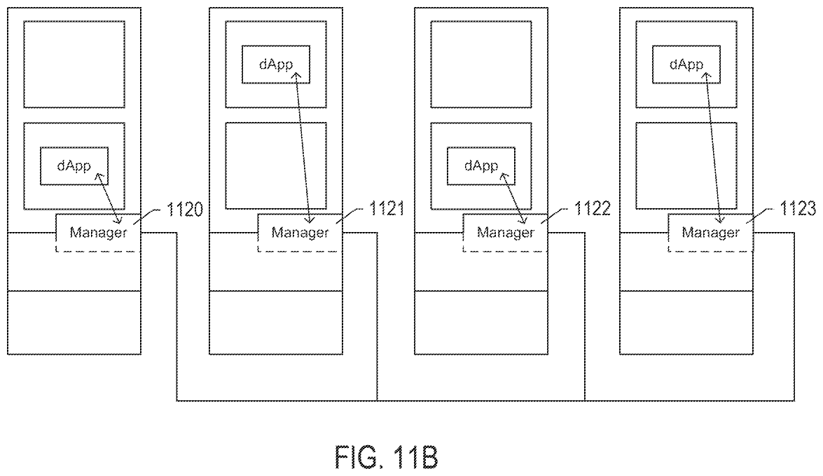

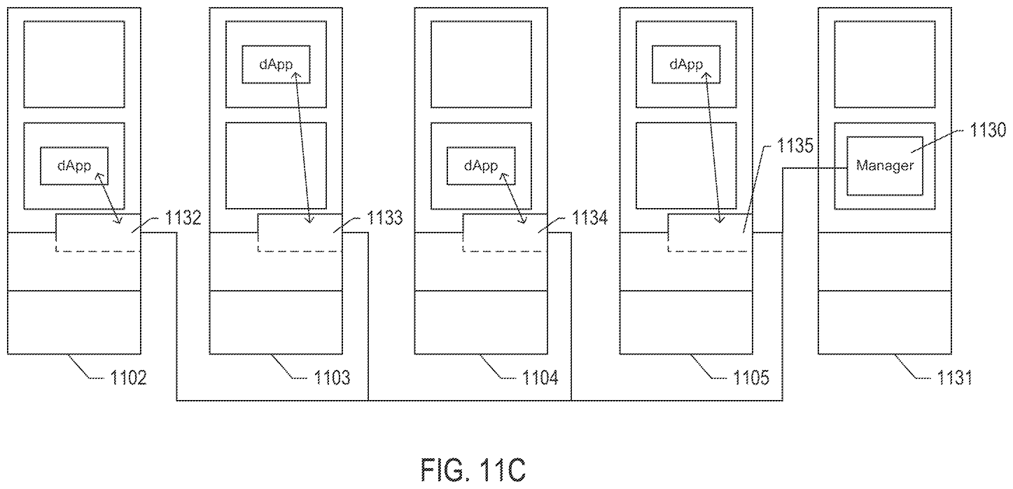

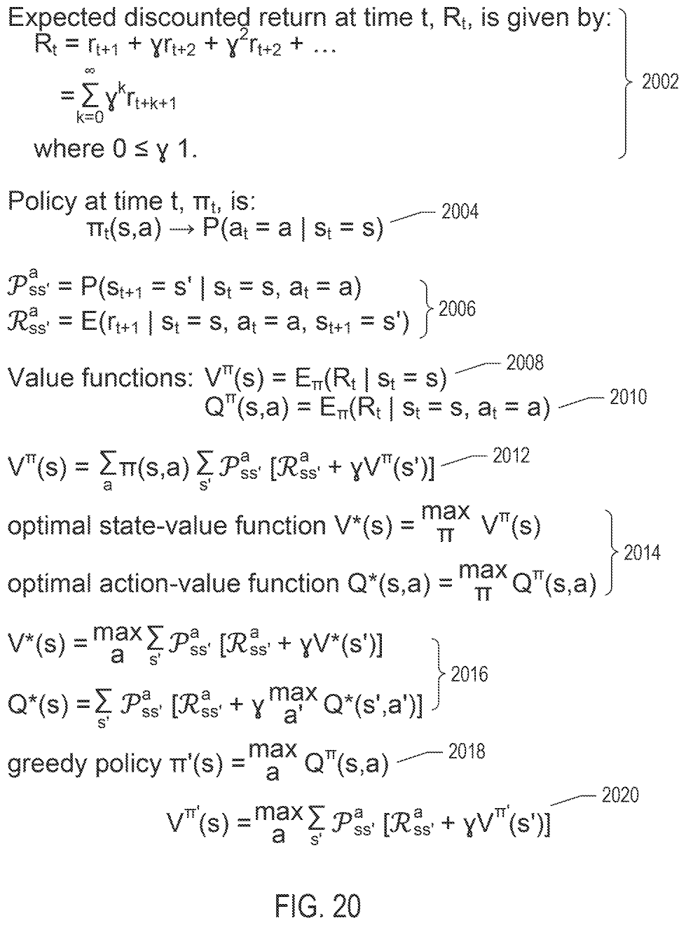

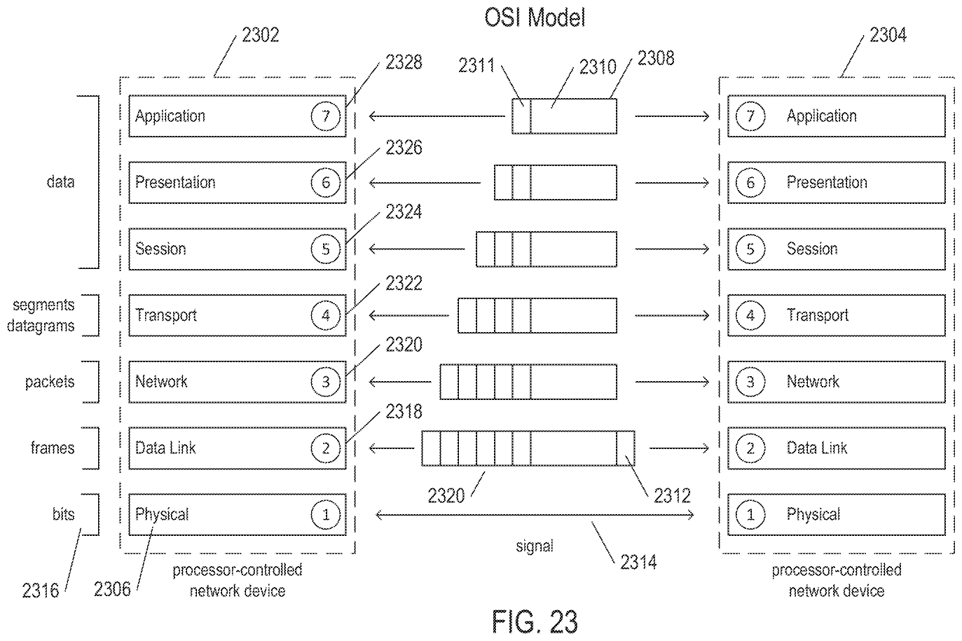

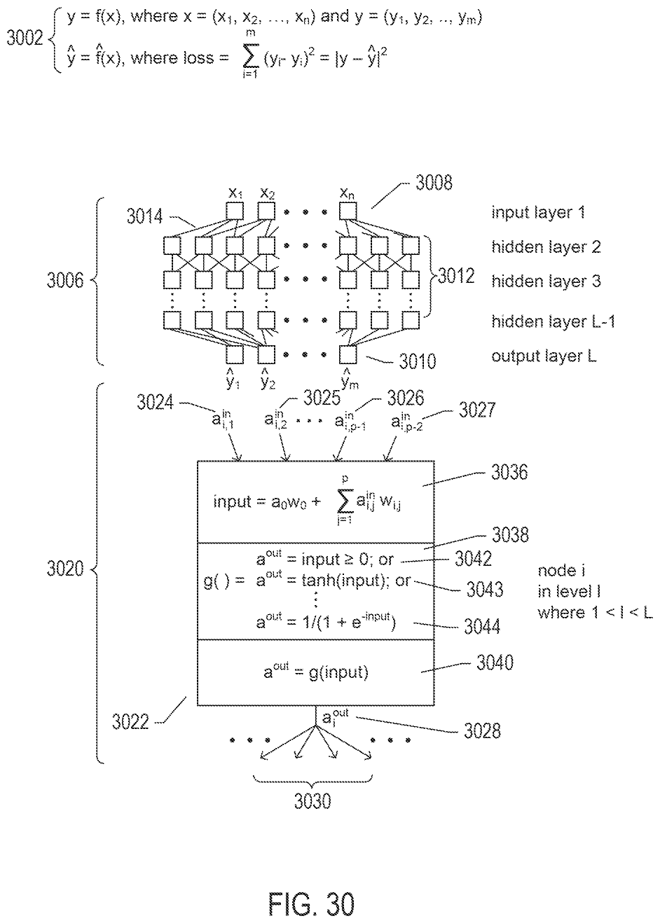

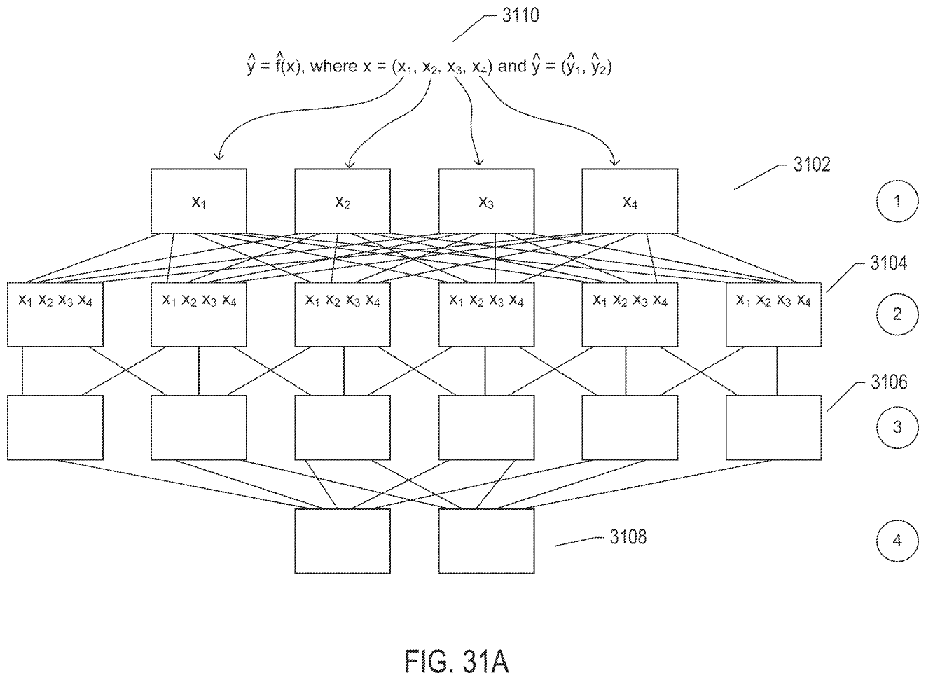

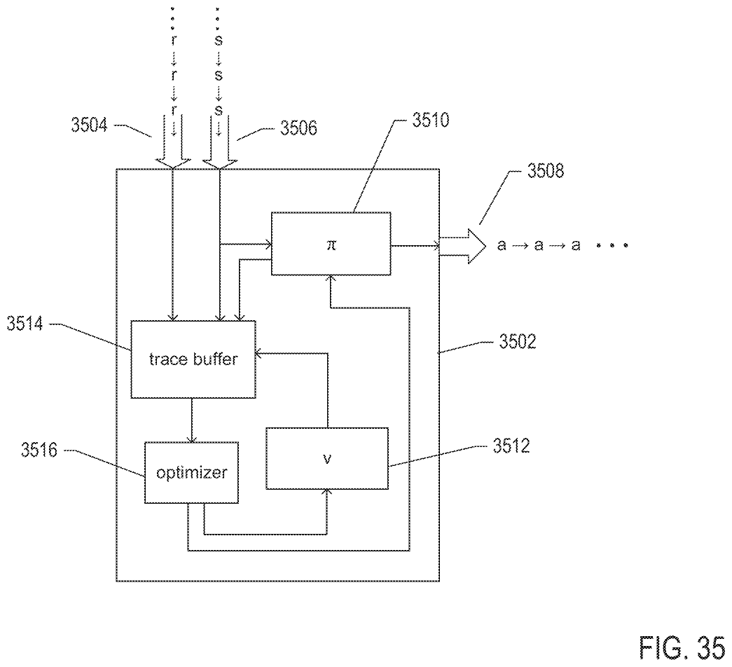

The current document is directed to reinforcement-learning-based controllers and managers that control distributed applications and the infrastructure environments in which they run. In a first subsection, below, a detailed description of computer hardware, complex computational systems, and virtualization is provided with reference to FIGS. 1-11. In a second subsection, application management and reinforcement learning are discussed with reference to FIGS. 11-19. In a third subsection, actor-critic reinforcement learning is discussed with reference to FIGS. 20-22. In a fourth subsection, virtual networking and virtual storage area networks are discussed with reference to FIGS. 23-29. In a fifth subsection, neural networks are discussed with reference to FIGS. 30-34F. In a sixth subsection, the currently disclosed methods and systems are discussed with reference to FIGS. 35-44E.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. Computers that receive, process, and store event messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

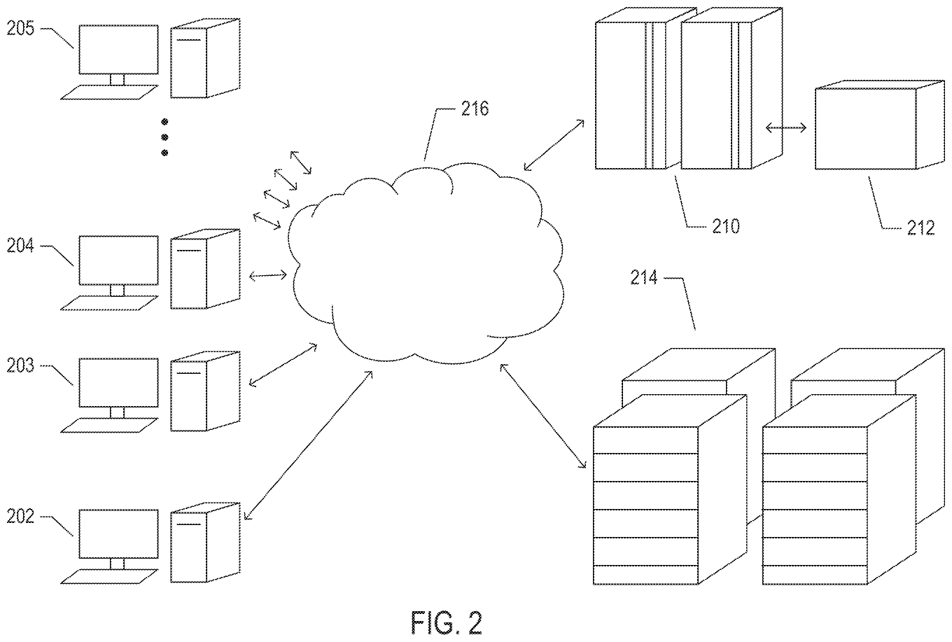

FIG. 2 illustrates an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

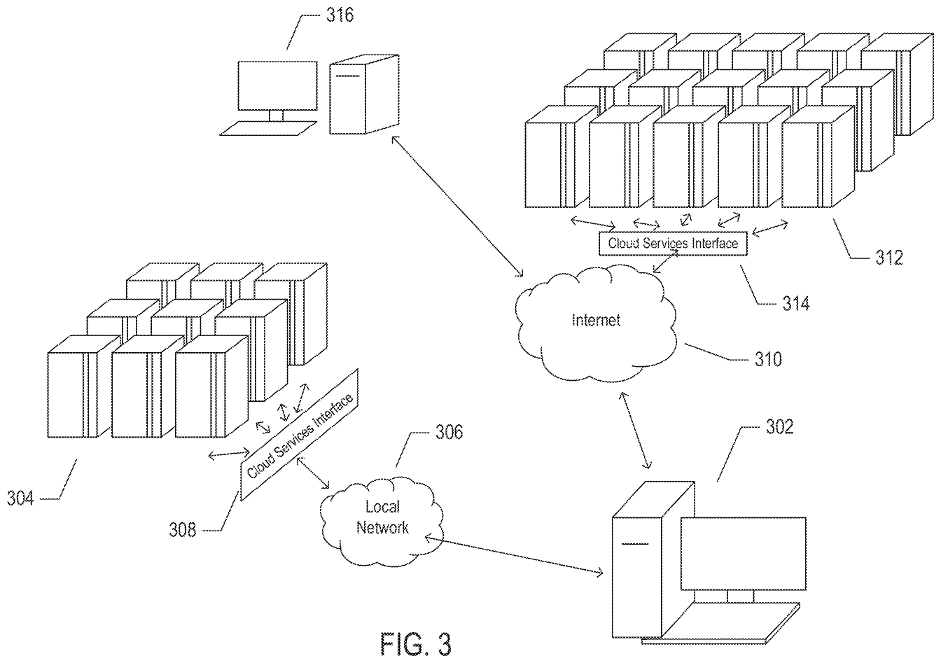

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

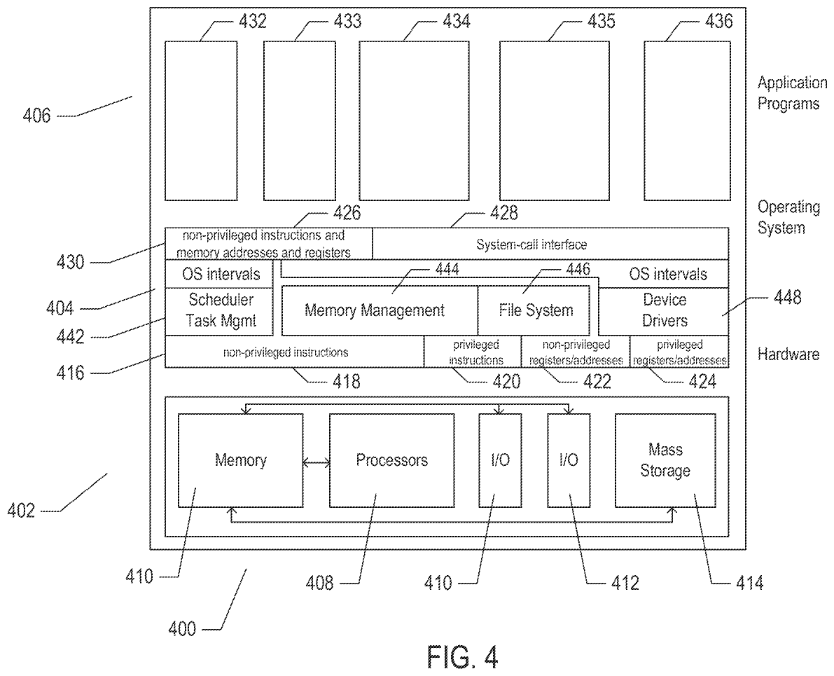

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

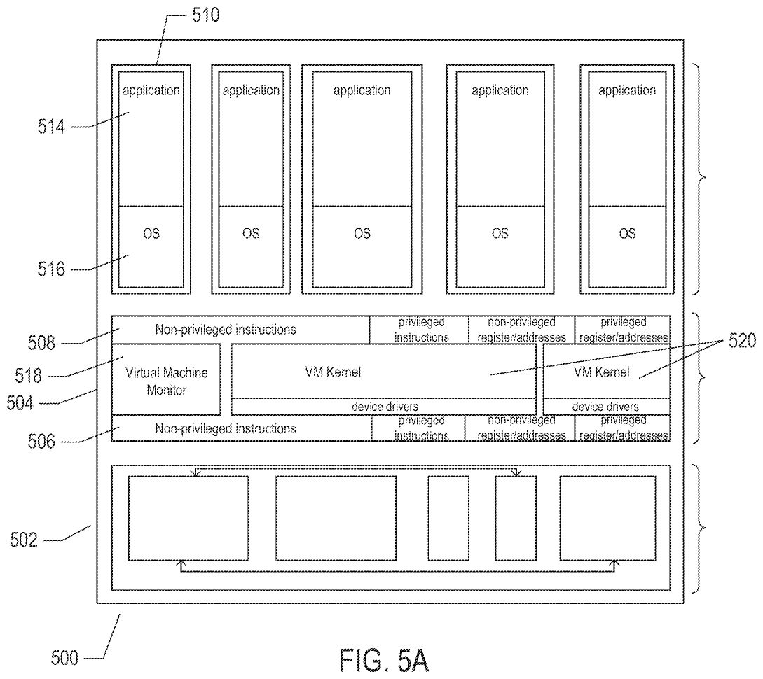

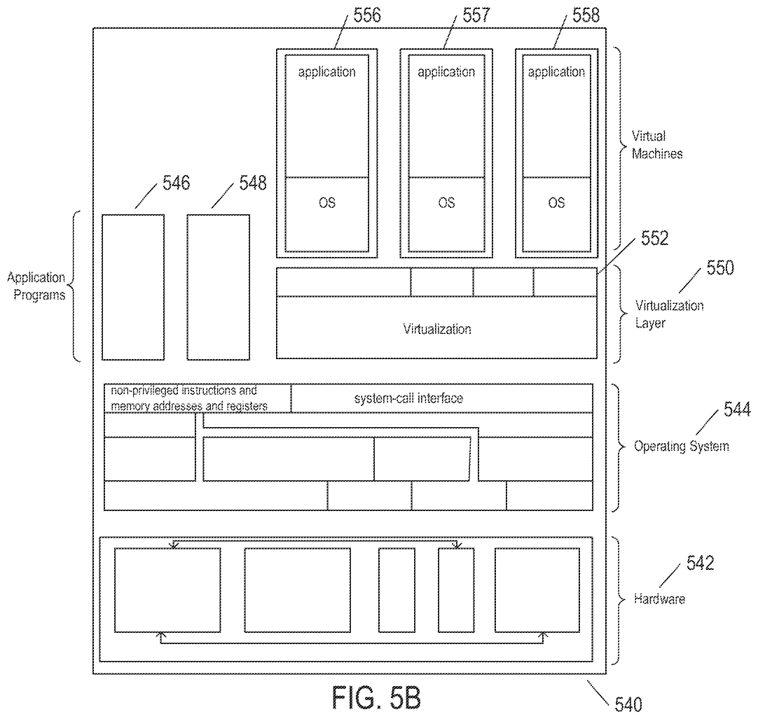

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-B illustrate two types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

In FIGS. 5A-B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

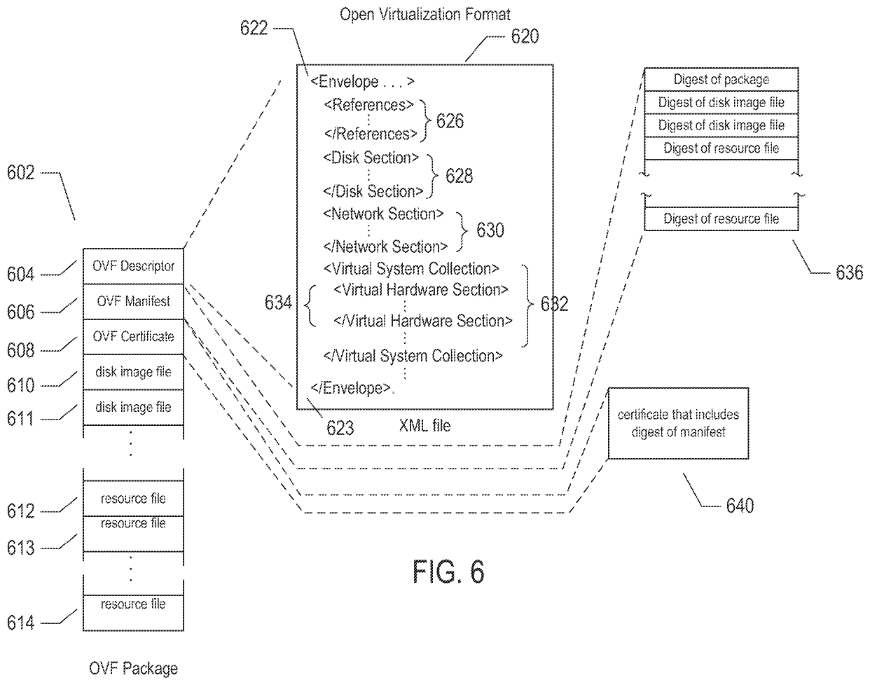

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608, one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing, XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more virtual machines that is encoded within an OVF package.

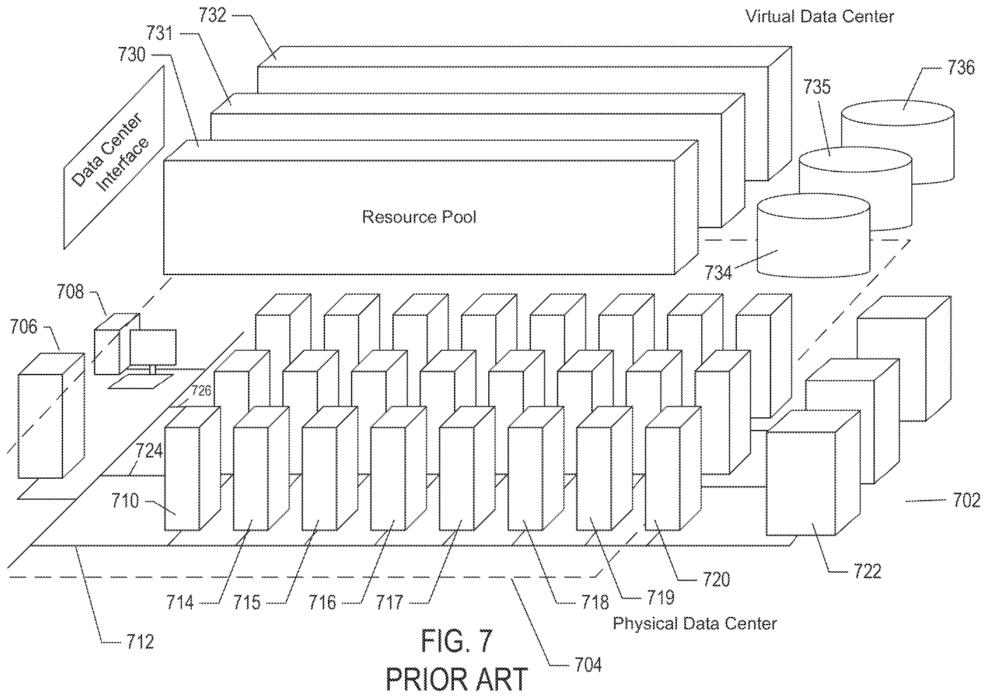

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers or virtual infrastructure, provides a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-data-center management server 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

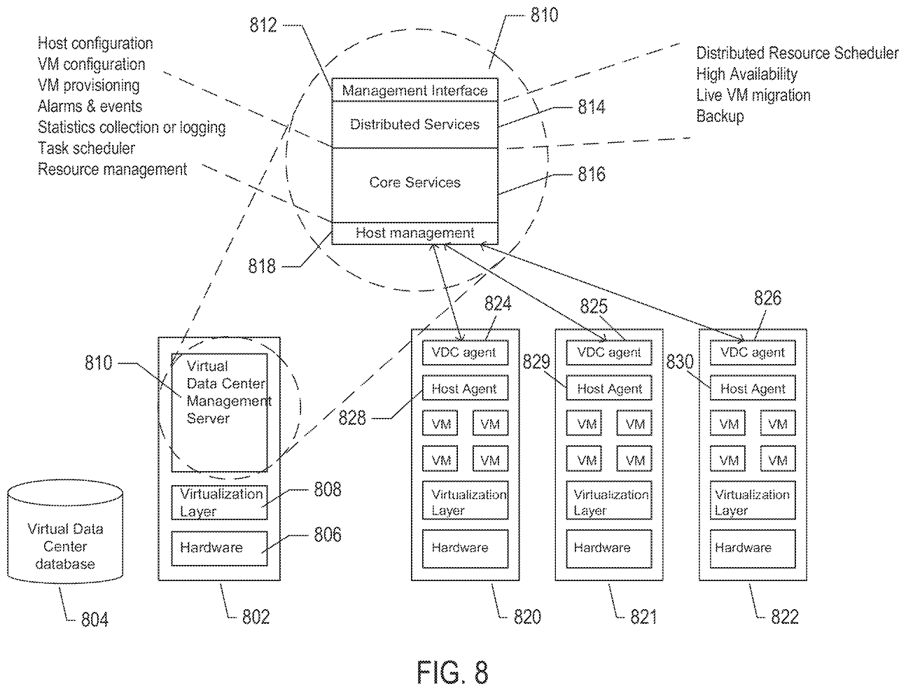

The virtual-data-center management interface allows provisioning and launching of virtual machines with respect to resource pools, virtual data stores, and virtual networks, so that virtual-data-center administrators need not be concerned with the identities of physical-data-center components used to execute particular virtual machines. Furthermore, the virtual-data-center management server includes functionality to migrate running virtual machines from one physical server to another in order to optimally or near optimally manage resource allocation, provide fault tolerance, and high availability by migrating virtual machines to most effectively utilize underlying physical hardware resources, to replace virtual machines disabled by physical hardware problems and failures, and to ensure that multiple virtual machines supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of virtual machines and virtual appliances as well as to provide high-level, distributed functionalities that involve pooling the resources of individual physical servers and migrating virtual machines among physical servers to achieve load balancing, fault tolerance, and high availability. FIG. 8 illustrates virtual-machine components of a virtual-data-center management server and physical servers of a physical data center above which a virtual-data-center interface is provided by the virtual-data-center management server. The virtual-data-center management server 802 and a virtual-data-center database 804 comprise the physical components of the management component of the virtual data center. The virtual-data-center management server 802 includes a hardware layer 806 and virtualization layer 808, and runs a virtual-data-center management-server virtual machine 810 above the virtualization layer. Although shown as a single server in FIG. 8, the virtual-data-center management server (“VDC management server”) may include two or more physical server computers that support multiple VDC-management-server virtual appliances. The virtual machine 810 includes a management-interface component 812, distributed services 814, core services 816, and a host-management interface 818. The management interface is accessed from any of various computers, such as the PC 708 shown in FIG. 7. The management interface allows the virtual-data-center administrator to configure a virtual data center, provision virtual machines, collect statistics and view log files for the virtual data center, and to carry out other, similar management tasks. The host-management interface 818 interfaces to virtual-data-center agents 824, 825, and 826 that execute as virtual machines within each of the physical servers of the physical data center that is abstracted to a virtual data center by the VDC management server.

The distributed services 814 include a distributed-resource scheduler that assigns virtual machines to execute within particular physical servers and that migrates virtual machines in order to most effectively make use of computational bandwidths, data-storage capacities, and network capacities of the physical data center. The distributed services further include a high-availability service that replicates and migrates virtual machines in order to ensure that virtual machines continue to execute despite problems and failures experienced by physical hardware components. The distributed services also include a live-virtual-machine migration service that temporarily halts execution of a virtual machine, encapsulates the virtual machine in an OVF package, transmits the OVF package to a different physical server, and restarts the virtual machine on the different physical server from a virtual-machine state recorded when execution of the virtual machine was halted. The distributed services also include a distributed backup service that provides centralized virtual-machine backup and restore.

The core services provided by the VDC management server include host configuration, virtual-machine configuration, virtual-machine provisioning, generation of virtual-data-center alarms and events, ongoing event logging and statistics collection, a task scheduler, and a resource-management module. Each physical server 820-822 also includes a host-agent virtual machine 828-830 through which the virtualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server. The virtual-data-center agents relay and enforce resource allocations made by the VDC management server, relay virtual-machine provisioning and configuration-change commands to host agents, monitor and collect performance statistics, alarms, and events communicated to the virtual-data-center agents by the local host agents through the interface API, and to carry out other, similar virtual-data-management tasks.

The virtual-data-center abstraction provides a convenient and efficient level of abstraction for exposing the computational resources of a cloud-computing facility to cloud-computing-infrastructure users. A cloud-director management server exposes virtual resources of a cloud-computing facility to cloud-computing-infrastructure users. In addition, the cloud director introduces a multi-tenancy layer of abstraction, which partitions VDCs into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

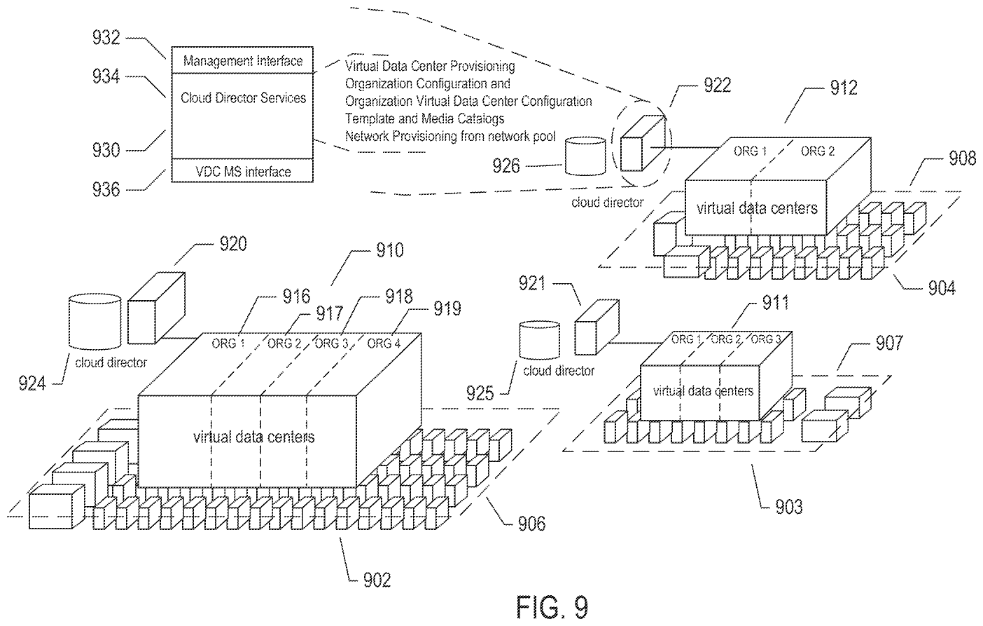

FIG. 9 illustrates a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The resources of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director servers 920-922 and associated cloud-director databases 924-926. Each cloud-director server or servers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are virtual machines that each contains an OS and/or one or more virtual machines containing applications. A template may include much of the detailed contents of virtual machines and virtual appliances that are encoded within OVF packages, so that the task of configuring a virtual machine or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

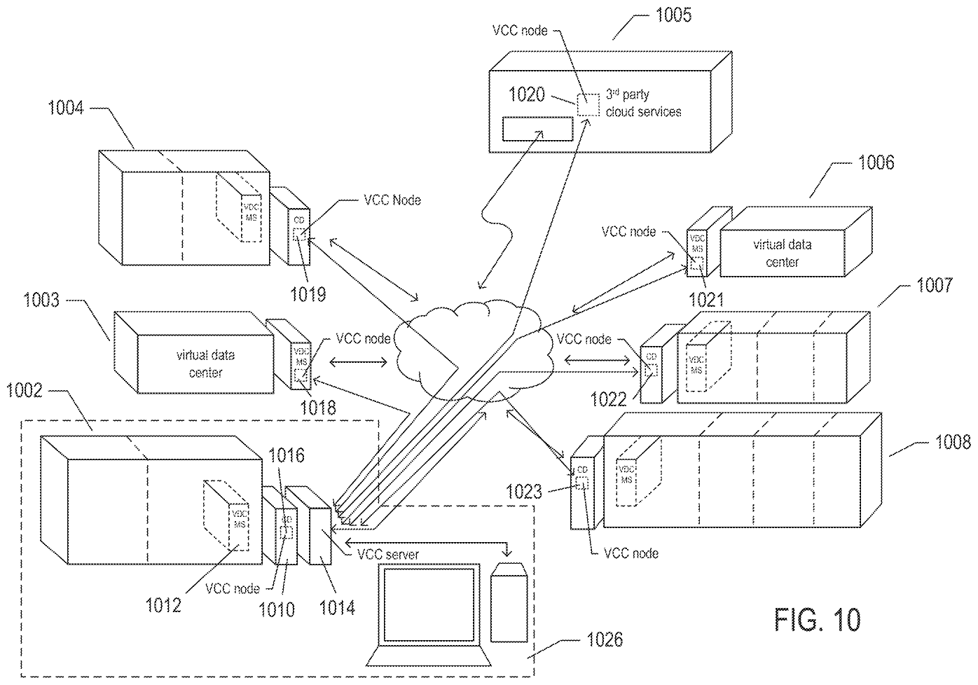

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are illustrated 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

### Application Management and Reinforcement Learning

FIGS. 11A-C illustrate an application manager. All three figures use the same illustration conventions, next described with reference to FIG. 11A. The distributed computing system is represented, in FIG. 11A, by four servers 1102-1105 that each support execution of a virtual machine, 1106-1108 respectively, that provides an execution environment for a local instance of the distributed application. Of course, in real-life cloud-computing environments, a particular distributed application may run on many tens to hundreds of individual physical servers. Such distributed applications often require fairly continuous administration and management. For example, instances of the distributed application may need to be launched or terminated, depending on current computational loads, and may be frequently relocated to different physical servers and even to different cloud-computing facilities in order to take advantage of favorable pricing for virtual-machine execution, to obtain necessary computational throughput, and to minimize networking latencies. Initially, management of distributed applications as well as the management of multiple, different applications executing on behalf of a client or client organization of one or more cloud-computing facilities was carried out manually through various management interfaces provided by cloud-computing facilities and distributed-computer data centers. However, as the complexity of distributed-computing environments has increased and as the numbers and complexities of applications concurrently executed by clients and client organizations have increased, efforts have been undertaken to develop automated application managers for automatically monitoring and managing applications on behalf of clients and client organizations of cloud-computing facilities and distributed-computer-system-based data centers.

As shown in FIG. 11B, one approach to automated management of applications within distributed computer systems is to include, in each physical server on which one or more of the managed applications executes, a local instance of a distributed application manager 1120-1123. The local instances of the distributed application manager cooperate, in peer-to-peer fashion, to manage a set of one or more applications, including distributed applications, on behalf of a client or client organization of the data center or cloud-computing facility. Another approach, as shown in FIG. 11C, is to run a centralized or centralized-distributed application manager 1130 on one or more physical servers 1131 that communicates with application-manager agents 1132-1135 on the servers 1102-1105 to support control and management of the managed applications. In certain cases, application-management facilities may be incorporated within the various types of management servers that manage virtual data centers and aggregations of virtual data centers discussed in the previous subsection of the current document. The phrase “application manager” means, in this document, an automated controller that controls and manages applications programs and the computational environment in which they execute. Thus, an application manager may interface to one or more operating systems and virtualization layers, in addition to applications, in various implementations, to control and manage the applications and their computational environments. In many implementations, an application manager may even control and manage virtual and/or physical components that support the computational environments in which applications execute.

In certain implementations, an application manager is configured to manage applications and their computational environments within one or more distributed computing systems based on a set of one or more policies, each of which may include various rules, parameter values, and other types of specifications of the desired operational characteristics of the applications. As one example, the one or more policies may specify maximum average latencies for responding to user requests, maximum costs for executing virtual machines per hour or per day, and policy-driven approaches to optimizing the cost per transaction and the number of transactions carried out per unit of time. Such overall policies may be implemented by a combination of finer-grain policies, parameterized control programs, and other types of controllers that interface to operating-system and virtualization-layer-management subsystems. However, as the numbers and complexities of applications desired to be managed on behalf of clients and client organizations of data centers and cloud-computing facilities continues to increase, it is becoming increasingly difficult, if not practically impossible, to implement policy-driven application management by manual programming and/or policy construction. As a result, a new approach to application management based on the machine-learning technique referred to as “reinforcement learning” has been undertaken.

In order to simplify the current discussion, the phrase “management-system agent” is used in the current document to mean any one of a centralized distributed application manager, a management agent that cooperates with a centralized distributed application manager, a peer instance of a distributed applications manager, or similar entities of a distributed-computer-system manager. A management-system agent, disclosed in the current document, is a reinforcement-learning-based controller, as discussed in great detail below, in following subsections.

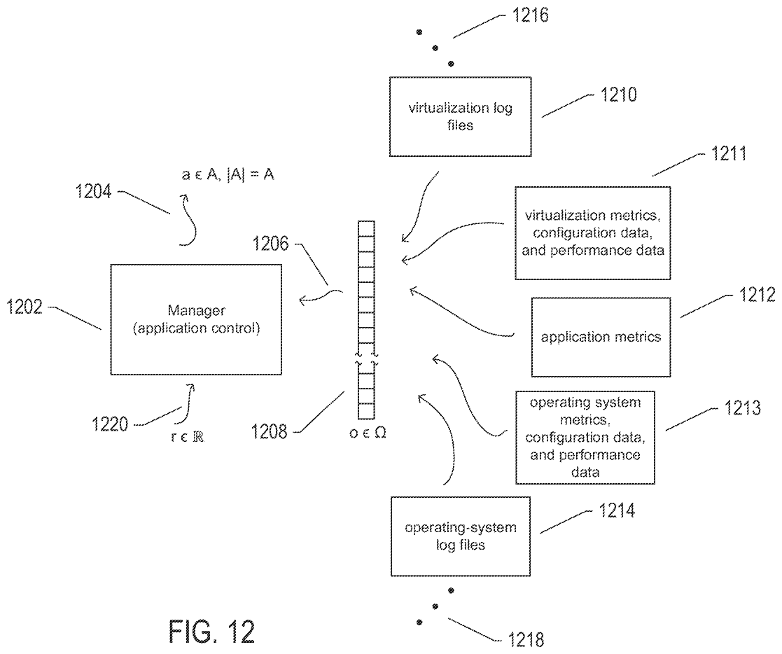

FIG. 12 illustrates, at a high level of abstraction, a reinforcement-learning-based management-system agent controlling a computational environment, such as a cloud-computing facility. As discussed above, a management-system agent may be one of multiple application managers that cooperate to manage one or more distributed computer systems, a centralized application manager, or a component of a centralized or distributed distributed-computer-system manager that manages both applications and infrastructure. The reinforcement-learning-based management-system agent 1202 manages one or more applications by emitting or issuing actions, as indicated by arrow 1204. These actions are selected from a set of actions A of cardinality |A|. Each action a in the set of actions A can be generally thought of as a vector of numeric values that specifies an operation that the manager is directing the environment to carry out. The environment may, in many cases, translate the action into one or more environment-specific operations that can be carried out by the computational environment controlled by the reinforcement-learning-based management-system agent. It should be noted that the cardinality |A| may be indeterminable, since the numeric values may include real values, and the action space may be therefore effectively continuous or effectively continuous in certain dimensions. The operations represented by actions may be, for example, commands, including command arguments, executed by operating systems, distributed operating systems, virtualization layers, management servers, and other types of control components and subsystems within one or more distributed computing systems or cloud-computing facilities.

The reinforcement-learning-based management-system agent receives observations from the computational environment, as indicated by arrow 1206. Each observation o can be thought of as a vector of numeric values 1208 selected from a set of possible observation vectors Ω. The set Ω may, of course, be quite large and even practically innumerable. Each element of the observation o represents, in certain implementations, a particular type of metric or observed operational characteristic or parameter, numerically encoded, that is related to the computational environment. The metrics may have discrete values or real values, in various implementations. For example, the metrics or observed operational characteristics may indicate the amount of memory allocated for applications and/or application instances, networking latencies experienced by one or more applications, an indication of the number of instruction-execution cycles carried out on behalf of applications or local-application instances, and many other types of metrics and operational characteristics of the managed applications and the computational environment in which the managed applications run. As shown in FIG. 12, there are many different sources 1210-1214 for the values included in an observation o, including virtualization-layer and operating-system log files 1210 and 1214, virtualization-layer metrics, configuration data, and performance data provided through a virtualization-layer management interface 1211, various types of metrics generated by the managed applications 1212, and operating-system metrics, configuration data, and performance data 1213. Ellipses 1216 and 1218 indicate that there may be many additional sources for observation values. In addition to receiving observation vectors o, the reinforcement-learning-based management-system agent receives rewards, as indicated by arrow 1220. Each reward is a numeric value that represents the feedback provided by the computational environment to the reinforcement-learning-based management-system agent after carrying out the most recent action issued by the manager and transitioning to a resultant state, as further discussed below.

The reinforcement-learning-based management-system agent is generally initialized with an initial policy that specifies the actions to be issued in response to received observations and over time, as the management-system agent interacts with the environment, the management-system agent adjusts the internally maintained policy according to the rewards received following issuance of each action. In many cases, after a reasonable period of time, a reinforcement-learning-based management-system agent is able to learn a near-optimal or optimal policy for the environment, such as a set of distributed applications, that it manages. In addition, in the case that the managed environment evolves over time, a reinforcement-learning-based management-system agent is able to continue to adjust the internally maintained policy in order to track evolution of the managed environment so that, at any given point in time, the internally maintained policy is near-optimal or optimal. In the case of a management-system agent, the computational environment in which the applications run may evolve through changes to the configuration and components, changes in the computational load experienced by the applications and computational environment, and as a result of many additional changes and forces. The received observations provide the information regarding the managed environment that allows the reinforcement-learning-based management-system agent to infer the current state of the environment which, in turn, allows the reinforcement-learning-based management-system agent to issue actions that push the managed environment towards states that, over time, produce the greatest cumulative reward feedbacks. Of course, similar reinforcement-learning-based management-system agents may be employed within standalone computer systems, individual, networked computer systems, various processor-controlled devices, including smart phones, and other devices and systems that run applications.

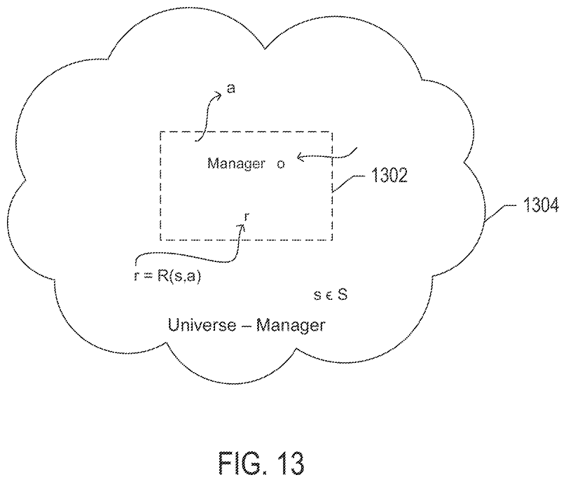

FIG. 13 summarizes the reinforcement-learning-based approach to control. The manager or controller 1302, referred to as a “reinforcement-learning agent,” is contained within the universe 1304. The universe comprises the manager or controller 1302 and the portion of the universe not included in the manager, in set notation referred to as “universe-manager.” In the current document, the portion of the universe not included in the manager is referred to as the “environment.” In the case of a management-system agent, the environment includes the managed applications, the physical computational facilities in which they execute, and even generally includes the physical computational facilities in which the manager executes. The rewards are generated by the environment and the reward-generation mechanism cannot be controlled or modified by the manager.

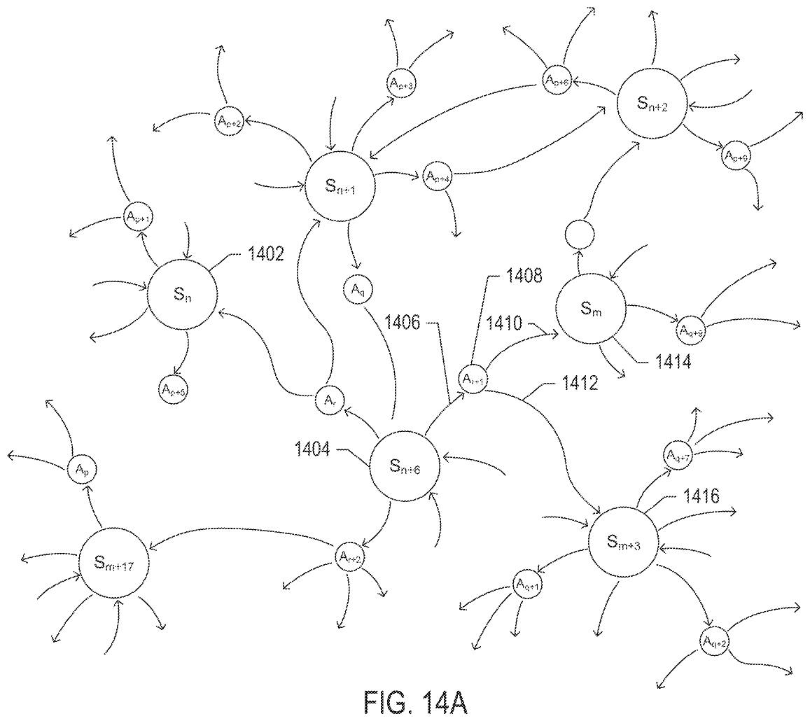

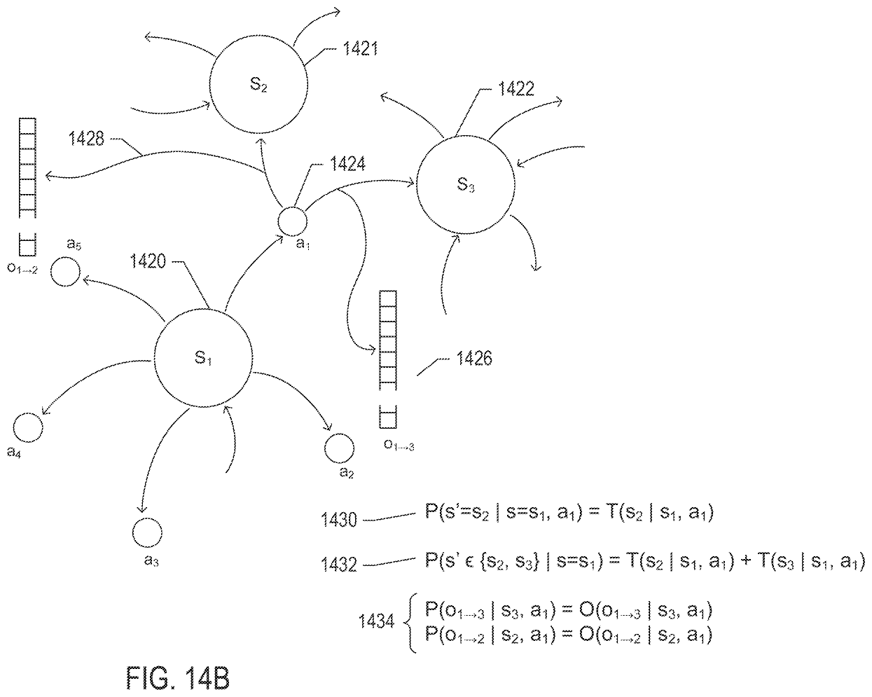

FIGS. 14A-B illustrate states of the environment. In the reinforcement-learning approach, the environment is considered to inhabit a particular state at each point in time. The state may be represented by one or more numeric values or character-string values, but generally is a function of hundreds, thousands, millions, or more different variables. The observations generated by the environment and transmitted to the manager reflect the state of the environment at the time that the observations are made. The possible state transitions can be described by a state-transition diagram for the environment. FIG. 14A illustrates a portion of a state-transition diagram. Each of the states in the portion of the state-transition diagram shown in FIG. 14A are represented by large, labeled disks, such as disc 1402 representing a particular state Sₙ. The transition between one state to another state occurs as a result of an action, emitted by the manager, that is carried out within the environment. Thus, arrows incoming to a given state represent transitions from other states to the given state and arrows outgoing from the given state represent transitions from the given state to other states. For example, one transition from state 1404, labeled Sₙ₊₆, is represented by outgoing arrow 1406. The head of this arrow points to a smaller disc that represents a particular action 1408. This action node is labeled Aᵣ₊₁. The labels for the states and actions may have many different forms, in different types of illustrations, but are essentially unique identifiers for the corresponding states and actions. The fact that outgoing arrow 1406 terminates in action 1408 indicates that transition 1406 occurs upon carrying out of action 1408 within the environment when the environment is in state 1404. Outgoing arrows 1410 and 1412 emitted by action node 1408 terminate at states 1414 and 1416, respectively. These arrows indicate that carrying out of action 1408 by the environment when the environment is in state 1404 results in a transition either to state 1414 or to state 1416. It should also be noted that an arrow emitted from an action node may return to the state from which the outgoing arrow to the action node was emitted. In other words, carrying out certain actions by the environment when the environment is in a particular state may result in the environment maintaining that state. Starting at an initial state, the state-transition diagram indicates all possible sequences of state transitions that may occur within the environment. Each possible sequence of state transitions is referred to as a “trajectory.”

FIG. 14B illustrates additional details about state-transition diagrams and environmental states and behaviors. FIG. 14B shows a small portion of a state-transition diagram that includes three state nodes 1420-1422. A first additional detail is the fact that, once an action is carried out, the transition from the action node to a resultant state is accompanied by the emission of an observation, by the environment, to the manager. For example, a transition from state 1420 to state 1422 as a result of action 1424 produces observation 1426, while transition from state 1420 to state 1421 via action 1424 produces observation 1428. A second additional detail is that each state transition is associated with a probability. Expression 1430 indicates that the probability of transitioning from state s₁ to state s₂ as a result of the environment carrying out action a₁, where s indicates the current state of the environment and s′ indicates the next state of the environment following s, is output by the state-transition function T, which takes, as arguments, indications of the initial state, the final state, and the action. Thus, each transition from a first state through a particular action node to a second state is associated with a probability. The second expression 1432 indicates that probabilities are additive, so that the probability of a transition from state s₁ to either state s₂ or state s₃ as a result of the environment carrying out action a₁ is equal to the sum of the probability of a transition from state s₁ to state s₂ via action a₁ and the probability of a transition from state s₁ to state s₃ via action a₁. Of course, the sum of the probabilities associated with all of the outgoing arrows emanating from a particular state is equal to 1.0, for all non-terminal states, since, upon receiving an observation/reward pair following emission of a first action, the manager emits a next action unless the manager terminates. As indicated by expressions 1434, the function O returns the probability that a particular observation o is returned by the environment given a particular action and the state to which the environment transitions following execution of the action. In other words, in general, there are many possible observations o that might be generated by the environment following transition to a particular state through a particular action, and each possible observation is associated with a probability of occurrence of the observation given a particular state transition through a particular action.

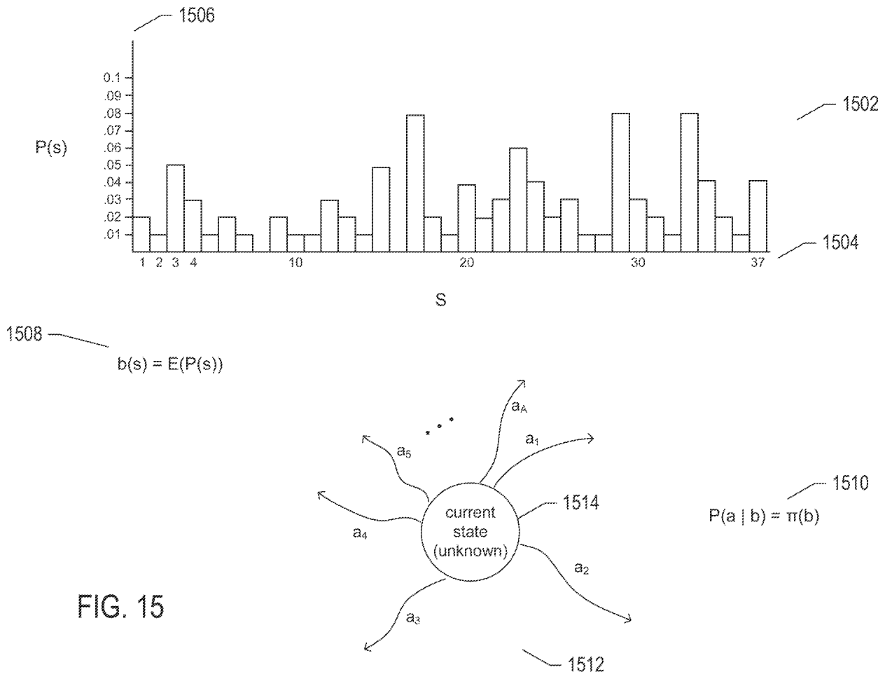

FIG. 15 illustrates the concept of belief. At the top of FIG. 15, a histogram 1502 is shown. The horizontal axis 1502 represents 37 different possible states for a particular environment and the vertical axis 1506 represents the probability of the environment being in the corresponding state at some point in time. Because the environment must be in one state at any given point in time, the sum of the probabilities for all the states is equal to 1.0. Because the manager does not know the state of the environment, but instead only knows the values of the elements of the observation following the last executed action, the manager infers the probabilities of the environment being in each of the different possible states. The manager's belief b(s) is the expectation of the probability that the environment is in state s, as expressed by equation 1508. Thus, the belief b is a probability distribution which could be represented in a histogram similar to histogram 1502. Over time, the manager accumulates information regarding the current state of the environment and the probabilities of state transitions as a function of the belief distribution and most recent actions, as a result of which the probability distribution b shifts towards an increasingly non-uniform distribution with greater probabilities for the actual state of the environment. In a deterministic and fully observable environment, in which the manager knows the current state of the environment, the policy π maintained by the manager can be thought of as a function that returns the next action a to be emitted by the manager to the environment based on the current state of the environment, or, in mathematical notation, a=π(s). However, in the non-deterministic and non-transparent environment in which management-system agents operate, the policy π maintained by the manager determines a probability for each action based on the current belief distribution b, as indicated by expression 1510 in FIG. 15, and an action with the highest probability is selected by the policy π, which can be summarized, in more compact notation, by expression 1511. Thus, as indicated by the diagram of a state 1512, at any point in time, the manager does not generally certainly know the current state of the environment, as indicated by the label 1514 within the node representation of the current date 1512, as a result of which there is some probability, for each possible state, that the environment is currently in that state. This, in turn, generally implies that there is a non-zero probability that each of the possible actions that the manager can issue should be the next issued action, although there are cases in which, although the state of the environment is not known with certain, there is enough information about the state of the environment to allow a best action to be selected.

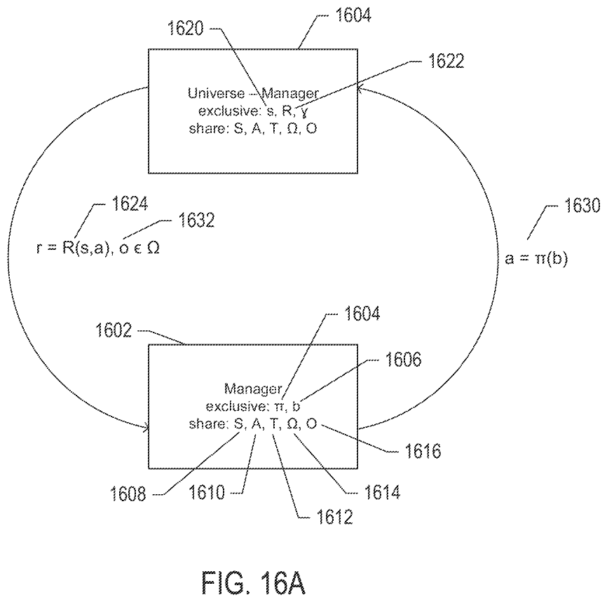

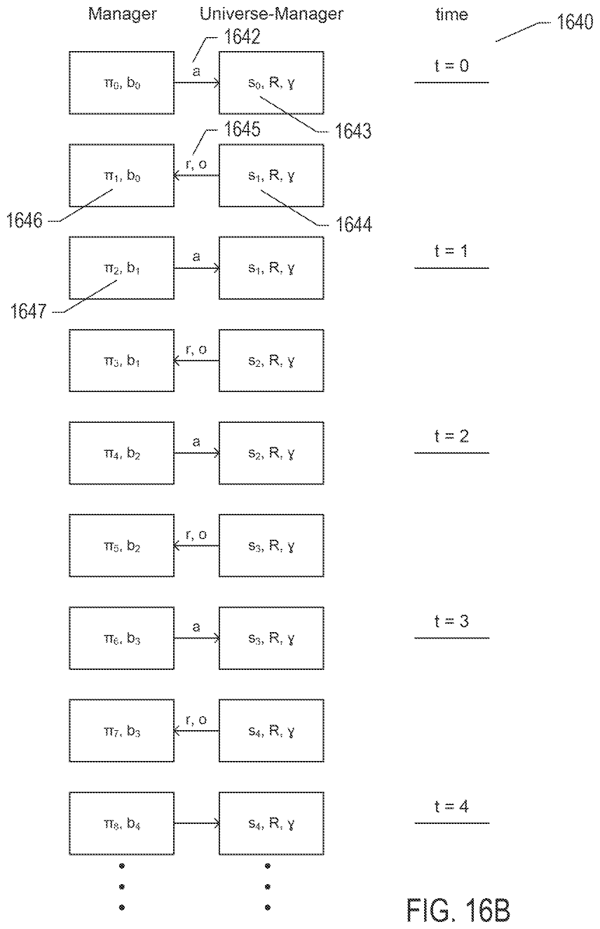

FIGS. 16A-B illustrate a simple flow diagram for the universe comprising the manager and the environment in one approach to reinforcement learning. The manager 1602 internally maintains a policy π 1604 and a belief distribution b 1606 and is aware of the set of environment states S 1608, the set of possible actions A 1610, the state-transition function T 1612, the set of possible observations Ω 1614 and, and the observation-probability function O 1616, all discussed above. The environment 1604 shares knowledge of the sets A, and Ω with the manager. Usually, the true state space S and the functions T and O are unknown and estimated by the manager. The environment maintains the current state of the environment s 1620, a reward function R 1622 that returns a reward r in response to an input current state s and an input action a received while in the current state 1624, and a discount parameter γ 1626, discussed below. The manager is initialized with an initial policy and belief distribution. The manager emits a next action 1630 based on the current belief distribution which the environment then carries out, resulting in the environment occupying a resultant state and then issues a reward 1624 and an observation o 1632 based on the resultant state and the received action. The manager receives the reward and observation, generally updates the internally stored policy and belief distribution, and then issues a next action, in response to which the environment transitions to a resultant state and emits a next reward and observation. This cycle continues indefinitely or until a termination condition arises.

It should be noted that this is just one model of a variety of different specific models that may be used for a reinforcement-learning agent and environment. There are many different models depending on various assumptions and desired control characteristics.

FIG. 16B shows an alternative way to illustrate operation of the universe. In this alternative illustration method, a sequence of time steps is shown, with the times indicated in a right-hand column 1640. Each time step consists of issuing, by the manager, an action to the environment and issuing, by the environment, a reward and observation to the manager. For example, in the first time step t=0, the manager issues an action a 1642, the environment transitions from state s₀ 1643 to s₁ 1644, and the environment issues a reward r and observation o 1645 to the manager. As a result, the manager updates the policy and belief distribution in preparation for the next time step. For example, the initial policy and belief distribution π₀ and b₀ 1646 are updated to the policy and belief distribution π₁ and b₁ 1647 at the beginning of the next time step t=1. The sequence of states {s₀, s₁, . . . } represents the trajectory of the environment as controlled by the manager. Each time step is thus equivalent to one full cycle of the control-flow-diagram-like representation discussed above with reference to FIG. 16A.

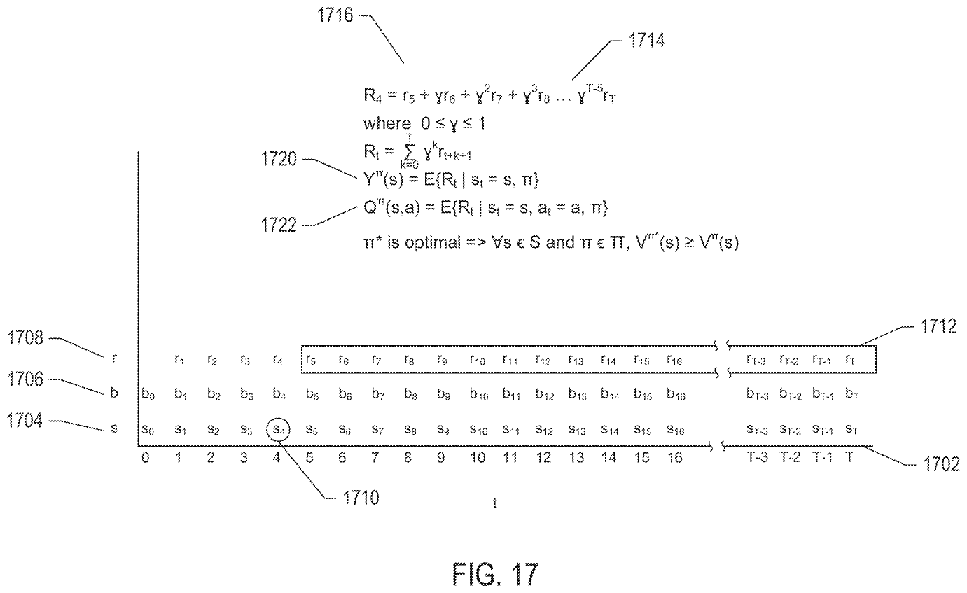

FIG. 17 provides additional details about the operation of the manager, environment, and universe. At the bottom of FIG. 17, a trajectory for the manager and environment is laid out horizontally with respect to the horizontal axis 1702 representing the time steps discussed above with reference to FIG. 16B. A first horizontal row 1704 includes the environment states, a second horizontal row 1706 includes the belief distributions, and a third horizontal row 1708 includes the issued rewards. At any particular state, such as circled state s₄ 1710, one can consider all of the subsequent rewards, shown for state s₄ within box 1712 in FIG. 17. The discounted return for state s₄, G₄, is the sum of a series of discounted rewards 1714. The first term in the series 1716 is the reward r₅ returned when the environment transitions from state s₄ to state s₅. Each subsequent term in the series includes the next reward multiplied by the discount rate γ raised to a power. The discounted reward can be alternatively expressed using a summation, as indicated in expression 1718. The value of a given state s, assuming a current policy π, is the expected discounted return for the state, and is returned by a value function V^{π}( ), as indicated by expression 1720. Alternatively, an action-value function returns a discounted return for a particular state and action, assuming a current policy, as indicated by expression 1722. An optimal policy π* provides a value for each state that is greater than or equal to the value provided by any possible policy π in the set of possible policies Π. There are many different ways for achieving an optimal policy. In general, these involve running a manager to control an environment while updating the value function V^{π}( ) and policy π, either in alternating sessions or concurrently. In some approaches to reinforcement learning, when the environment is more or less static, once an optimal policy is obtained during one or more training runs, the manager subsequently controls the environment according to the optimal policy. In other approaches, initial training generates an initial policy that is then continuously updated, along with the value function, in order to track changes in the environment so that a near-optimal policy is maintained by the manager.

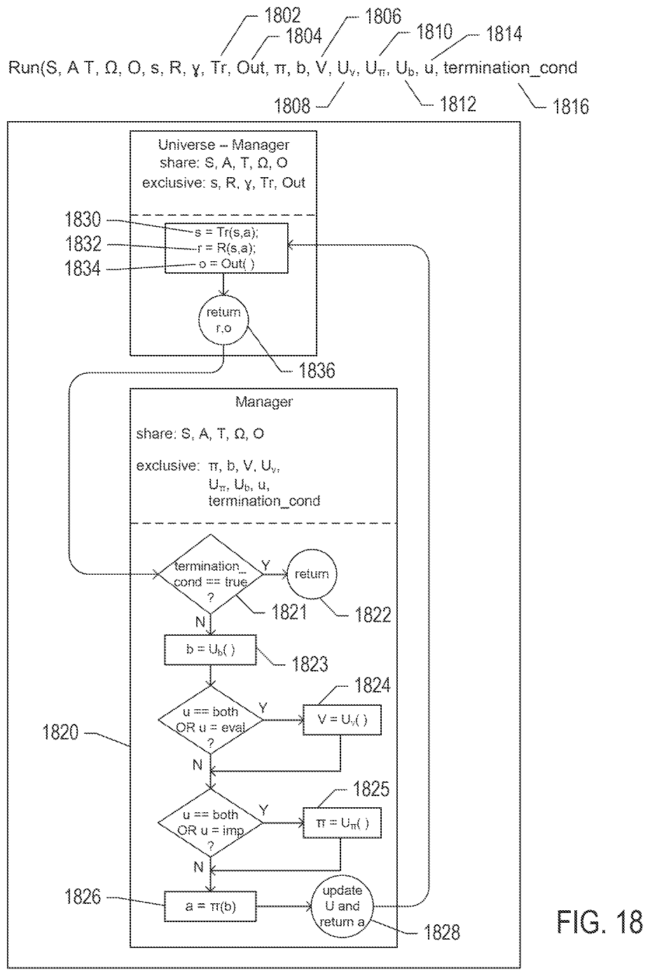

FIG. 18 provides a somewhat more detailed control-flow-like description of operation of the manager and environment than originally provided in FIG. 16A. The control-flow-like presentation corresponds to a run of the manager and environment that continues until a termination condition evaluates to TRUE. In addition to the previously discussed sets and functions, this model includes a state-transition function Tr 1802, an observation-generation function Out 1804, a value function V 1806, update functions U_{V} 1808, U_{π} 1810, and U_{b} 1812 that update the value function, policy, and belief distribution, respectively, an update variable u 1814 that indicates whether to update the value function, policy, or both, and a termination condition 1816. The manager 1820 determines whether the termination condition evaluates to TRUE, in step 1821, and, if so, terminates in step 1822. Otherwise, the manager updates the belief, in step 1823 and updates one or both of the value function and policy, in steps 1824 and 1825, depending on the current value of the update variable u. In step 1826, the manager generates a new action and, in step 1828, updates the update variable u and issues the generated action to the environment. The environment determines a new state 1830, determines a reward 1832, and determines an observation 1834 and returns the generated reward and observation in step 1836.

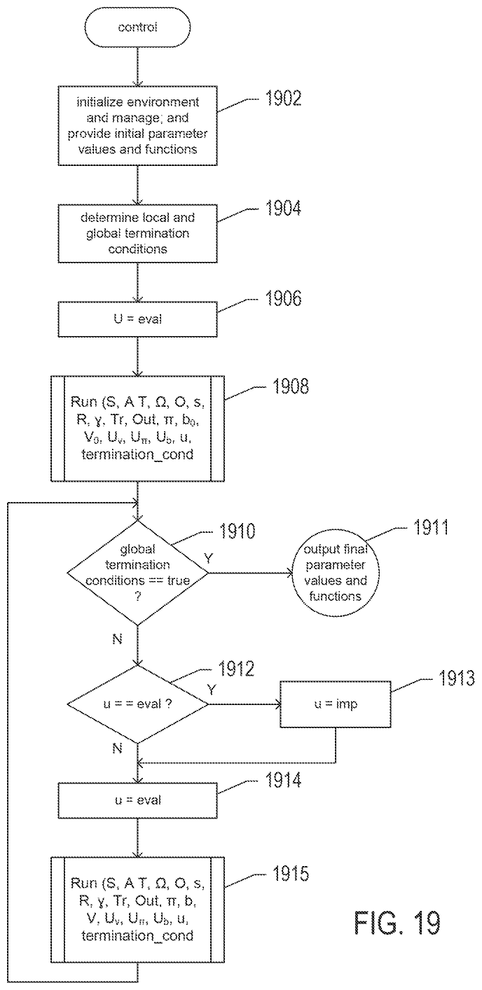

FIG. 19 provides a traditional control-flow diagram for operation of the manager and environment over multiple runs. In step 1902, the environment and manager are initialized. This involves initializing certain of the various sets, functions, parameters, and variables shown at the top of FIG. 18. In step 1904, local and global termination conditions are determined. When the local termination condition evaluates to TRUE, the run terminates. When the global termination condition evaluates to TRUE, operation of the manager terminates. In step 1906, the update variable u is initialized to indicate that the value function should be updated during the initial run. Step 1908 consists of the initial run, during which the value function is updated with respect to the initial policy. Then, additional runs are carried out in the loop of steps 1910-1915. When the global termination condition evaluates to TRUE, as determined in step 1910, operation of the manager is terminated in step 1911, with output of the final parameter values and functions. Thus, the manager may be operated for training purposes, according to the control-flow diagram shown in FIG. 19, with the final output parameter values and functions stored so that the manager can be subsequently operated, according to the control-flow diagram shown in FIG. 19, to control a live system. Otherwise, when the global termination condition does not evaluate to TRUE and when the update variable u has a value indicating that the value function should be updated, as determined in step 1912, the value stored in the update variable u is changed to indicate that the policy should be updated, in step 1913. Otherwise, the value stored in the update variable u is changed to indicate that the value function should be updated, in step 1914. Then, a next run, described by the control-flow-like diagram shown in FIG. 18, is carried out in step 1915. Following termination of this run, control flows back to step 1910 for a next iteration of the loop of steps 1910-1915. In alternative implementations, the update variable u may be initially set to indicate that both the value function and policy should be updated during each run and the update variable u is not subsequently changed. This approach involves different value-function and policy update functions than those used when only one of the value function and policy is updated during each run.

### Actor-Critic Reinforcement Learning

FIG. 20 illustrates certain details of one class of reinforcement-learning system.

In this class of reinforcement-learning system, the values of states are based on an expected discounted return at each point in time, as represented by expressions 2002. The expected discounted return at time t, Rₜ, is the sum of the reward returned at time t+1 and increasingly discounted subsequent rewards, where the discount rate γ is a value in the range [0, 1). As indicated by expression 2004, the agent's policy at time t, πₜ, is a function that receives a state s and an action a and that returns the probability that the action issued by the agent at time t, aₜ, is equal to input action a given that the current state, sₜ, is equal to the input state s. Probabilistic policies are used to encourage an agent to continuously explore the state/action space rather than to always choose what is currently considered to be the optimal action for any particular state. It is by this type of exploration that an agent learns an optimal or near-optimal policy and is able to adjust to new environmental conditions, over time. Note that, in this model, observations and beliefs are not used, but that, instead, the environment returns states and rewards to the agent rather than observations and rewards.

In many reinforcement-learning approaches, a Markov assumption is made with respect to the probabilities of state transitions and rewards. Expressions 2006 encompass the Markov assumption. The transition probability P_{s,s′}^{a} is the estimated probability that if action a is issued by the agent when the current state is s, the environment will transition to state s′. According to the Markov assumption, this transition probability can be estimated based only on the current state, rather than on a more complex history of action/state-reward cycles. The value R_{s,s′}^{a} is the expected reward entailed by issuing action a when the current state is s and when the state transitions to state s′.

In the described reinforcement-learning implementation, the policy followed by the agent is based on value functions. These include the value function V^{π}(s), which returns the currently estimated expected discounted return under the policy π for the state s, as indicated by expression 2008, and the value function Q^{π}(s,a), which returns the currently estimated expected discounted return under the policy π for issuing action a when the current state is s, as indicated by expression 2010. Expression 2012 illustrates one approach to estimating the value function V^{π}(s) by summing probability-weighted estimates of the values of all possible state transitions for all possible actions from a current state s. The value estimates are based on the estimated immediate reward and a discounted value for the next state to which the environment transitions. Expressions 2014 indicate that the optimal state-value and action-value functions V*(s,a) and Q*(s,a) represent the maximum values for these respective functions given for any possible policy. The optimal state-value and action-value functions can be estimated as indicated by expressions 2016. These expressions are closely related to expression 2012, discussed above. Finally, an expression 2018 for a greedy policy π′ is provided, along with a state-value function for that policy, provided in expression 2020. The greedy policy selects the action that provides the greatest action-value-function return for a given policy and the state-value function for the greedy policy is the maximum value estimated for each of all possible actions by the sums of probability-weighted value estimations for all possible state transitions following issuance of the action. In practice, a modified greedy policy is used to permit a specified amount of exploration so that an agent can continue to learn while adhering to the modified greedy policy, as mentioned above.

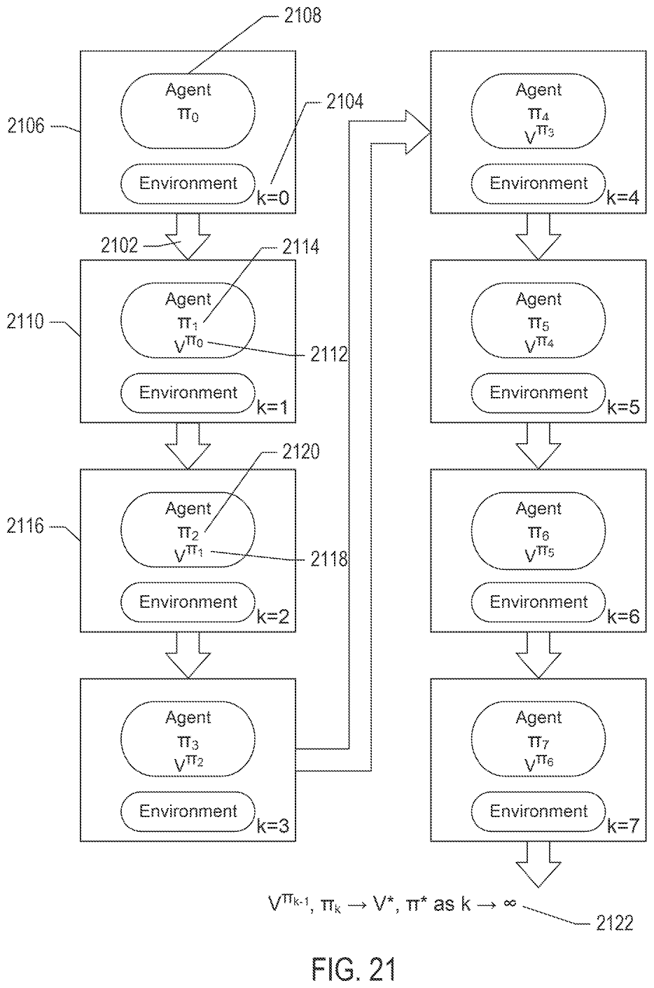

FIG. 21 illustrates learning of a near-optimal or optimal policy by a reinforcement-learning agent. FIG. 21 uses the same illustration conventions as used in FIG. 18, with the exceptions of using broad arrows, such as broad arrow 2102, rather than the thin arrows used in FIG. 18, and the inclusion of epoch indications, such as the indication “k=0” 2104. Thus, in FIGS. 21, each rectangle, such as rectangle 2106, represents a reinforcement-learning system at each successive epoch, where epochs consist of one or more action/state-reward cycles. In the 0^{th} epoch, or first epoch, represented by rectangle 2106, the agent is currently using an initial policy π₀ 2108. During the next epoch, represented by rectangle 2110, the agent is able to estimate the state-value function for the initial policy 2112 and can now employ a new policy π₁ 2114 based on the state-value function estimated for the initial policy. An obvious choice for the new policy is the above-discussed greedy policy or a modified greedy policy based on the state-value function estimated for the initial policy. During the third epoch, represented by rectangle 2116, the agent has estimated a state-value function 2118 for previously used policy π₁ 2114 and is now using policy π₂ 2120 based on state-value function 2118. For each successive epoch, as shown in FIG. 18, a new state-value-function estimate for the previously used policy is determined and a new policy is employed based on that new state-value function. Under certain basic assumptions, it can be shown that, as the number of epochs approaches infinity, the current state-value function and policy approach an optimal state-value function and an optimal policy, as indicated by expression 2122 at the bottom of 21.

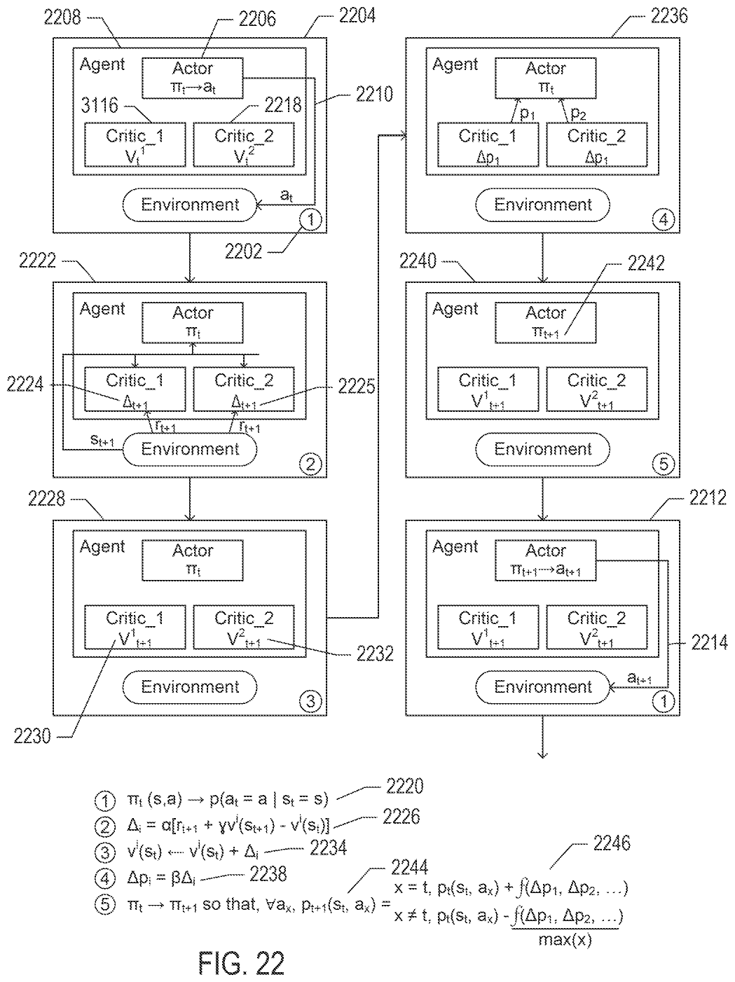

FIG. 22 illustrates one type of reinforcement-learning system that falls within a class of reinforcement-learning systems referred to as “actor-critic” systems. FIG. 22 uses similar illustration conventions as used in FIGS. 21 and 18. However, in the case of FIG. 22, the rectangles represent steps within an action/state-reward cycle. Each rectangle includes, in the lower right-hand corner, a circled number, such as circle “1” 2202 in rectangle 2204, which indicates the sequential step number. The first rectangle 2204 represents an initial step in which an actor 2206 within the agent 2208 issues an action at time t, as represented by arrow 2210. The final rectangle 2212 represents the initial step of a next action/state-reward cycle, in which the actor issues a next action at time t+1, as represented by arrow 2214. In the actor-critic system, the agent 2208 includes both an actor 2206 as well as one or more critics. In the actor-critic system illustrated in FIG. 22, the agent includes two critics 2260 and 2218. The actor maintains a current policy, πₜ, and the critics each maintain state-value functions Vₜⁱ, where i is a numerical identifier for a critic. Thus, in contrast to the previously described general reinforcement-learning system, the agent is partitioned into a policy-managing actor and one or more state-value-function-maintaining critics. As shown by expression 2220, towards the bottom of FIG. 22, the actor selects a next action according to the current policy, as in the general reinforcement-learning systems discussed above. However, in a second step represented by rectangle 2222, the environment returns the next state to both the critics and the actor, but returns the next reward only to the critics. Each critic i then computes a state-value adjustment Δᵢ 2224-2225, as indicated by expression 2226. The adjustment is positive when the sum of the reward and discounted value of the next state is greater than the value of the current state and negative when the sum of the reward and discounted value of the next state is less than the value of the current state. The computed adjustments are then used, in the third step of the cycle, represented by rectangle 2228, to update the state-value functions 2230 and 2232, as indicated by expression 2234. The state value for the current state sₜ is adjusted using the computed adjustment factor. In a fourth step, represented by rectangle 2236, the critics each compute a policy adjustment factor Δₚ_{ᵢ}, as indicated by expression 2238, and forward the policy adjustment factors to the actor. The policy adjustment factor is computed from the state-value adjustment factor via a multiplying coefficient β, or proportionality factor. In step 5, represented by rectangle 2240, the actor uses the policy adjustment factors to determine a new, improved policy 2242, as indicated by expression 2244. The policy is adjusted so that the probability of selecting action a when in state sₜ is adjusted by adding some function of the policy adjustment factors 2246 to the probability while the probabilities of selecting other actions when in state sₜ are adjusted by subtracting the function of the policy adjustment factors divided by the total number of possible actions that can be taken at state sₜ from the probabilities.

### Virtual Networking and Virtual Storage Area Networks

FIG. 23 illustrates the Open Systems Interconnection model (“OSI model”) that characterizes many modern approaches to implementation of communications systems that interconnect computers. In FIG. 23, two processor-controlled network devices, or computer systems, are represented by dashed rectangles 2302 and 2304. Within each processor-controlled network device, a set of communications layers are shown, with the communications layers both labeled and numbered. For example, the first communications level 2306 in network device 2302 represents the physical layer which is alternatively designated as layer 1. The communications messages that are passed from one network device to another at each layer are represented by divided rectangles in the central portion of FIG. 23, such as divided rectangle 2308. The largest rectangular division 2310 in each divided rectangle represents the data contents of the message. Smaller rectangles, such as rectangle 2311, represent message headers that are prepended to a message by the communications subsystem in order to facilitate routing of the message and interpretation of the data contained in the message, often within the context of an interchange of multiple messages between the network devices. Smaller rectangle 2312 represents a footer appended to a message to facilitate data-link-layer frame exchange. As can be seen by the progression of messages down the stack of corresponding communications-system layers, each communications layer in the OSI model generally adds a header or a header and footer specific to the communications layer to the message that is exchanged between the network devices.

It should be noted that while the OSI model is a useful conceptual description of the modern approach to electronic communications, particular communications-systems implementations may depart significantly from the seven-layer OSI model. However, in general, the majority of communications systems include at least subsets of the functionality described by the OSI model, even when that functionality is alternatively organized and layered.

The physical layer, or layer 1, represents the physical transmission medium and communications hardware. At this layer, signals 2314 are passed between the hardware communications systems of the two network devices 2302 and 2304. The signals may be electrical signals, optical signals, or any other type of physically detectable and transmittable signal. The physical layer defines how the signals are interpreted to generate a sequence of bits 2316 from the signals. The second data-link layer 2318 is concerned with data transfer between two nodes, such as the two network devices 2302 and 2304. At this layer, the unit of information exchange is referred to as a “data frame” 2320. The data-link layer is concerned with access to the communications medium, synchronization of data-frame transmission, and checking for and controlling transmission errors. The third network layer 2320 of the OSI model is concerned with transmission of variable-length data sequences between nodes of a network. This layer is concerned with networking addressing, certain types of routing of messages within a network, and disassembly of a large amount of data into separate frames that are reassembled on the receiving side. The fourth transport layer 2322 of the OSI model is concerned with the transfer of variable-length data sequences from a source node to a destination node through one or more networks while maintaining various specified thresholds of service quality. This may include retransmission of packets that fail to reach their destination, acknowledgement messages and guaranteed delivery, error detection and correction, and many other types of reliability. The transport layer also provides for node-to-node connections to support multi-packet and multi-message conversations, which include notions of message sequencing. Thus, layer 4 can be considered as a connections-oriented layer. The fifth session layer of the OSI model 2324 involves establishment, management, and termination of connections between application programs running within network devices. The sixth presentation layer 2326 is concerned with communications context between application-layer entities, translation and mapping of data between application-layer entities, data-representation independence, and other such higher-level communications services. The final seventh application layer 2328 represents direct interaction of the communications systems with application programs. This layer involves authentication, synchronization, determination of resource availability, and many other services that allow particular applications to communicate with one another on different network devices. The seventh layer can thus be considered to be an application-oriented layer.

In the widely used TCP/IP communications protocol stack, the seven OSI layers are generally viewed as being compressed into a data-frame layer, which includes OSI layers 1 and 2, a transport layer, corresponding to OSI layer 4, and an application layer, corresponding to OSI layers 5-7. These layers are commonly referred to as “layer 2,” “layer 4,” and “layer 7,” to be consistent with the OSI terminology.

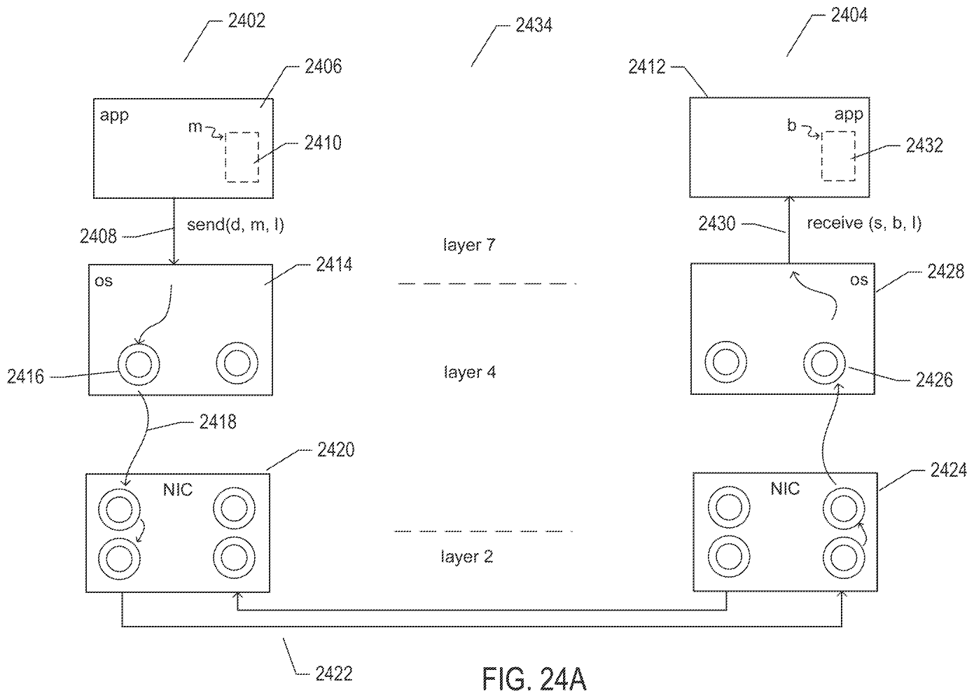

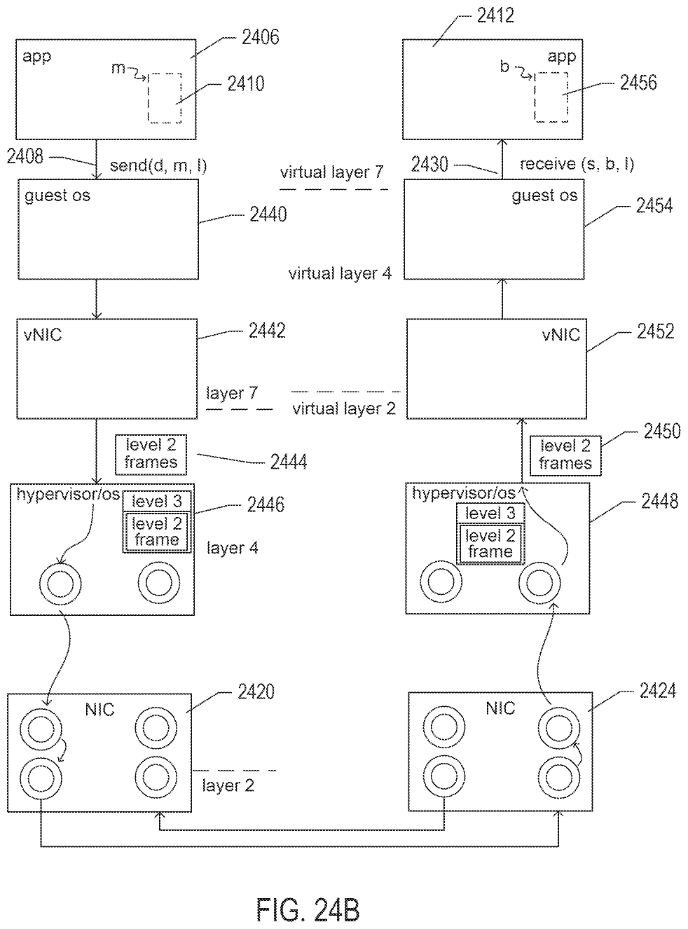

FIGS. 24A-B illustrate a layer-2-over-layer-3 encapsulation technology on which virtualized networking can be based. FIG. 24A shows traditional network communications between two applications running on two different computer systems. Representations of components of the first computer system are shown in a first column 2402 and representations of components of the second computer system are shown in a second column 2404. An application 2406 running on the first computer system calls an operating-system function, represented by arrow 2408, to send a message 2410 stored in application-accessible memory to an application 2412 running on the second computer system. The operating system on the first computer system 2414 moves the message to an output-message queue 2416 from which it is transferred 2418 to a network-interface-card (“NIC”) 2420, which decomposes the message into frames that are transmitted over a physical communications medium 2422 to a NIC 2424 in the second computer system. The received frames are then placed into an incoming-message queue 2426 managed by the operating system 2428 on the second computer system, which then transfers 2430 the message to an application-accessible memory 2432 for reception by the second application 2412 running on the second computer system. In general, communications are bidirectional, so that the second application can similarly transmit messages to the first application. In addition, the networking protocols generally return acknowledgment messages in response to reception of messages. As indicated in the central portion of FIG. 24A 2434, the NIC-to-NIC transmission of data frames over the physical communications medium corresponds to layer-2 (“L2”) network operations and functionality, layer-4 (“L4”) network operations and functionality are carried out by a combination of operating-system and NIC functionalities, and the system-call-based initiation of a message transmission by the application program and operating system represents layer-7 (“L7”) network operations and functionalities. The actual precise boundary locations between the layers may vary depending on particular implementations.

FIG. 24B shows use of a layer-2-over-layer-3 encapsulation technology in a virtualized network communications scheme. FIG. 24B uses similar illustration conventions as used in FIG. 24A. The first application 2406 again employs an operating-system call 2408 to send a message 2410 stored in local memory accessible to the first application. However, the system call, in this case, is received by a guest operating system 2440 running within a virtual machine. The guest operating system queues the message for transmission to a virtual NIC 2442 (“vNIC”), which transmits L2 data frames 2444 to a virtual communications medium. What this means, in the described implementation, is that the L2 data frames are received by a hypervisor 2446, which packages the L2 data frames into L3 data packets and then either directly, or via an operating system, provides the L3 data packets to a physical NIC 2420 for transmission to a receiving physical NIC 2424 via a physical communications medium. In other words, the L2 data frames produced by the virtual NIC are encapsulated in higher-level-protocol packets or messages that are then transmitted through a normal communications protocol stack and associated devices and components. The receiving physical NIC reconstructs the L3 data packets and provides them to a hypervisor and/or operating system 2448 on the receiving computer system, which unpackages the L2 data frames 2450 and provides the L2 data frames to a vNIC 2452. The vNIC, in turn, reconstructs a message or messages from the L2 data frames and provides a message to a guest operating system 2454, which reconstructs the original application-layer message 2456 in application-accessible memory. Of course, the same process can be used by the application 2412 on the second computer system to send messages to the application 2406 and the first computer system.

The layer-2-over-layer-3 encapsulation technology provides a basis for generating complex virtual networks and associated virtual-network elements, such as firewalls, routers, edge routers, and other virtual-network elements within a virtual data centers, discussed above, with reference to FIGS. 7-10, in the context of a preceding discussion of virtualization technologies that references FIGS. 4-6. Virtual machines and vNICs are implemented by a virtualization layer, and the layer-2-over-layer-3 encapsulation technology allows the L2 data frames generated by a vNIC implemented by the virtualization layer to be physically transmitted, over physical communications facilities, in higher-level protocol messages or, in some cases, over internal buses within a server, providing a relatively simple interface between virtualized networks and physical communications networks.

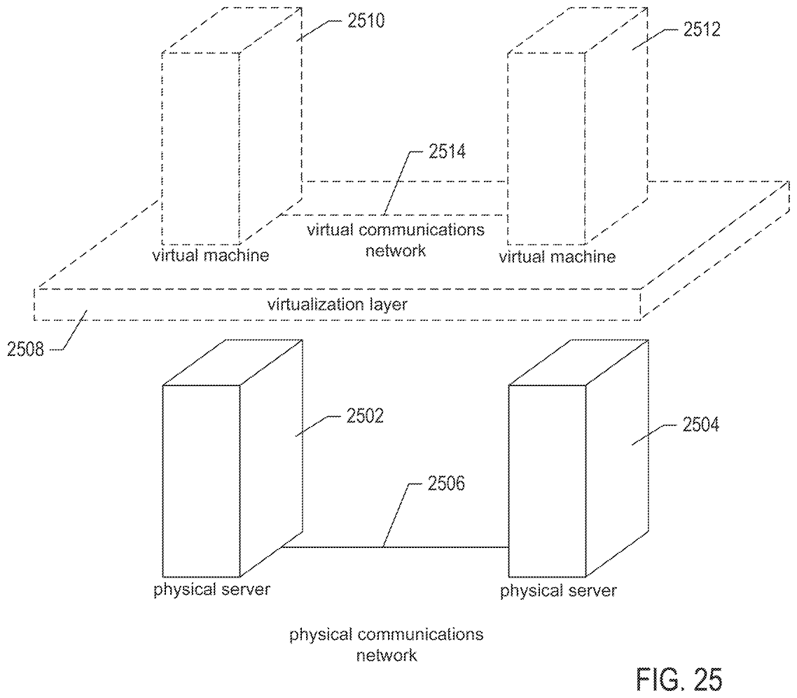

FIG. 25 illustrates virtualization of two communicating servers. A first physical server 2502 and a second physical server 2504 are interconnected by physical communications network 2506 in the lower portion of FIG. 25. Virtualization layers running on both physical servers together compose a distributed virtualization layer 2508, which can then implement a first virtual machine (“VM”) 2510 and a second VM 2512 that are interconnected by a virtual communications network 2514. The first VM and the second VM may both execute on the first physical server, may both execute on the second physical server, or one VM may execute on one of the two physical servers and the other VM may execute on another of the two physical servers. The VMs may move from one physical server to another while executing applications and guest operating systems. The characteristics of the VMs, including computational bandwidths, memory capacities, instruction sets, and other characteristics, may differ from the characteristics of the underlying servers. Similarly, the characteristics of the virtual communications network 2514 may differ from the characteristics of the physical communications network 2506. As one example, the virtual communications network 2514 may provide for interconnection of 10, 20, or more virtual machines, and may include multiple local virtual networks bridged by virtual switches or virtual routers, while the physical communications network 2506 may be a local area network (“LAN”) or point-to-point data exchange medium that connects only the two physical servers to one another. In essence, the virtualization layer 2508 can construct any number of different virtual machines and virtual communications networks based on the underlying physical servers and physical communications network. Of course, the virtual machines' operational capabilities, such as computational bandwidths, are constrained by the aggregate operational capabilities of the two physical servers and the virtual networks' operational capabilities are constrained by the aggregate operational capabilities of the underlying physical communications network, but the virtualization layer can partition the operational capabilities in many different ways among many different virtual entities, including virtual machines and virtual networks.

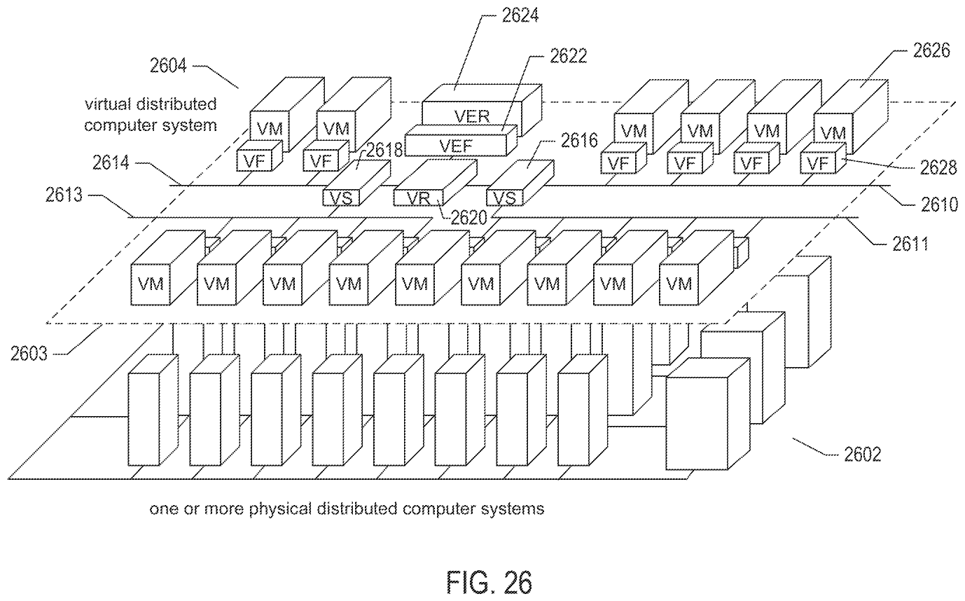

FIG. 26 illustrates a virtual distributed computer system based on one or more distributed computer systems. The one or more physical distributed computer systems 2602 underlying the virtual/physical boundary 2603 are abstracted, by virtualization layers running within the physical servers, as a virtual distributed computer system 2604 shown above the virtual/physical boundary. In the virtual distributed computer system 2604, there are numerous virtual local area networks (“LANs”) 2610-2614 interconnected by virtual switches (“vSs”) 2616 and 2618 to one another and to a virtual router (“vR”)2621. The vR interconnects the virtual router through a virtual edge-router firewall (“vEF”)2622 to a virtual edge router (“vER”)2624 that, in turn, interconnects the virtual distributed computer system with external data centers, external computers, and other external network-communications-enable devices and systems. A large number of virtual machines, such as virtual machine 2626, are connected to the LANs through virtual firewalls (“vFs”), such as vF 2628. The VMs, vFs, vSs, vR, vEF, and vER are implemented largely by execution of stored computer instructions by the hypervisors within the physical servers, and while underlying physical resources of the one or more physical distributed computer systems are employed to implement the virtual distributed computer system. The components, topology, and organization of the virtual distributed computer system are largely independent from the underlying one or more physical distributed computer systems.

Virtualization provides many important and significant advantages. Virtualized distributed computer systems can be configured and launched in time frames ranging from seconds to minutes, while physical distributed computer systems often require weeks or months for construction and configuration. Virtual machines can emulate many different types of physical computer systems with many different types of physical computer-system architectures, so that a virtual distributed computer system can run many different operating systems, as guest operating systems, that would otherwise not be compatible with the physical servers of the underlying one or more physical distributed computer systems. Similarly, virtual networks can provide capabilities that are not available in the underlying physical networks. As one example, the virtualized distributed computer system can provide firewall security to each virtual machine using vFs, as shown in FIG. 26. This allows a much finer granularity of network-communications security, referred to as “microsegmentation,” than can be provided by the underlying physical networks. Additionally, virtual networks allow for partitioning of the physical resources of an underlying physical distributed computer system into multiple virtual distributed computer systems, each owned and managed by different organizations and individuals, that are each provided full security through completely separate internal virtual LANs connected to virtual edge routers. Virtualization thus provides capabilities and facilities that are unavailable in non-virtualized distributed computer systems and that provide enormous improvements in the computational services that can be obtained from a distributed computer system.

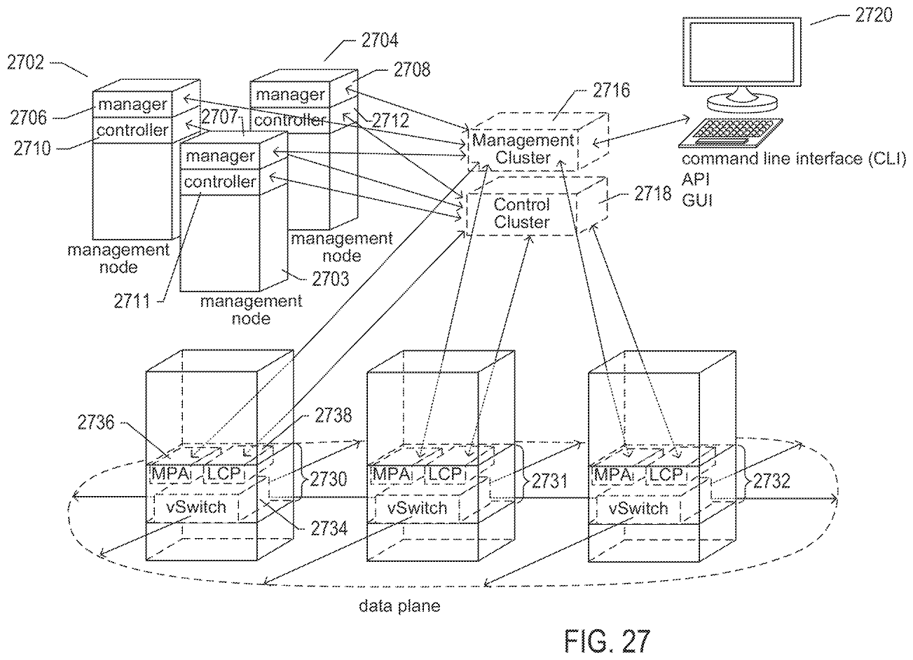

FIG. 27 illustrates components of several implementations of a virtual network within a distributed computing system. The virtual network is managed by a set of three or more management nodes 2702-2704, each including a manager instance 2706-2708 and a controller instance 2710-2712. The manager instances together comprise a management cluster 2716 and the controllers together comprise a control cluster 2718. The management cluster is responsible for configuration and orchestration of the various virtual networking components of the virtual network, discussed above, and provisioning of a variety of different networking, edge, and security services. The management cluster additionally provides administration and management interfaces 2720, including a command-line interface (“CLI”), an application programming interface (“API”), and a graphical-user interface (“GUI”), through which administrators and managers can configure and manage the virtual network. The control cluster is responsible for propagating configuration data to virtual-network components implemented by hypervisors within physical servers and facilitates various types of virtual-network services. The virtual-network components implemented by the hypervisors within physical servers 2730-2732 provide for communications of messages and other data between virtual machines, and are collectively referred to as the “data plane.” Each hypervisor generally includes a virtual switch, such as virtual switch 2734, a management-plane agent, such as management-plane agent 2736, and a local-control-plane instance, such as local-control-plane instance 2738, and other virtual-network components. A virtual network within the virtual distributed computing system is, therefore, a large and complex subsystem with many components and associated data-specified configurations and states.

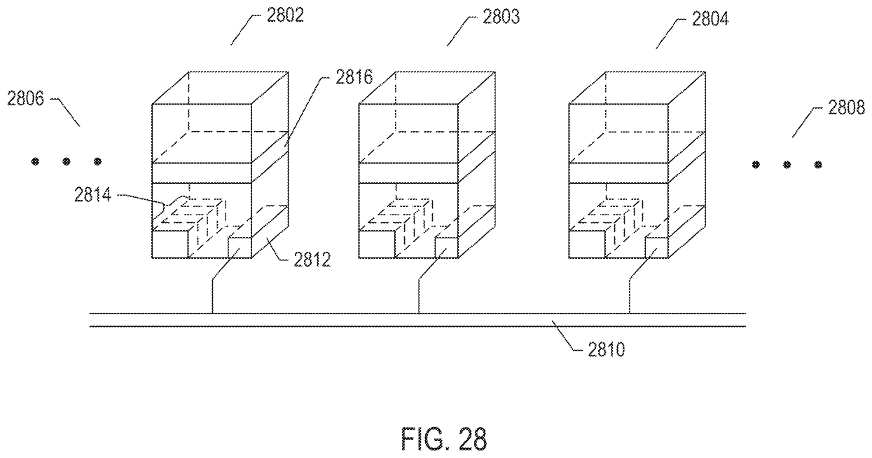

FIG. 28 illustrates a number of server computers, within a distributed computer system, interconnected by physical local area network. Representations of three server computers 2802-2804 are shown in FIG. 28, with ellipses 2806 and 2808 indicating that additional servers may be attached to the local area network 2010. Each server, including server 2802, includes communications hardware 2812, multiple data-storage devices 2814, and a virtualization layer 2816. Of course, the server computers include many additional hardware components below the virtualization layer and include many additional computer-instruction-implemented components above the virtualization layer, including guest operating systems and virtual machines. The servers may be connected to multiple physical communications media, including a dedicated storage area network (“SAN”) that allows the computers to access network-attached storage devices.

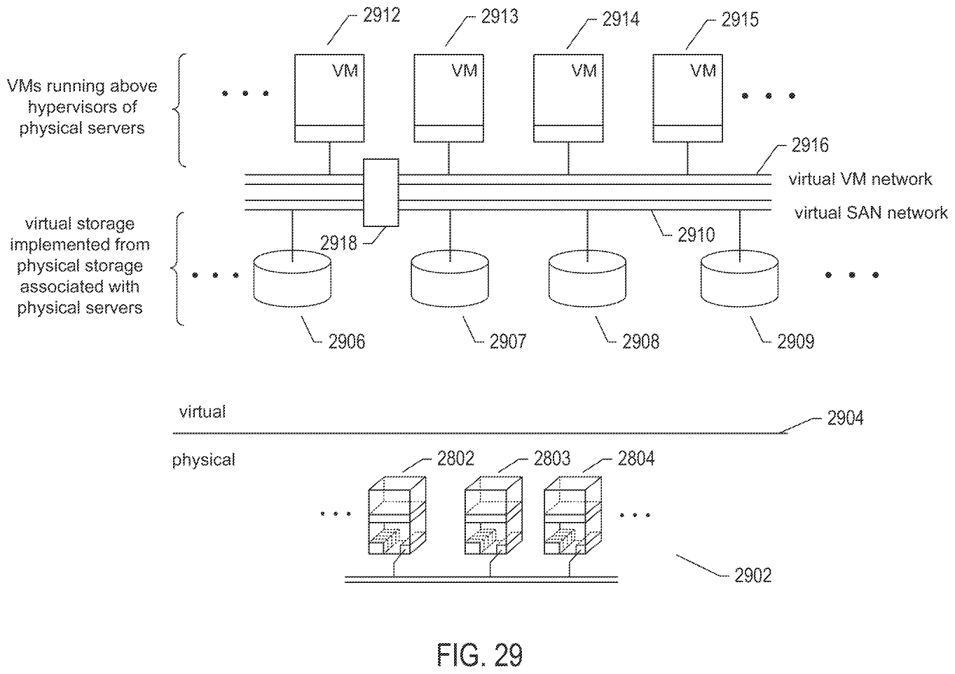

FIG. 29 illustrates a virtual storage-area network (“VSAN”). In FIG. 29, the networked servers discussed above with reference to FIG. 28 are again shown 2902 below a horizontal line 2904 that represents the boundary between the VSAN, shown above the horizontal line, and the physical networked servers below the horizontal line. A VSAN is a virtual SAN that uses virtual networking and virtualization-layer VSAN logic to create one or more virtual network-attached storage devices accessible to virtual machines running within the physical servers via a virtual SAN, just as virtual machines run in virtual execution environments created from physical computer hardware by virtualization layers. The virtualization layers within the physical servers 2802-2804 each includes VSAN logic that pools unused local data-storage resources within each of the physical servers to create one or more virtual network-attached storage devices 2906-2909. The VSAN logic employs virtual networking to connect these virtual network-attached storage devices to a virtual SAN network 2910. Virtual machines 2912-2915 running within the physical servers are interconnected by a virtual-machine local-area network 2916, so that the virtual machines are able to access the virtual network-attached storage devices via a virtual bridge or switch 2918 that interconnects the virtual-machine local-area network 2916 to the virtual SAN. This allows a group of virtual machines to access pooled physical data storage distributed across multiple physical servers via SAN protocols and logic. The virtual-machine execution environments, virtual networking, and VSANs are virtual components of the virtual data centers and virtual distributed-computing systems discussed in previous sections of this document.

### Neural Networks

FIG. 30 illustrates fundamental components of a feed-forward neural network. Expressions 3002 mathematically represent ideal operation of a neural network as a function ƒ(x). The function receives an input vector x and outputs a corresponding output vector y 1103. For example, an input vector may be a digital image represented by a two-dimensional array of pixel values in an electronic document or may be an ordered set of numeric or alphanumeric values. Similarly, the output vector may be, for example, an altered digital image, an ordered set of one or more numeric or alphanumeric values, an electronic document, or one or more numeric values. The initial expression of expressions 3002 represents the ideal operation of the neural network. In other words, the output vector y represents the ideal, or desired, output for corresponding input vector x. However, in actual operation, a physically implemented neural network \hat{ƒ}(x), as represented by the second expression of expressions 3002, returns a physically generated output vector ŷ that may differ from the ideal or desired output vector y. An output vector produced by the physically implemented neural network is associated with an error or loss value. A common error or loss value is the square of the distance between the two points represented by the ideal output vector y and the output vector produced by the neural network ŷ. The distance between the two points represented by the ideal output vector and the output vector produced by the neural network, with optional scaling, may also be used as the error or loss. A neural network is trained using a training dataset comprising input-vector/ideal-output-vector pairs, generally obtained by human or human-assisted assignment of ideal-output vectors to selected input vectors. The ideal-output vectors in the training dataset are often referred to as “labels.” During training, the error associated with each output vector, produced by the neural network in response to input to the neural network of a training-dataset input vector, is used to adjust internal weights within the neural network in order to minimize the error or loss. Thus, the accuracy and reliability of a trained neural network is highly dependent on the accuracy and completeness of the training dataset.

As shown in the middle portion 3006 of FIG. 30, a feed-forward neural network generally consists of layers of nodes, including an input layer 3008, an output layer 3010, and one or more hidden layers 3012. These layers can be numerically labeled 1, 2, 3, . . . , L−1, L, as shown in FIG. 30. In general, the input layer contains a node for each element of the input vector and the output layer contains one node for each element of the output vector. The input layer and/or output layer may each have one or more nodes. In the following discussion, the nodes of a first level with a numeric label lower in value than that of a second layer are referred to as being higher-level nodes with respect to the nodes of the second layer. The input-layer nodes are thus the highest-level nodes. The nodes are interconnected to form a graph, as indicated by line segments, such as line segment 3014.

The lower portion of FIG. 30 (3020 in FIG. 30) illustrates a feed-forward neural-network node. The neural-network node 3022 receives inputs 3024-3027 from one or more next-higher-level nodes and generates an output 3028 that is distributed to one or more next-lower-level nodes 3030. The inputs and outputs are referred to as “activations,” represented by superscripted-and-subscripted symbols “a” in FIG. 30, such as the activation symbol 3024. An input component 3036 within a node collects the input activations and generates a weighted sum of these input activations to which a weighted internal activation a₀ is added. An activation component 3038 within the node is represented by a function g( ), referred to as an “activation function,” that is used in an output component 3040 of the node to generate the output activation of the node based on the input collected by the input component 3036. The neural-network node 3022 represents a generic hidden-layer node. Input-layer nodes lack the input component 3036 and each receive a single input value representing an element of an input vector. Output-component nodes output a single value representing an element of the output vector. The values of the weights used to generate the cumulative input by the input component 3036 are determined by training, as previously mentioned. In general, the input, outputs, and activation function are predetermined and constant, although, in certain types of neural networks, these may also be at least partly adjustable parameters. In FIG. 30, three different possible activation functions are indicated by expressions 3042-3044. The first expression is a binary activation function and the third expression represents a sigmoidal relationship between input and output that is commonly used in neural networks and other types of machine-learning systems, both functions producing an activation in the range [0, 1]. The second function is also sigmoidal, but produces an activation in the range [−1, 1].

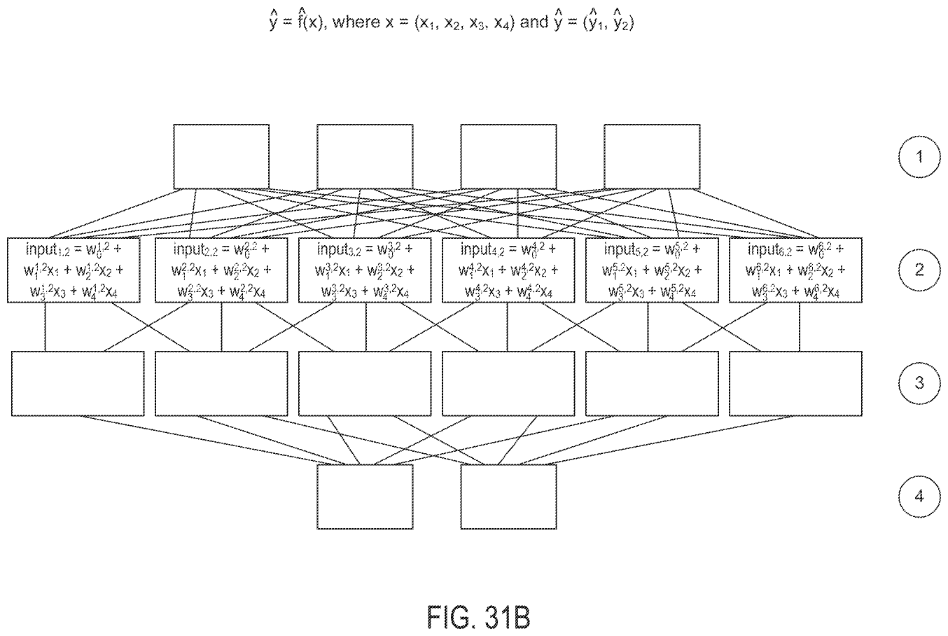

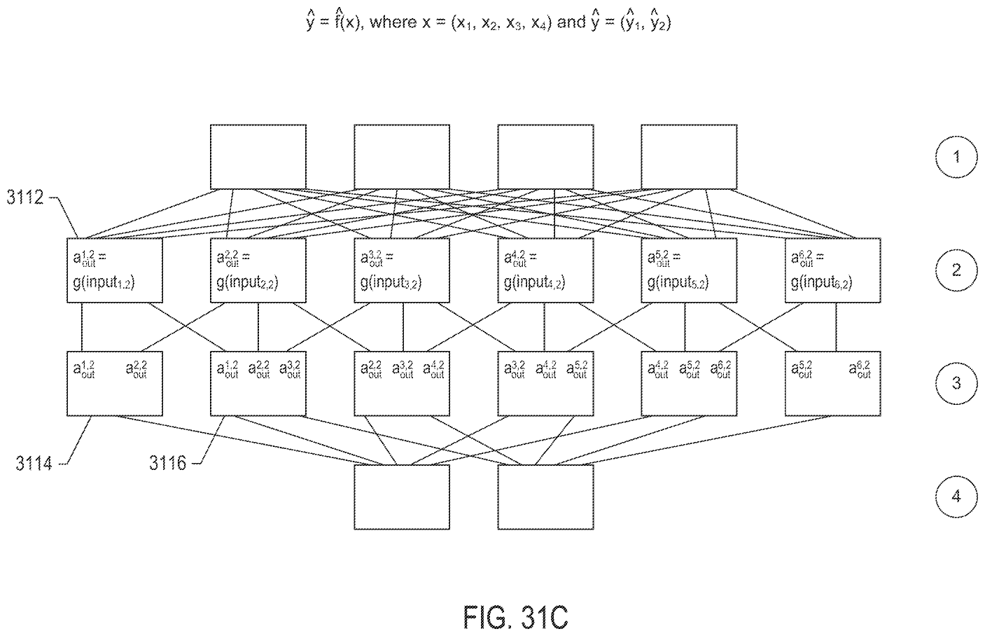

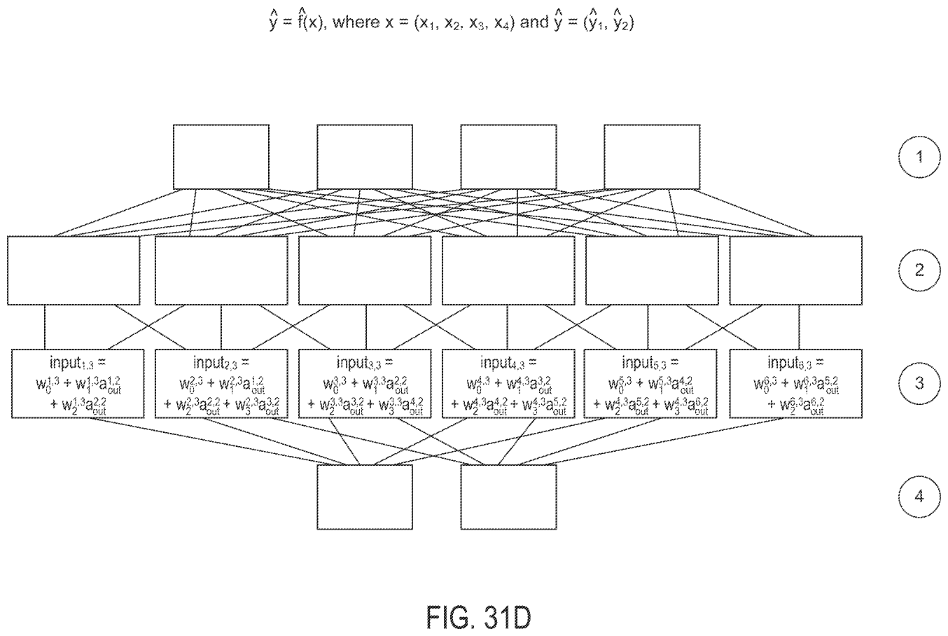

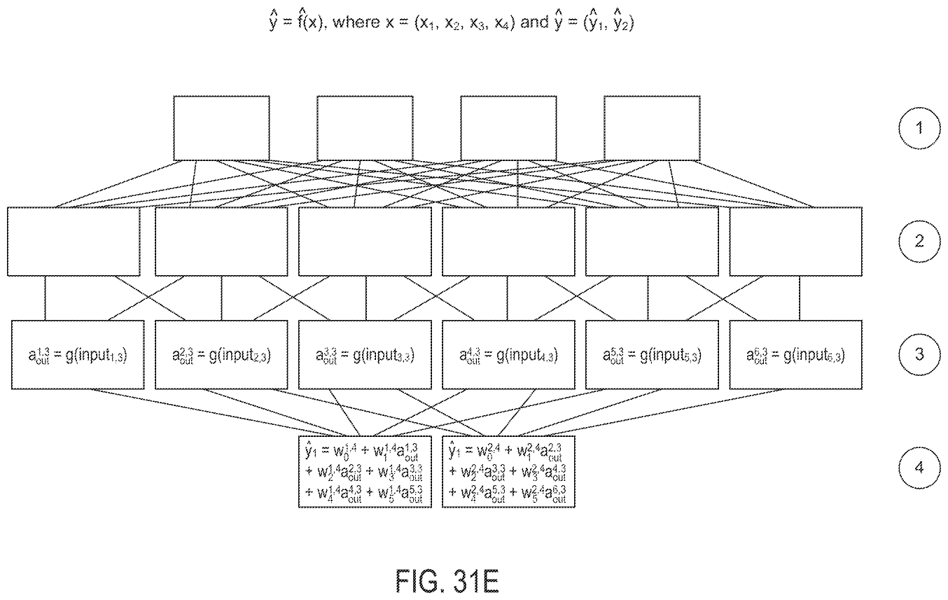

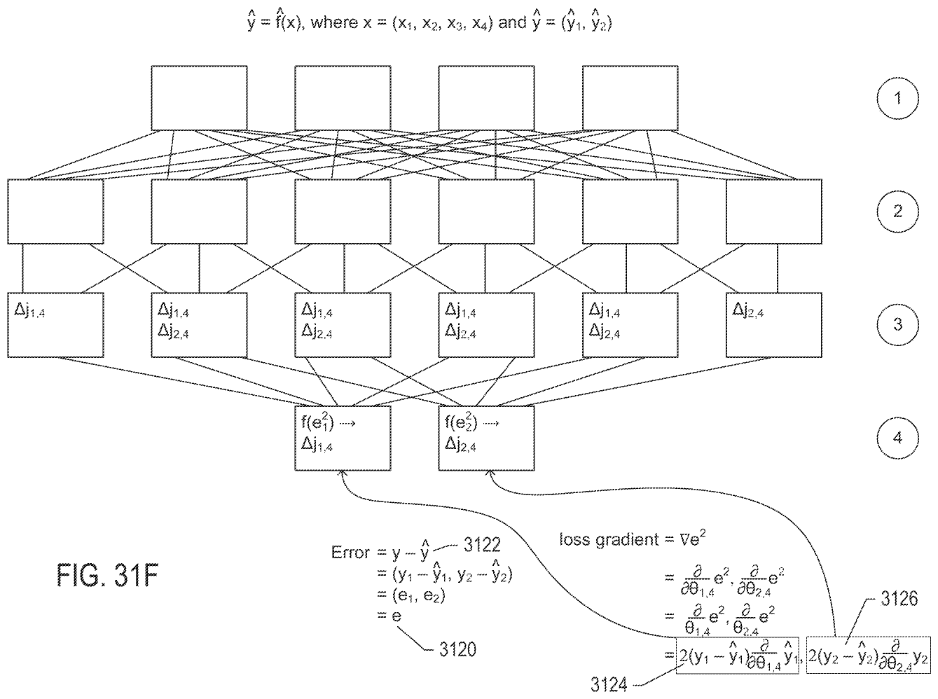

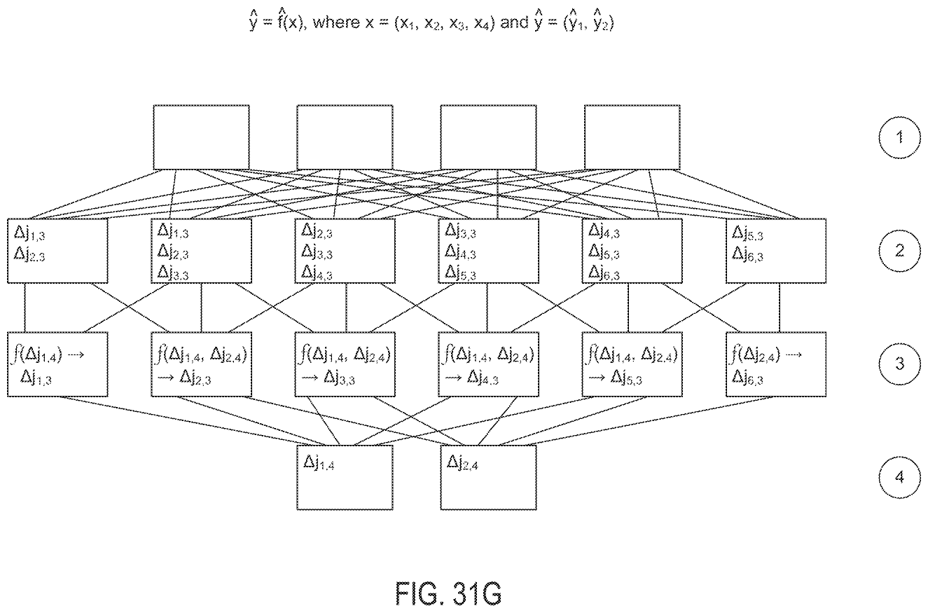

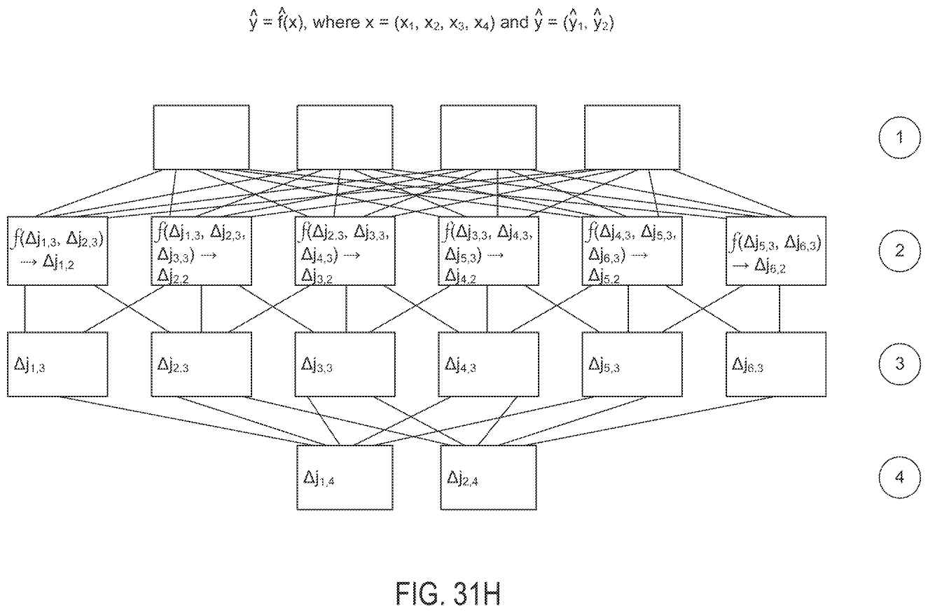

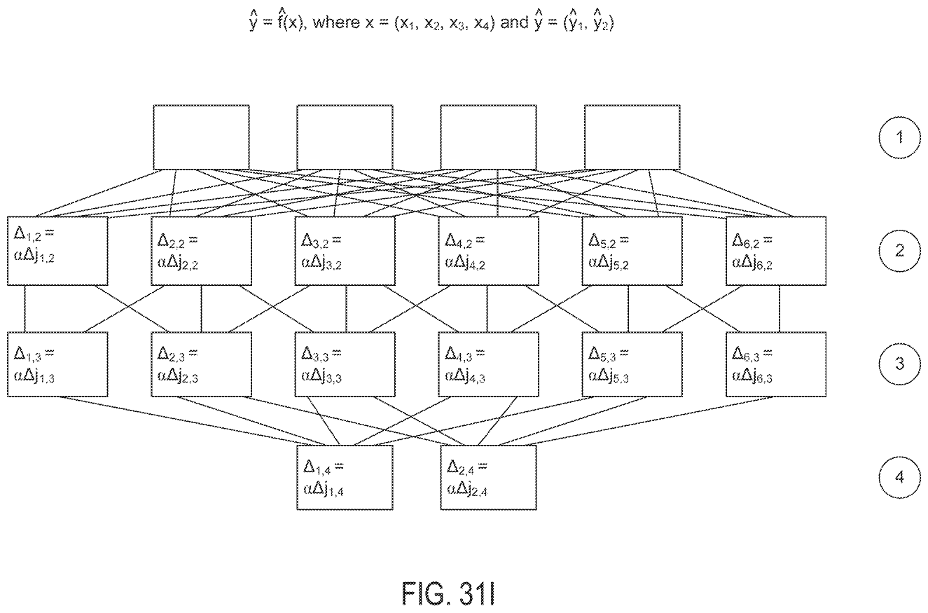

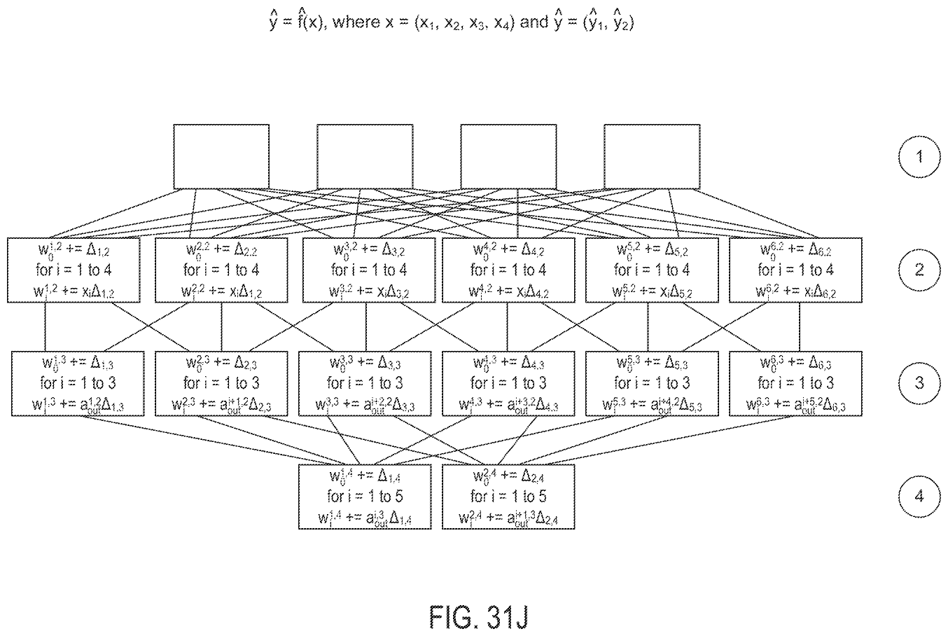

FIGS. 31A-J illustrate operation of a very small, example neural network. The example neural network has four input nodes in a first layer 3102, six nodes in a first hidden layer 3104 six nodes in a second hidden layer 3106, and two output nodes 3108. As shown in FIG. 31A, the four elements of the input vector x 3110 are each input to one of the four input nodes which then output these input values to the nodes of the first-hidden layer to which they are connected. In the example neural network, each input node is connected to all of the nodes in the first hidden layer. As a result, each node in the first hidden layer has received the four input-vector elements, as indicated in FIG. 31A. As shown in FIG. 31B, each of the first-hidden-layer nodes computes a weighted-sum input according to the expression contained in the input components (3036 in FIG. 30) of the first hidden-layer nodes. Note that, although each first-hidden-layer node receives the same four input-vector elements, the weighted-sum input computed by each first-hidden-layer node is generally different from the weighted-sum inputs computed by the other first-hidden-layer nodes, since each first-hidden-layer node generally uses a set of weights unique to the first-hidden-layer node. As shown in FIG. 31C, the activation component (3038 in FIG. 30) of each of the first-hidden-layer nodes next computes an activation and then outputs the computed activation to each of the second-hidden-layer nodes to which the first-hidden-layer node is connected. Thus, for example, the first-hidden-layer node 3112 computes activation aₒᵤₜ^{1,2} using the activation function and outputs this activation to second-hidden-layer nodes 3114 and 3116. As shown in FIG. 31D, the input components (3036 in FIG. 30) of the second-hidden-layer nodes compute weighted-sum inputs from the activations received from the first-hidden-layer nodes to which they are connected and then, as shown in FIG. 31E, compute activations from the weighted-sum inputs and output the activations to the output-layer nodes to which they are connected. The output-layer nodes compute weighted sums of the inputs and then output those weighted sums as elements of the output vector.

FIG. 31F illustrates backpropagation of an error computed for an output vector. Backpropagation of a loss in the reverse direction through the neural network results in a change in some or all of the neural-network-node weights and is the mechanism by which a neural network is trained. The error vector e 3120 is computed as the difference between the desired output vector y and the output vector ŷ (3122 in FIG. 31F) produced by the neural network in response to input of the vector x. The output-layer nodes each receive a squared element of the error vector and compute a component of a gradient of the squared length of the error vector with respect to the parameters θ of the neural-network, which are the weights. Thus, in the current example, the squared length of the error vector e is equal to |e|² or e₁²+e₂², and the loss gradient is equal to:

$${∇}_{θ} ( {e}_{1}^{2} + {e}_{2}^{2} ) = \frac{\partial }{\partial θ} {e}_{1}^{2} , \frac{\partial }{\partial θ} {e}_{2}^{2} .$$

Since each output-layer neural-network node represents one dimension of the multi-dimensional output, each output-layer neural-network node receives one term of the squared distance of the error vector and computes the partial differential of that term with respect to the parameters, or weights, of the output-layer neural-network node. Thus, the first output-layer neural-network node receives e₁² and computes

$$\frac{\partial }{\partial {θ}_{1 , 4}} {e}_{1}^{2} ,$$

where the subscript 1,4 indicates parameters for the first node of the fourth, or output, layer. The output-layer neural-network nodes then compute this partial derivative, as indicated by expressions 3124 and 3126 in FIG. 31F. The computations are discussed later. However, to follow the backpropagation diagrammatically, each node of the output layer receives a term of the squared length of the error vector which is input to a function that returns a weight adjustment Δⱼ. As shown in FIG. 31F, the weight adjustment computed by each of the output nodes is back propagated upward to the second-hidden-layer nodes to which the output node is connected. Next, as shown in FIG. 31G, each of the second-hidden-layer nodes computes a weight adjustment Δⱼ from the weight adjustments received from the output-layer nodes and propagates the computed weight adjustments upward in the neural network to the first-hidden-layer nodes to which the second-hidden-layer node is connected. Finally, as shown in FIG. 31H, the first-hidden-layer nodes computes weight adjustments based on the weight adjustments received from the second-hidden-layer nodes. These weight adjustments are not, however, back propagated further upward in the neural network since the input-layer nodes do not compute weighted sums of input activations, instead each receiving only a single element of the input vector x.

In a next logical step, shown in FIG. 31I, the computed weight adjustments are multiplied by a learning constant α to produce final weight adjustments Δ for each node in the neural network. In general, each final weight adjustment is specific and unique for each neural-network node, since each weight adjustment is computed based on a node's weights and the weights of lower-level nodes connected to a node via a path in the neural network. The logical step shown in FIG. 31I is not, in practice, a separate discrete step since the final weight adjustments can be computed immediately following computation of the initial weight adjustment by each node. Similarly, as shown in FIG. 31J, in a final logical step, each node adjusts its weights using the computed final weight adjustment for the node. Again, this final logical step is, in practice, not a discrete separate step since a node can adjust its weights as soon as the final weight adjustment for the node is computed. It should be noted that the weight adjustment made by each node involves both the final weight adjustment computed by the node as well as the inputs received by the node during computation of the output vector ŷ from which the error vector e was computed, as discussed above with reference to FIG. 31F. The weight adjustment carried out by each node shift the weights in each node toward producing an output that, together with the outputs produced by all the other nodes following weight adjustment, results in decreasing the distance between the desired output vector y and the output vector ŷ that would now be produced by the neural network in response to receiving the input vector x. In many neural-network implementations, it is possible to make batched adjustments to the neural-network weights based on multiple output vectors produced from multiple inputs, as discussed further below.

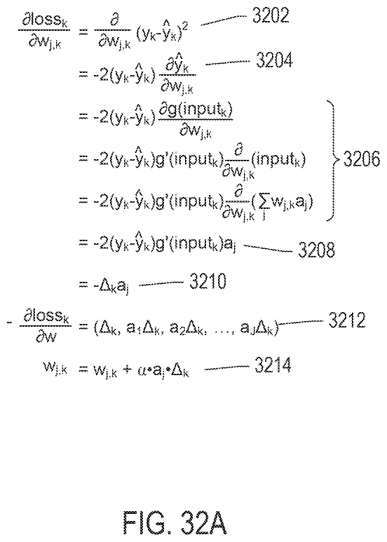

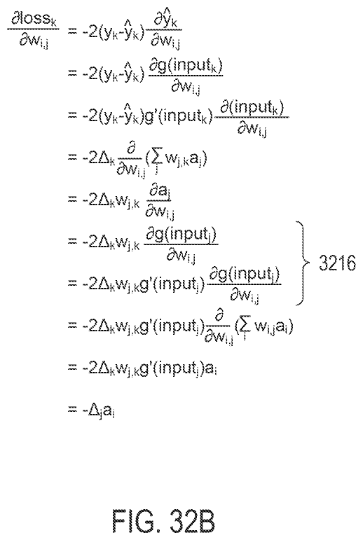

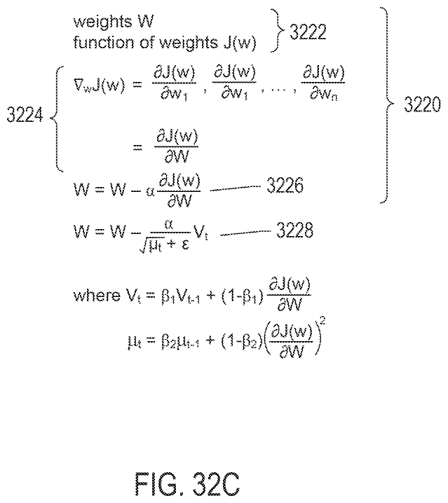

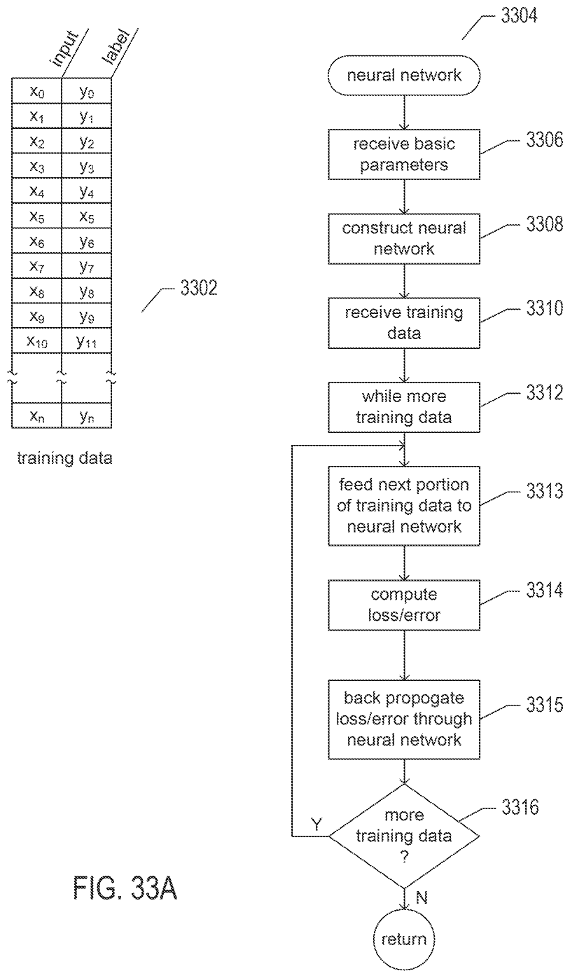

FIGS. 32A-C show details of the computation of weight adjustments made by neural-network nodes during backpropagation of error vectors into neural networks. The expression 3202 in FIG. 32A represents the partial differential of the loss, or k^{th} component of the squared length of the error vector eₖ², computed by the k^{th} output-layer neural-network node with respect to the J+1 weights applied to the formal 0^{th} input a₀ and inputs a₁-a_{J} received from higher-level nodes. Application of the chain rule for partial differentiation produces expression 3204. Substitution of the activation function for ŷₖ in the second application of the chain rule produces expressions 3206. The partial differential of the sum of weighted activations with respect to the weight for activation j is simply activation j, aⱼ, generating expression 3208. The initial factors in expression 3208 are replaced by −Δₖ to produce a final expression for the partial differential of the k^{th} component of the loss with respect to the j^{th} weight, 3210. The negative gradient of the weight adjustments is used in backpropagation in order to minimize the loss, as indicated by expression 3212. Thus, the j^{th} weight for the k^{th} output-layer neural-network node is adjusted according to expression 3214, where α is a learning-rate constant in the range [0,1].

FIG. 32B illustrates computation of the weight adjustment for the kth component of the error vector in a final-hidden-layer neural-network node. This computation is similar to that discussed above with reference to FIG. 32A, but includes an additional application of the chain rule for partial differentiation in expressions 3216 in order to obtain an expression for the partial differential with respect to a second-hidden-layer-node weight that includes an output-layer-node weight adjustment.

FIG. 32C illustrates one commonly used improvement over the above-described weight-adjustment computations. The above-described weight-adjustment computations are summarized in expressions 3220. There is a set of weights W and a function of the weights J(W), as indicated by expressions 3222. The backpropagation of errors through the neural network is based on the gradient, with respect to the weights, of the function J(W), as indicated by expressions 3224. The weight adjustment is represented by expression 3226, in which a learning constant times the gradient of the function J(W) is subtracted from the weights to generate the new, adjusted weights. In the improvement illustrated in FIG. 32C, expression 3226 is modified to produce expression 3228 for the weight adjustment. In the improved weight adjustment, the learning constant α is divided by the sum of a weighted average of adjustments and a very small additional term F and the gradient is replaced by the factor Vₜ, where t represents time or, equivalently, the current weight adjustment in a series of weight adjustments. The factor Vₜ is a combination of the factor for the preceding time point or weight adjustment Vₜ₋₁ and the gradient computed for the current time point or weight adjustment. This factor is intended to add momentum to the gradient descent in order to avoid premature completion of the gradient-descent process at a local minimum. Division of the learning constant α by the weighted average of adjustments adjusts the learning rate over the course of the gradient descent so that the gradient descent converges in a reasonable period of time.

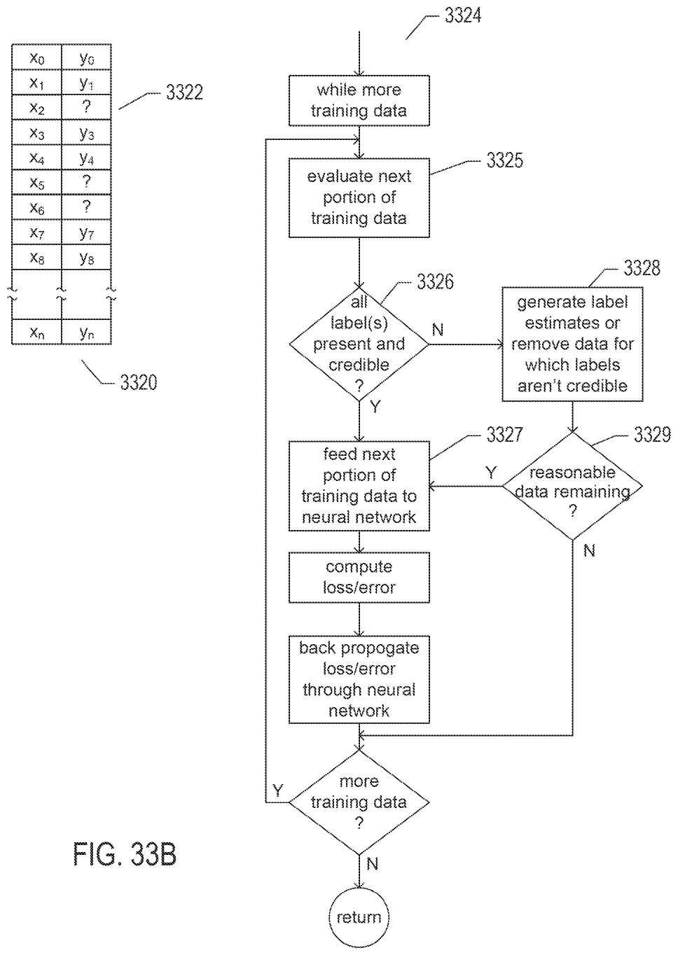

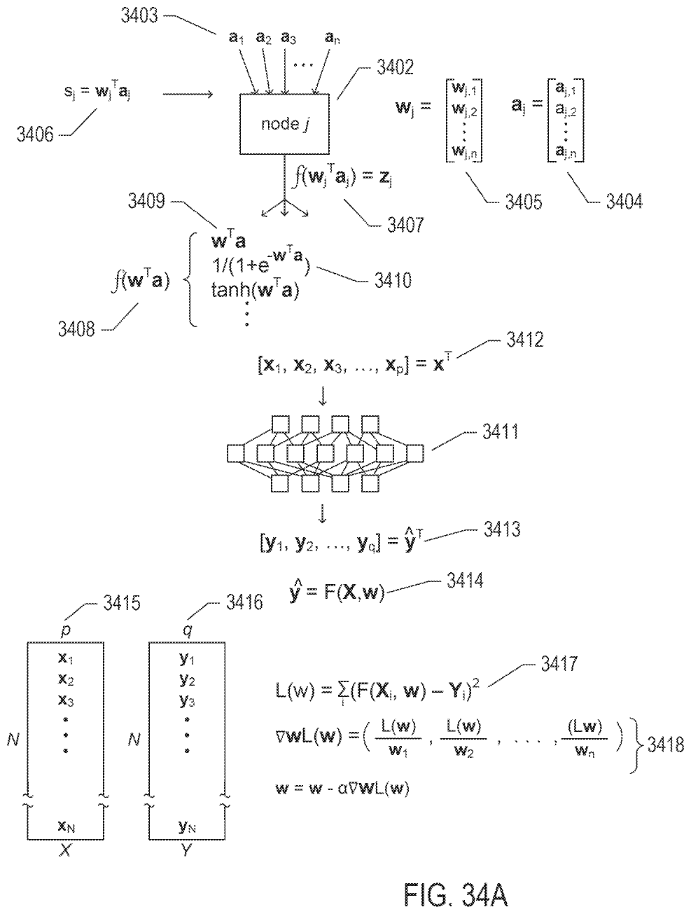

FIGS. 33A-B illustrate neural-network training. FIG. 33A illustrates the construction and training of a neural network using a complete and accurate training dataset. The training dataset is shown as a table of input-vector/label pairs 3302, in which each row represents an input-vector/label pair. The control-flow diagram 3304 illustrates construction and training of a neural network using the training dataset. In step 3306, basic parameters for the neural network are received, such as the number of layers, number of nodes in each layer, node interconnections, and activation functions. In step 3308, the specified neural network is constructed. This involves building representations of the nodes, node connections, activation functions, and other components of the neural network in one or more electronic memories and may involve, in certain cases, various types of code generation, resource allocation and scheduling, and other operations to produce a fully configured neural network that can receive input data and generate corresponding outputs. In many cases, for example, the neural network may be distributed among multiple computer systems and may employ dedicated communications and shared memory for propagation of activations and total error or loss between nodes. It should again be emphasized that a neural network is a physical system comprising one or more computer systems, communications subsystems, and often multiple instances of computer-instruction-implemented control components.

In step 3310, training data represented by table 3302 is received. Then, in the while-loop of steps 3312-3316, portions of the training data are iteratively input to the neural network, in step 3313, the loss or error is computed, in step 3314, and the computed loss or error is back-propagated through the neural network step 3315 to adjust the weights. The control-flow diagram refers to portions of the training data rather than individual input-vector/label pairs because, in certain cases, groups of input-vector/label pairs are processed together to generate a cumulative error that is back-propagated through the neural network. A portion may, of course, include only a single input-vector/label pair.

FIG. 33B illustrates one method of training a neural network using an incomplete training dataset. Table 3320 represents the incomplete training dataset. For certain of the input-vector/label pairs, the label is represented by a “?” symbol, such as in the input-vector/label pair 3322. The “?” symbol indicates that the correct value for the label is unavailable. This type of incomplete data set may arise from a variety of different factors, including inaccurate labeling by human annotators, various types of data loss incurred during collection, storage, and processing of training datasets, and other such factors. The control-flow diagram 3324 illustrates alterations in the while-loop of steps 3312-3316 in FIG. 33A that might be employed to train the neural network using the incomplete training dataset. In step 3325, a next portion of the training dataset is evaluated to determine the status of the labels in the next portion of the training data. When all of the labels are present and credible, as determined in step 3326, the next portion of the training dataset is input to the neural network, in step 3327, as in FIG. 33A. However, when certain labels are missing or lack credibility, as determined in step 3326, the input-vector/label pairs that include those labels are removed or altered to include better estimates of the label values, in step 3328. When there is reasonable training data remaining in the training-data portion following step 3328, as determined in step 3329, the remaining reasonable data is input to the neural network in step 3327. The remaining steps in the while-loop are equivalent to those in the control-flow diagram shown in FIG. 33A. Thus, in this approach, either suspect data is removed, or better labels are estimated, based on various criteria, for substitution for the suspect labels.

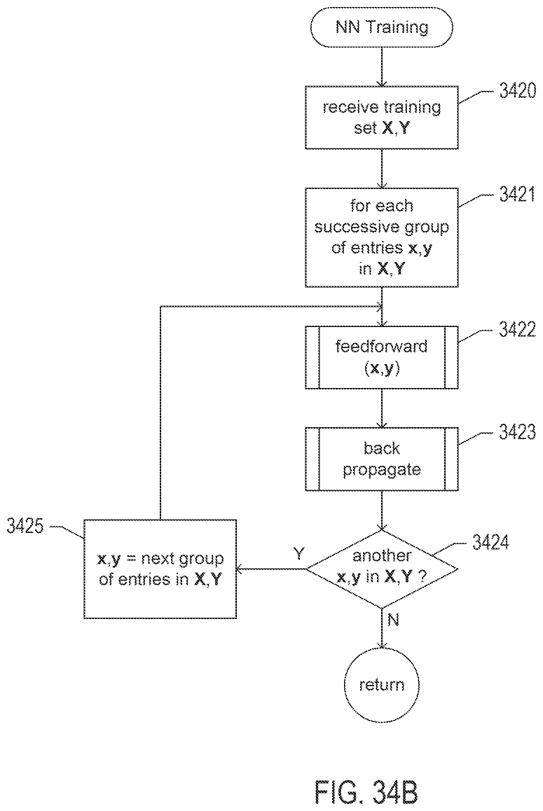

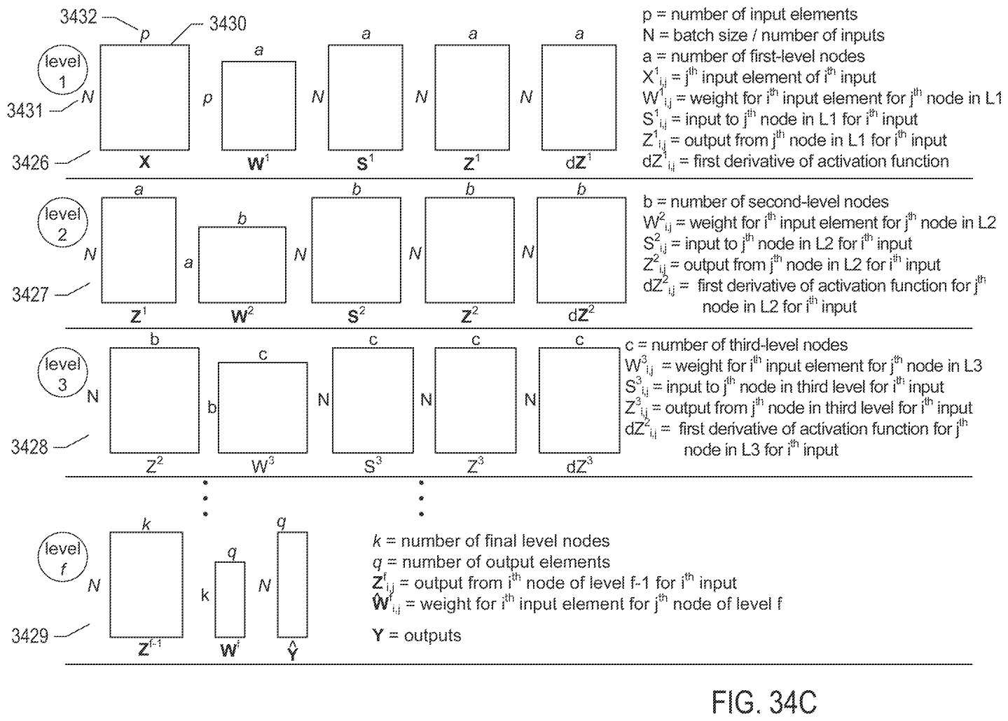

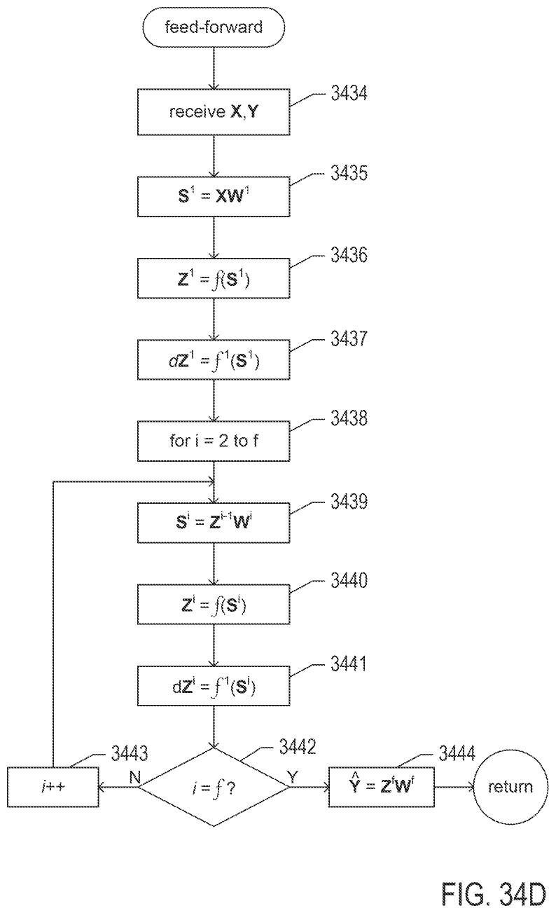

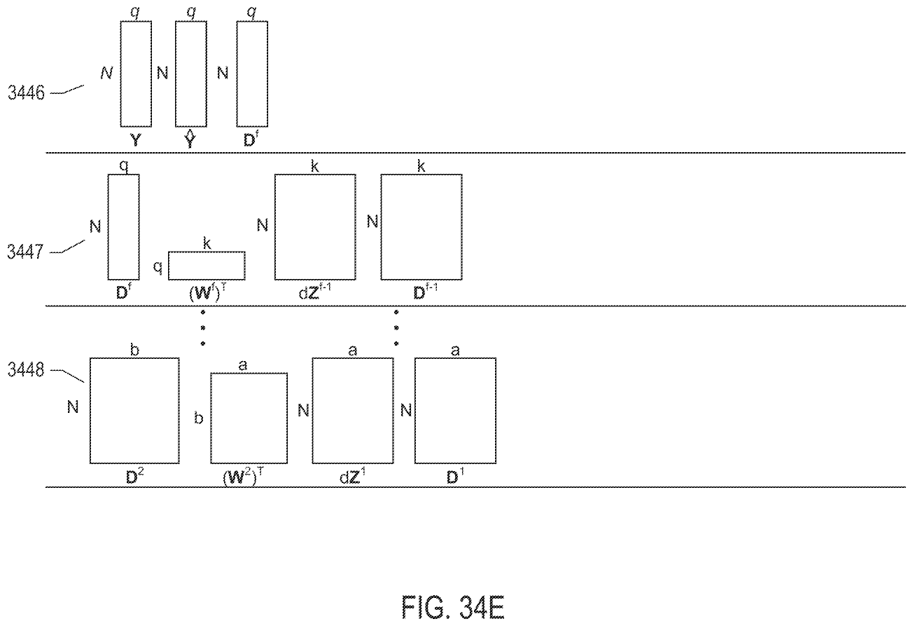

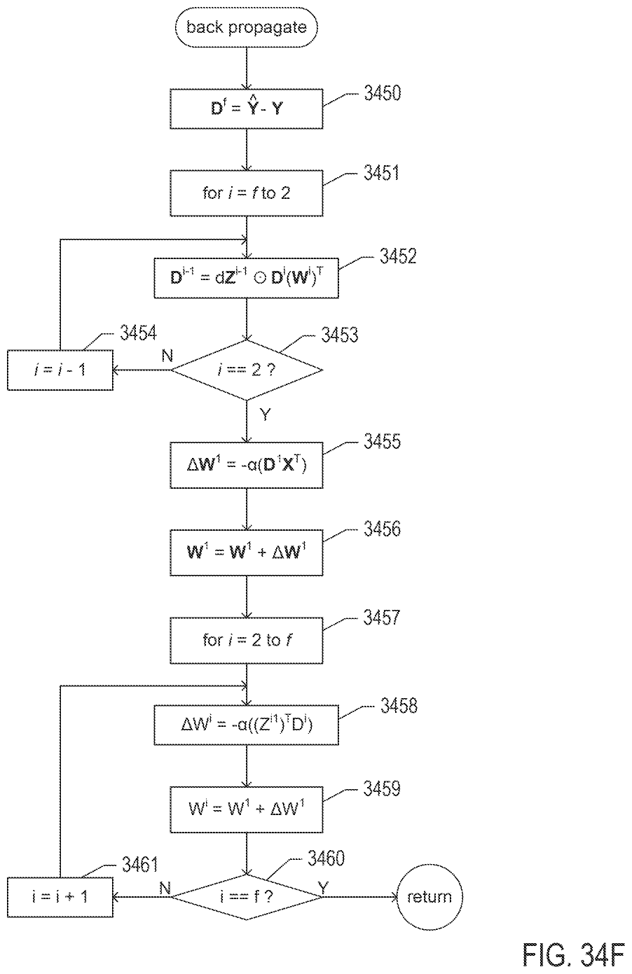

FIGS. 34A-F illustrate a matrix-operation-based batch method for neural-network training. This method processes batches of training data and losses to efficiently train a neural network. FIG. 34A illustrates the neural network and associated terminology. As discussed above, each node in the neural network, such as node j 3402, receives one or more inputs a 3403, expressed as a vector aⱼ 3404, that are multiplied by corresponding weights, expressed as a vector wⱼ 3405, and added together to produce an input signal sⱼ using a vector dot-product operation 3406. An activation function ƒ within the node receives the input signal sⱼ and generates an output signal zⱼ 3407 that is output to all child nodes of node j. Expression 3408 provides an example of various types of activation functions that may be used in the neural network. These include a linear activation function 3409 and a sigmoidal activation function 3410. As discussed above, the neural network 3411 receives a vector of p input values 3412 and outputs a vector of q output values 3413. In other words, the neural network can be thought of as a function F 3414 that receives a vector of input values X^{T} and uses a current set of weights w within the nodes of the neural network to produce a vector of output values ŷ^{T}. The neural network is trained using a training data set comprising a matrix X 3415 of input values, each of N rows in the matrix corresponding to an input vector X^{T}, and a matrix Y 3416 of desired output values, or labels, each of N rows in the matrix corresponding to a desired output-value vector y^{T}. A least-squares loss function is used in training 3417 with the weights updated using a gradient vector generated from the loss function, as indicated in expressions 3418, where a is a constant that corresponds to a learning rate.

FIG. 34B provides a control-flow diagram illustrating the method of neural-network training. In step 3420, the routine “NNTraining” receives the training set comprising matrices X and Y. Then, in the for-loop of steps 3421-3425, the routine “NNTraining” processes successive groups or batches of entries x and y selected from the training set. In step 3422, the routine “NNTraining” calls a routine “feedforward” to process the current batch of entries to generate outputs and, in step 3423, calls a routine “back propagated” to propagate errors back through the neural network in order to adjust the weights associated with each node.

FIG. 34C illustrates various matrices used in the routine “feedforward.” FIG. 34C is divided horizontally into four regions 3426-3429. Region 3426 approximately corresponds to the input level, regions 3427-3428 approximately correspond to hidden-node levels, and region 3429 approximately corresponds to the final output level. The various matrices are represented, in FIG. 34C, as rectangles, such as rectangle 3430 representing the input matrix X. The row and column dimensions of each matrix are indicated, such as the row dimension N 3431 and the column dimension p 3432 for input matrix X 3430. In the right-hand portion of each region in FIG. 34C, descriptions of the matrix-dimension values and matrix elements are provided. In short, the matrices W^{x} represent the weights associated with the nodes at level x, the matrices S^{x} represent the input signals associated with the nodes at level x, the matrices Z^{x} represent the outputs from the nodes at level x, and the matrices dZ^{X} represent the first derivative of the activation function for the nodes at level x evaluated for the input signals.

FIG. 34D provides a control-flow diagram for the routine “feedforward,” called in step 3422 of FIG. 34B. In step 3434, the routine “feedforward” receives a set of training data x and y selected from the training-data matrices X and Y. In step 3435, the routine “feedforward” computes the input signals S¹ for the first layer of nodes by matrix multiplication of matrices x and W¹, where matrix W¹ contains the weights associated with the first-layer nodes. In step 3436, the routine “feedforward” computes the output signals Z¹ for the first-layer nodes by applying a vector-based activation function ƒ to the input signals S¹. In step 3437, the routine “feedforward” computes the values of the derivatives of the activation function ƒ′, dZ¹. Then, in the for-loop of steps 3438-3443, the routine “feedforward” computes the input signals Sⁱ, the output signals Zⁱ, and the derivatives of the activation function dZⁱ for the nodes of the remaining levels of the neural network. Following completion of the for-loop of steps 3438-3443, the routine “feedforward” computes the output values ŷ^{T} for the received set of training data.

FIG. 34E illustrates various matrices used in the routine “back propagate.” FIG. 34E uses similar illustration conventions as used in FIG. 34C, and is also divided horizontally into horizontal regions 3446-3448. Region 3446 approximately corresponds to the output level, region 3447 approximately corresponds to hidden-node levels, and region 3448 approximately corresponds to the first node level. The only new type of matrix shown in FIG. 34E are the matrices D^{x} for node levels x. These matrices contain the error signals that are used to adjust the weights of the nodes.

FIG. 34F provides a control-flow diagram for the routine “back propagate.” In step 3450, the routine “back propagate” computes the first error-signal matrix D^{ƒ} as the difference between the values ŷ output during a previous execution of the routine “feedforward” and the desired output values from the training set y. Then, in a for-loop of steps 3451-3454, the routine “back propagate” computes the remaining error-signal matrices for each of the node levels up to the first node level as the Shur product of the dZ matrix and the product of the transpose of the W matrix and the error-signal matrix for the next lower node level. In step 3455, the routine “back propagate” computes weight adjustments ΔW for the first-level nodes as the negative of the constant α times the product of the transpose of the input-value matrix and the error-signal matrix. In step 3456, the first-node-level weights are adjusted by adding the current W matrix and the weight-adjustments matrix ΔW. Then, in the for-loop of steps 3457-3461, the weights of the remaining node levels are similarly adjusted.

Thus, as shown in FIGS. 34A-F, neural-network training can be conducted as a series of simple matrix operations, including matrix multiplications, matrix transpose operations, matrix addition, and the Shur product. Interestingly, there are no matrix inversions or other complex matrix operations needed for neural-network training.

### Currently Disclosed Methods and Systems

FIG. 35 provides a high-level diagram for a management-system agent that represents one implementation of the currently disclosed methods and systems. The management-system agent is based on a type of actor-critic reinforcement learning referred to as proximal policy optimization (“PPO”). The management-system agent 3502 receives rewards 3504 and status indications 3506 from the environment and outputs actions 3508, as in the various types of reinforcement learning discussed in previous sections of this document. The management-system agent uses a policy neural network II 3510 and a value neural network V 3512. The policy neural network II learns a control policy and the value neural network V learns a value function that returns the expected discounted reward for an input state vector. The management agent also employs a trace buffer 3514 and an optimizer 3516. The trace buffer stores traces, described below, that include states, actions, action probabilities, state values, and other information that represent the sequence of actions emitted, and states and rewards encountered, by the management-system agent. The optimizer 3516 uses the traces stored in the trace buffer to compute losses that are then used to train the policy neural network II 3510 and the value neural network V 3512. As further discussed below, the currently disclosed management-system agent can operate in three different modes. In a controller mode, no learning occurs. In this mode, the management-system agent iteratively receives state vectors from the environment and, in response, issues actions to the controlled environment. In an update_only mode, collected traces are processed by an optimizer component to generate losses that are input to the policy neural network II and value neural network V for backpropagation within these neural networks. In a learning mode, the management-system agent issues actions and, concurrently, learns using the collected traces stored in the trace buffer. As further discussed below, these different modes of operation facilitate on-line control and off-line policy optimization and state-value-function optimization. Note that, in the described implementation, observations and beliefs are not used, but that, instead, the environment returns states and rewards to the management-system agent rather than observations and rewards. In alternative implementations, the environment returns observations and rewards, as discussed above with reference to FIGS. 15 and 16A-B.

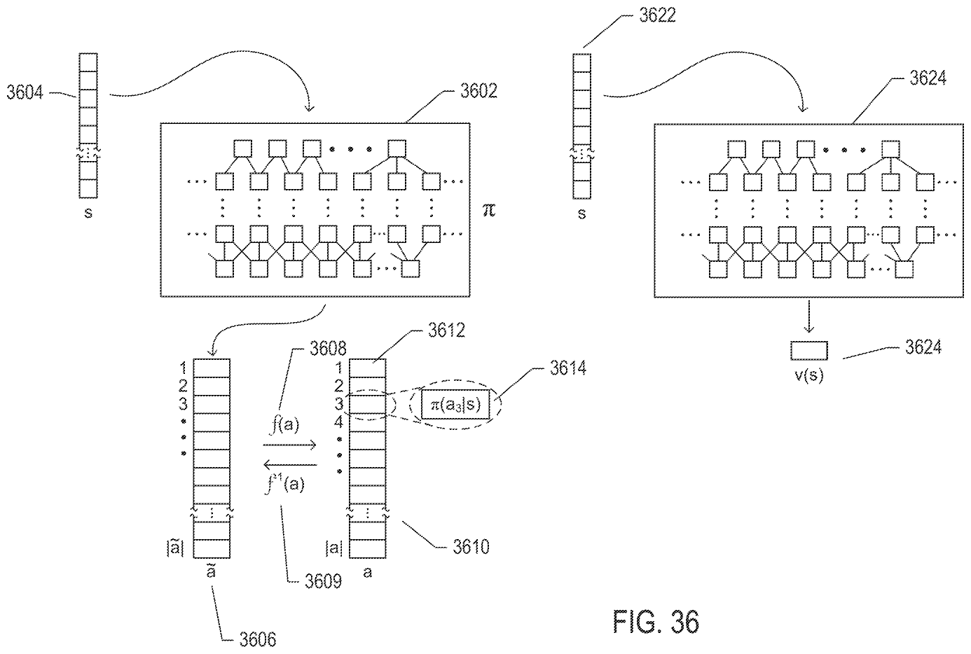

FIG. 36 illustrates the policy neural network II and value neural network V that are incorporated into the management-system agent discussed above with reference to FIG. 35. The policy neural network II 3602 receives input state vectors 3604 and outputs an unnormalized action-probability vector 3606. A function ƒ is applied to the unnormalized action-probability vector 3608 to generate an action-probability vector a 3610. In the normalized action-probability vector a, the elements contain probability values in the range [0, 1] that sum to 1.0. The function ƒ is associated with an inverse function ƒ⁻¹ 3609 that generates an unnormalized action-probability vector from a normalized action-probability vector. In many implementations, the normalization function is the Softmax function, given by expression:

$${a}_{i} = \frac{{e}^{{\tilde{a}}_{i}}}{{\sum }_{j = 1}^{\vert \tilde{a} \vert} {e}^{{\tilde{a}}_{j}}}$$

The action-probability vector a contains |a| elements, each element corresponding to a different possible action that can be issued to the controlled environment by the management-system agent. In the current discussion, the different possible actions are associated with unique integer identifiers. Thus, the first element 3612 of action-probability vector a contains the probability of the management-system agent issuing action a₁ when the current state is equal to the state represented by the input state vector 3604. As discussed in a previous subsection, actions themselves may be vectors. Inset 3614 shows that the third element of action-probability vector a contains the probability that the management-system agent will issue action a₃ given that the current state is the state S represented by the input vector 3604. This probability is expressed using the notation π(a₃|S). The value neural network V 3620 receives an input state vector S 3622 and returns the discounted value of the state, V(S) 3624.

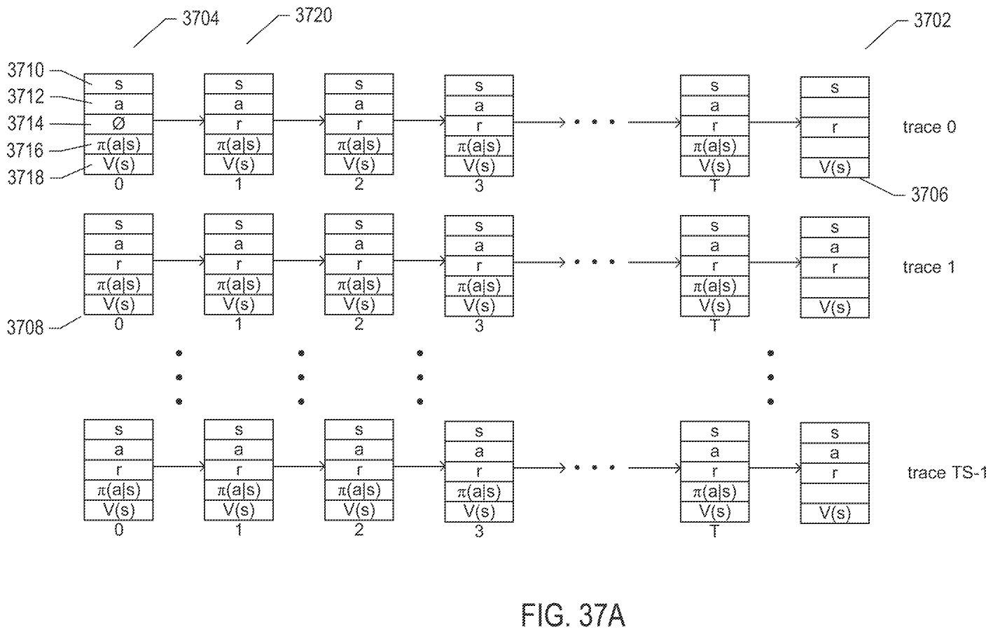

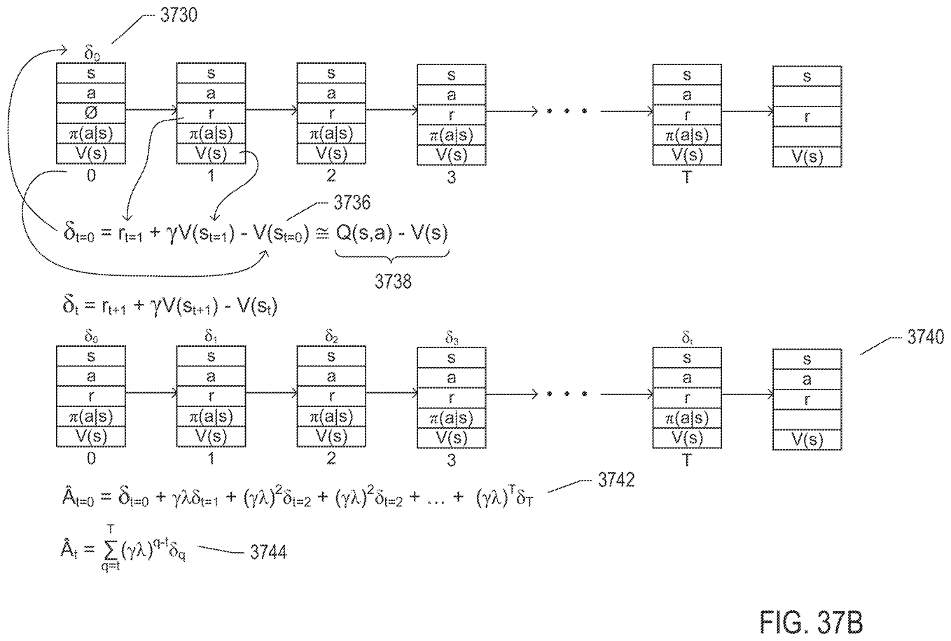

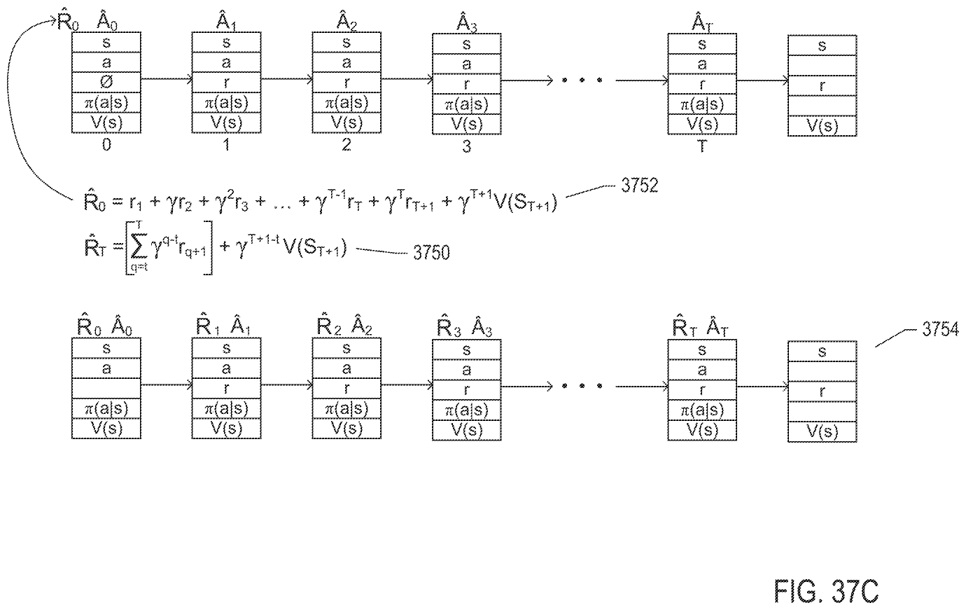

FIGS. 37A-C illustrate traces and the generation of estimated rewards and estimated advantages for the steps in each trace. FIG. 37A illustrates a set of traces containing TS traces indexed from 0 to TS−1. Each trace, such as trace 0 (3702 in FIG. 37A) includes T+1 steps, such as step 0 (3704 in FIG. 37A), along with a final incomplete step, such as step 3706 in trace 0, which contains a portion of the data contained in the first step 3708 of the next trace. Each step, such as step 3704, includes a state vector s 3710, an action a 3712, a reward r 3714, the probability that the action would be taken in state s 3716, and the discounted value of state s, V(S) 3718. The null value in the reward field of step 3704 indicates that the first reward in the first traces is generally not relevant to the computations based on traces, discussed below. Each step represents a different time point or iteration in the operation of the management-system agent. The steps within traces and the traces within a set of traces are ordered in time. The management-system agent is initially in state s and issued action a, as recorded in step 3704. In response, the environment returns the next state s and the reward r recorded in step 3720. As a result, the management-system agent emitted action a as recorded in step 3720. Step 3720 also records the probability π(a|S) that action a would be emitted when the current state is state s, recorded in step 3720, as well as the value of state s.

FIG. 37B illustrates computation of the estimated advantage Â for each step in a trace. First, an undiscounted estimate of the advantage for a particular state, δ, is estimated for each step in the trace. For example, the undiscounted estimate for the advantage of the first step 3730, δ₀, is equal to the sum of the reward in the next step 3732 and the value of the next state multiplied by discount factor γ 3734 from which the value of the current state 3736 is subtracted. The curved arrows pointing to these terms in the expression for the undiscounted estimate of the advantage illustrate the data used in the trace to compute the undiscounted estimate of the advantage. As indicated by expression 3738, the undiscounted advantage is an estimate of the difference between the expected reward for issuing action a, recorded in step 3730, when the current state is s, also recorded in step 3730, and the discounted value of state s. This computed value is referred to as an advantage because it indicates the advantage in emitting action a when in the current state s with respect to the estimated discounted value of state s. When the expected reward is greater than the estimated state value, the advantage is positive. When the expected reward is less than the estimated state value, the advantage is negative. Once the undiscounted estimates of the advantages been computed and associated with each step, as shown for trace 3740 in FIG. 37B, an estimated advantage Âₜ for each step t is computed by expression 3742 or the equivalent, more concise expression 3744. The parameter λ is a smoothing parameter, often with the value of 0.95, and γ is the discount parameter.

FIG. 37C illustrates computation of the estimated discounted reward \hat{R} for each step in a trace. The estimated discounted reward for step t, \hat{R}ₜ, is computed by expression 3750. For the first step, step 0, the estimated reward \hat{R}₀ computed by expression 3752, which shows the computation as a sum of terms rather than using a summation sign, as used in expression 3750. As shown for trace 3754, each step in a trace can be associated with both a discounted reward \hat{R}ₜ and an estimated advantage Âₜ. These estimates are computed entirely from data stored on in trace, as shown in FIGS. 37B-C.

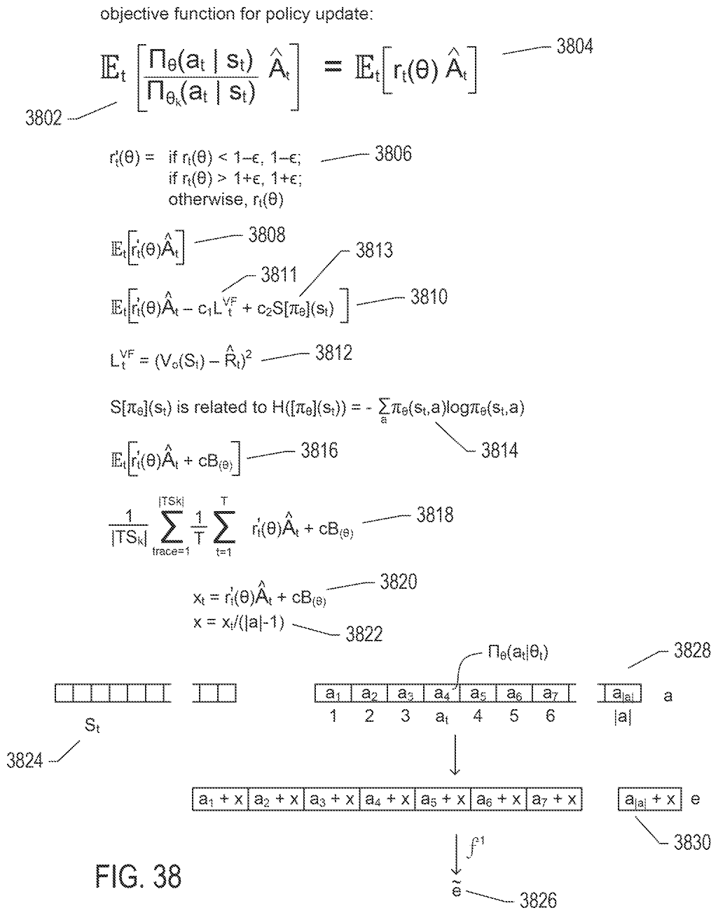

FIG. 38 illustrates how the optimizer component of the management-system agent (3416 in FIG. 34) generates a loss gradient for backpropagation into the policy neural network II. A general objective function that the optimizer attempts to maximize is given by expression 3802. This is the estimated value, over a trace, of the product contained within the brackets. A trace includes T steps, as discussed above, and the estimated value of the expression in brackets over the trace is approximated with the average value of the expression over all the steps in the trace. The expression in the brackets includes a first factor computed as the probability of issuing the action issued in a particular step t for the current state recorded in step t that would be returned by an updated policy neural network II divided by the probability of issuing the action issued in the particular step for the current state recorded in the step that was returned by the policy neural network II and a second factor that is the estimated advantage Âₜ for the step. In other words, by modifying the weights of the policy neural network to maximize this expression, the neural network is trained to increase the probabilities of actions associated with positive advantages and to decrease the probabilities of actions associated with negative advantages.

Expression 3804 is equivalent to expression 3802, with the probability ratio replaced by the notation rₜ(θ). In many implementations, a modified probability ratio r′ₜ(θ) is used, given by expression 3806. The modified probability ratio avoids wide swings in loss magnitudes that can result in slow convergence of the policy neural network to an optimal policy. Thus, the expression 3808 represents the objective function that the optimizer seeks to maximize when training the policy neural network. In many implementations, a slightly more complex objective function 3810 is used. This objective function includes an additional negative term 3811 corresponding to the squared error in the values generated by the value neural network 3812 and an additional positive entropy term 3813 that is related to the entropy of the action-probability vector output by the policy neural network, as indicated by expression 3814. This objective function is more concisely represented by expression 3816.

As mentioned above, the expectation over a trace is approximated by the average of the objects of function over the trace, indicated by expression 3818. The objective function is summed over all the traces in a set of traces and divided by the number of traces in the set, TS, with the objective function summed over all of the steps in each trace and divided by the number of steps in the trace T. The objective function following the right-hand summation symbol in expression 3818 is thus computed for each step of each trace of each trace set. As shown in expression 3820, the notation xₜ can be used to refer to the value of the objective function for a particular step t. The notation x is used, shown in expression 3822, to refer to the value of xₜ divided by one less than the length, or number of elements in, the action-probability vector a. For a particular step, the training data for the policy neural network consists of the state vector for the state of the system at the timepoint corresponding to step 3824 and the desired output from the policy neural network 3826. The desired output is obtained by modifying the action-probability vector a 3828 by subtracting xₜ from the contents of the element of the action-probability vector a and adding x to all of the other elements of the action-probability vector a to produce vector e 3830. Vector e is transformed to the desired output 3826 via the function ƒ⁻¹ discussed above with reference to FIG. 36. The desired output is set to the negative of the desired output, since neural networks are generally implemented for gradient descent rather than gradient ascent, and gradient ascent is desired for policy optimization based on the above-discussed objective function.

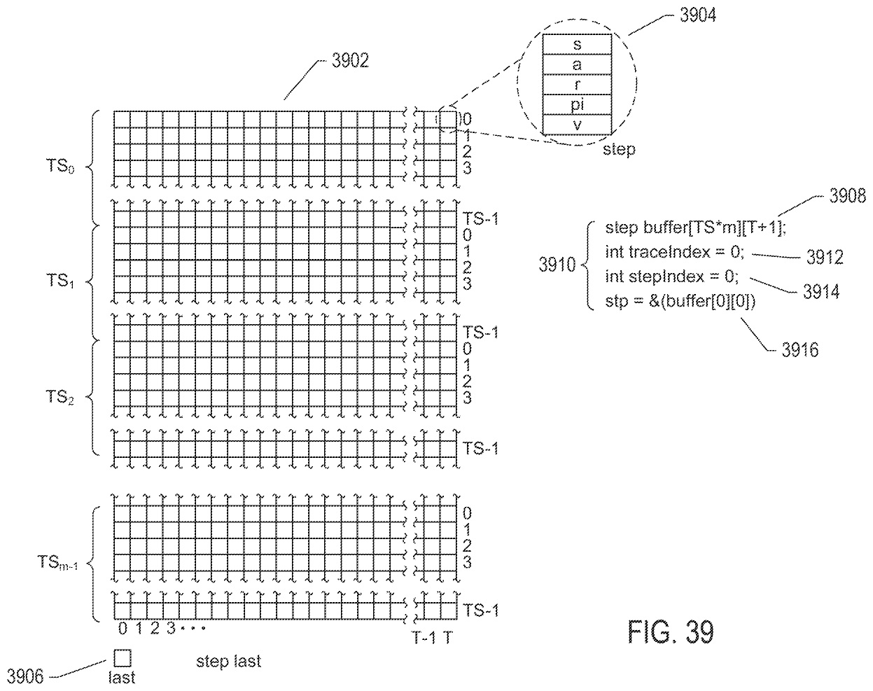

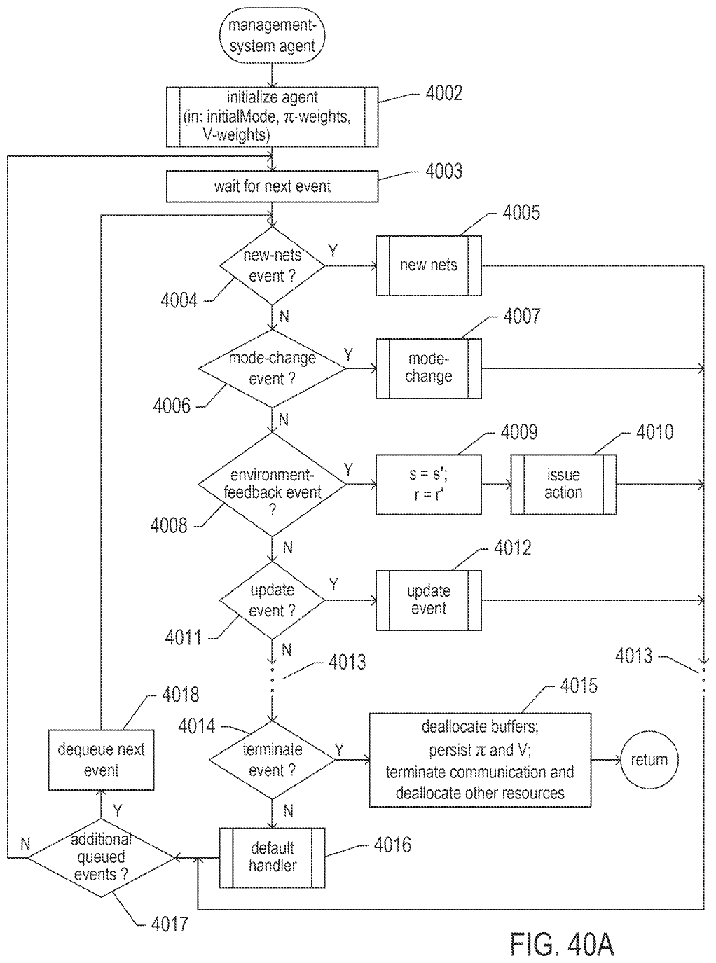

FIG. 39 illustrates a data structure that represents the trace-buffer component of the management-system agent. The data structure comprises a very large two-dimensional array buffer of step data structures 3902, with inset 3904 indicating the contents of a step data structure, described above with reference to FIG. 36A. Each row in the large two-dimensional array buffer represents a trace, with a single step data structure last 3906 representing a final step used for computing estimated rewards and advantages. The traces are logically arranged in m trace sets TS₀-TSₘ₋₁ that each contain TS traces. Each trace contains T+1 steps. A declaration for the two-dimensional array is shown 3908 in a block of declarations 3910 that additionally includes declarations for two indices, traceIndex 3912 and stepIndex 3914 along with a pointer stp, initialized to the first step of the first trace 3916. The trace-buffer data structure is used in subsequent control-flow diagrams as a logical representation of the trace-buffer component of the management-system agent. In actual implementations, the trace buffer may have other logical organizations and may, in fact, be one or more storage devices or appliances referenced by the management-system agent rather than an internal component of the management-system agent. Furthermore, the traces in the trace buffer may be exported to external entities, as discussed below.

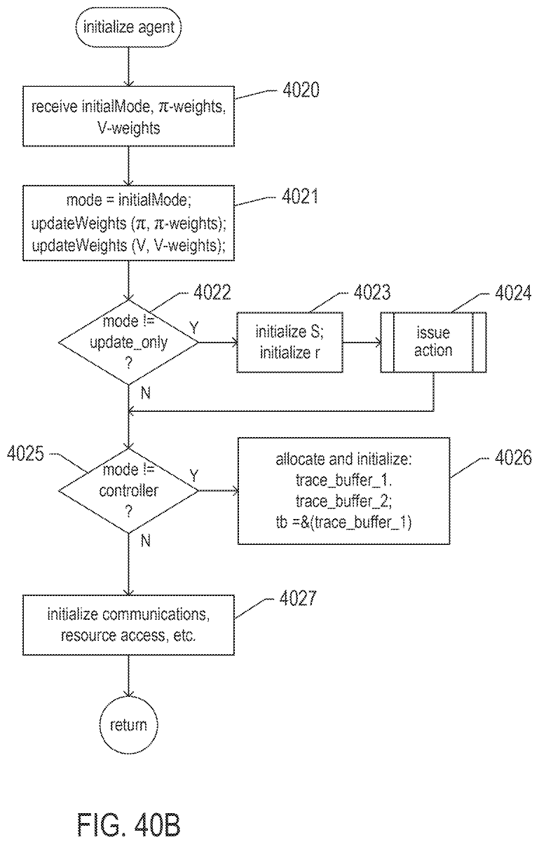

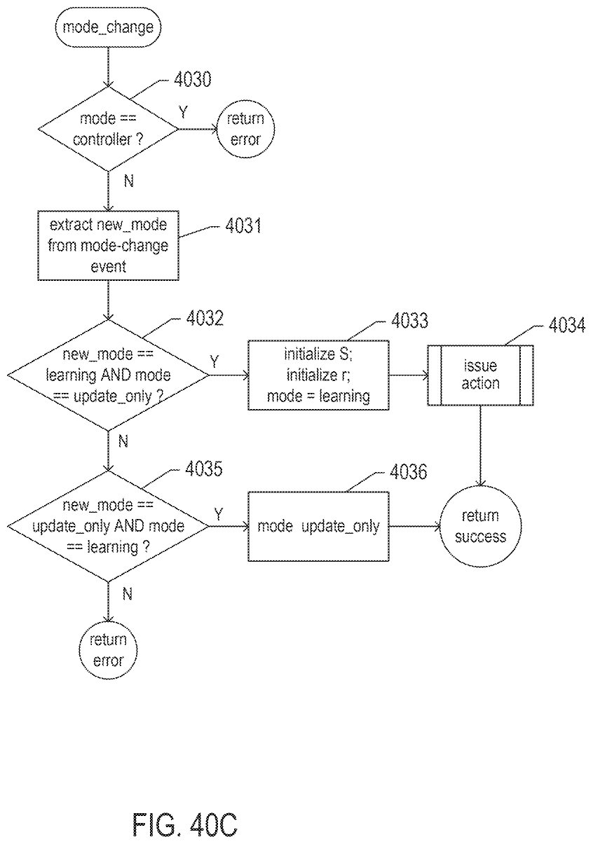

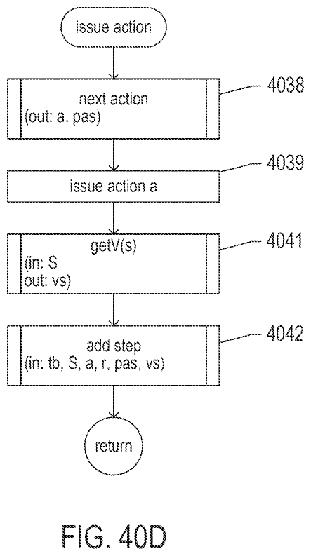

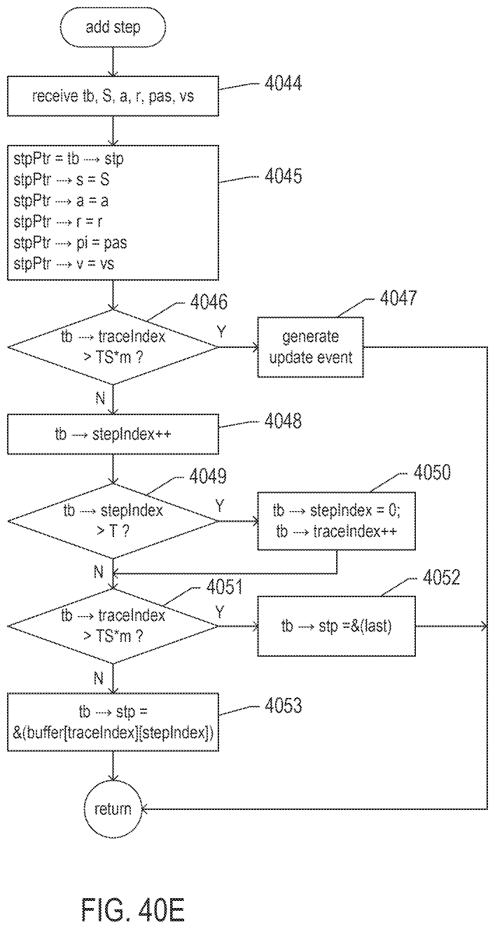

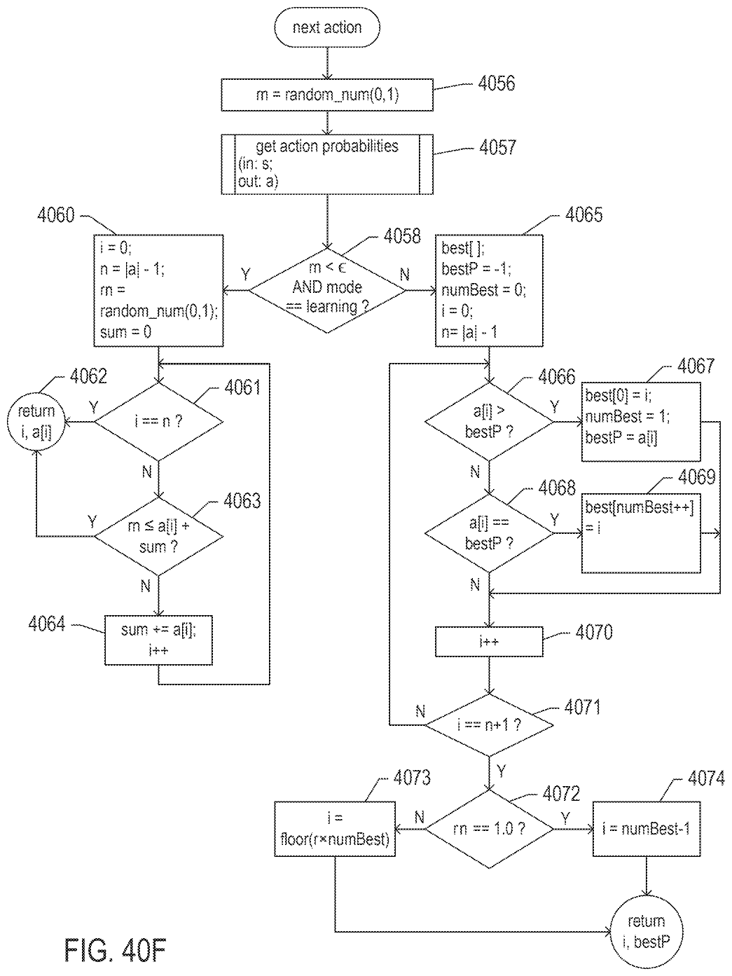

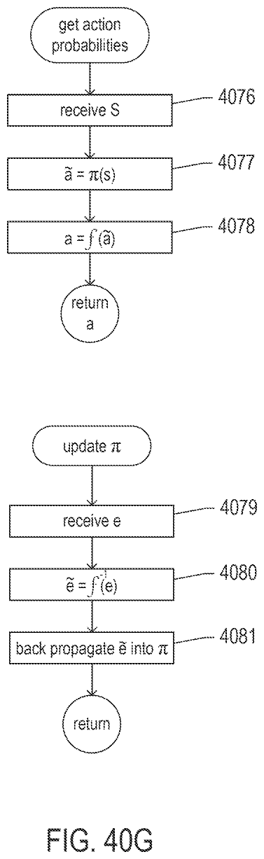

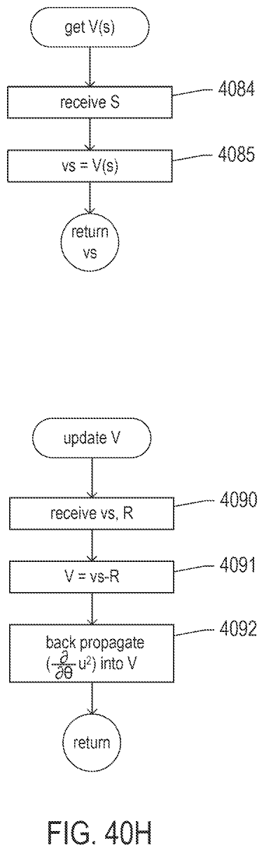

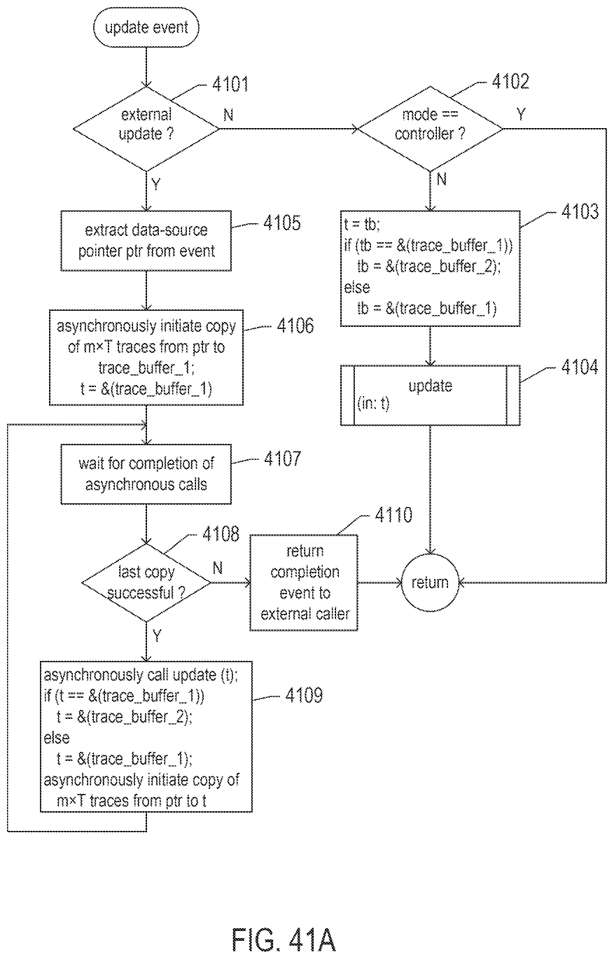

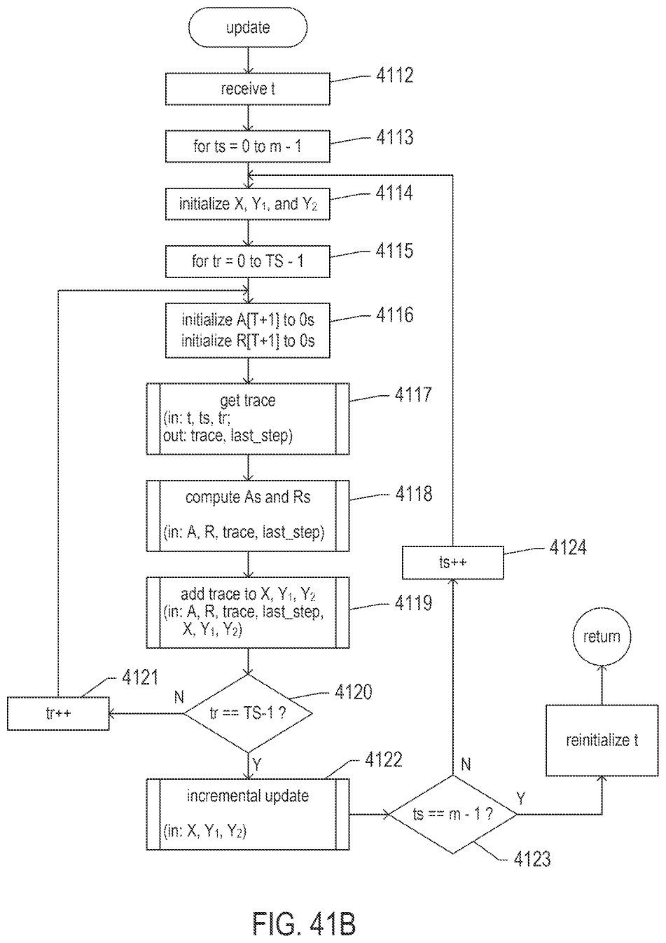

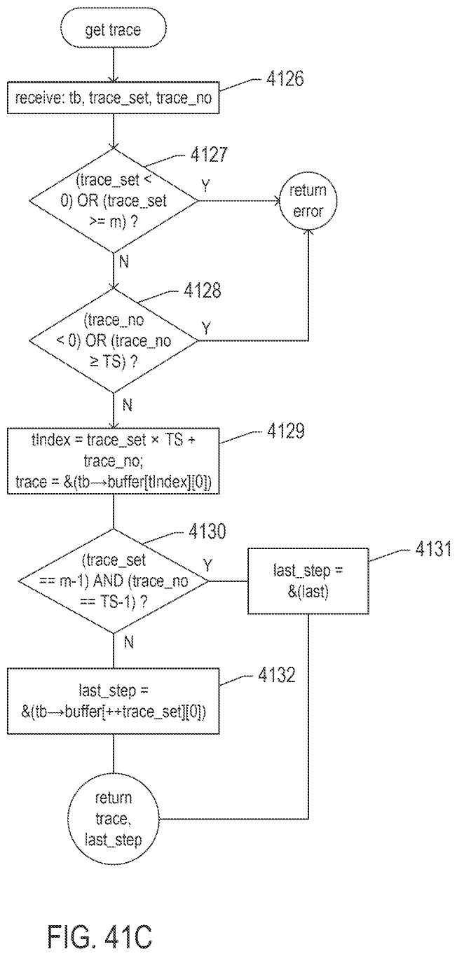

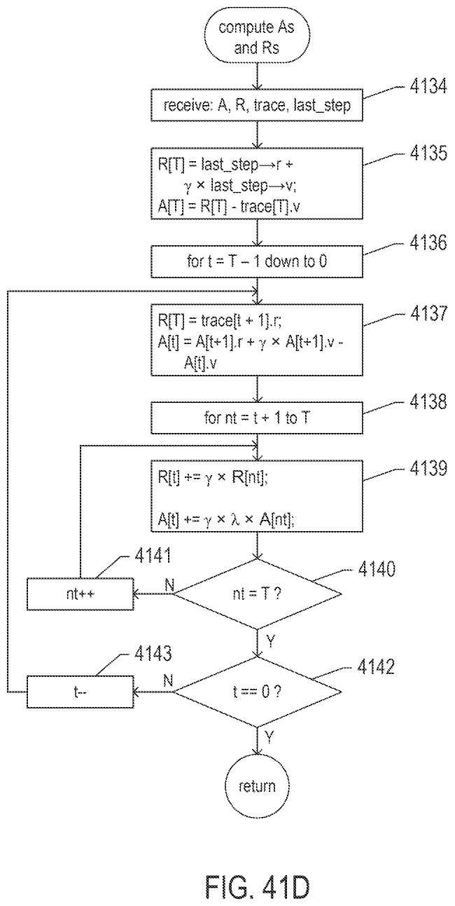

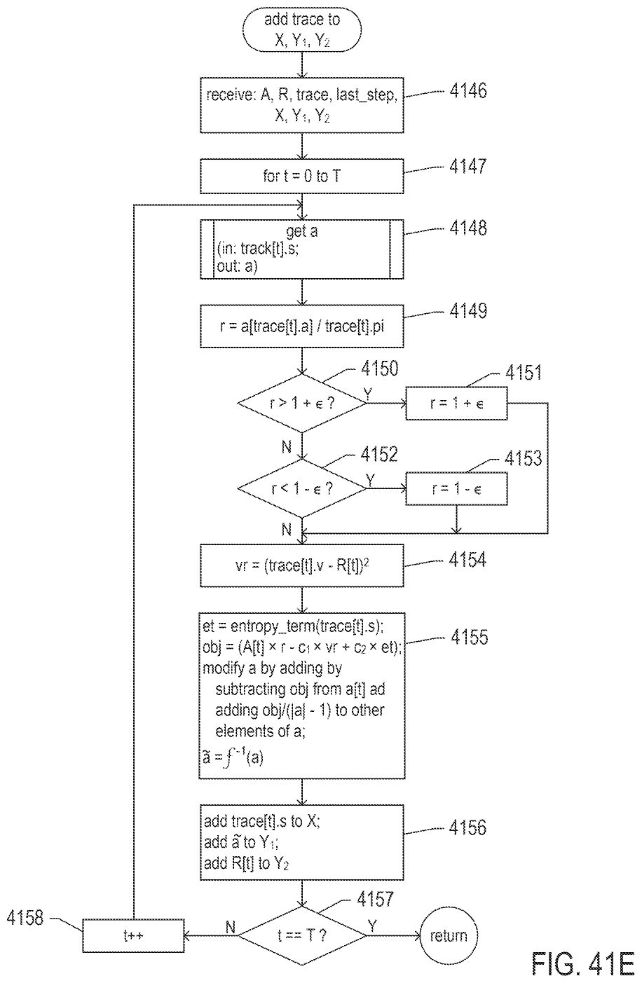

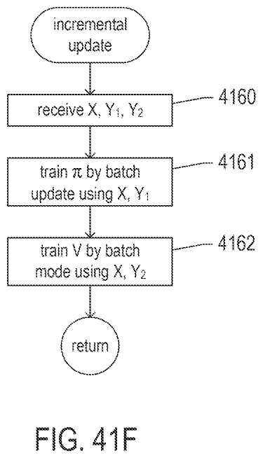

FIGS. 40A-H and FIGS. 41A-F provide control-flow diagrams for one implementation of the management-system agent discussed above with reference to FIGS. 35-39. FIG. 40A provides a highest-level control-flow diagram for the management-system agent. In step 4002, a routine “initialize agent” is called to initialize various data structures and variables as well as to carry out general initialization tasks. In step 4003, the routine “management-system agent” waits for a next event to occur. When the next occurring event is a new-nets event, as determined in step 4004, a routine “new nets” is called, in step 4005, to update the policy neural network and the value neural network with new weights provided from a twin management-system agent that is trained in an external training environment, as further discussed below. The new weights directly replace the current weights in the neural networks without invoking a backpropagation-based process. The routine “new nets” is not further described, below, since weight replacement is highly implementation-dependent and relatively straightforward. When the next occurring event is a mode-change event, as determined in step 4006, a routine “mode change” is called in step 4007. When the next occurring event is an environment-feedback event, as determined in step 4008, the current state vector and current reward are replaced by a new state vector and a new reward extracted from the event, in step 4009, followed by a call to the routine “issue action” in step 4010. It is assumed, in the control-flow diagrams, that environment-feedback events do not occur when the management-system agent is in update_only mode. When the next occurring event is an update event, as determined in step 4011, a routine “update event” is called in step 4012. Ellipses 4013 indicate that additional events may be handled in the event loop of the management-system-agent routine. When the next occurring event is a terminate event, as determined in step 4014, any allocated buffers are deallocated, weights for the policy and value neural networks are persisted, communications connections are terminated, and other such termination actions, including deallocating any other allocated resources, are carried out in step 4015 before the management-system-agent routine terminates. A default handler 4016 handles any rare or unexpected events when there are additional queued events to handle, as determined in step 4017, and control returns to step 4003 where the management-system-agent routine waits for a next event to occur. Otherwise, the next event is dequeued, in step 4018, and control returns to step 4004.

FIG. 40B provides a control-flow diagram for the routine “initialize agent,” called in step 4002 of FIG. 40A. In step 4020, the routine “initialize agent” receives an initial mode along with initial weights for the policy neural network and the value neural network. The global variable mode and the policy and value neural networks are initialized in step 4021. When the current mode is not equal to mode update_only, as determined in step 4022, the global variables S and r are set to initial values in step 4023 and a first action is issued by calling the routine “issue action,” in step 4024. When the current mode is not equal to controller, as determined in step 4025, two trace-buffer data structures, trace_buffer_1 and trace_buffer_2, are allocated and initialized in the global variable tb is initialized to reference trace_buffer_1 in step 4026. Finally, in step 4027, the routine “initialize agent” initializes communications connections, resource access, and carries out other initialization operations for the management-system agent.

FIG. 40C provides a control-flow diagram for the routine “mode_change,” called in step 4007 of FIG. 40A. If the current mode of the management-system agent is controller, as determined in step 4030, an error is returned. In the currently discussed implementation, the operational mode of a management-system agent in the mode controller cannot be changed. As discussed further below, a management-system agent in the mode controller is a management-system agent installed within a live target system to control the live target system, and does not undertake learning of more optimal policies or more accurate value functions. Instead, a twin management-system agent that executes in an external training environment uses traces collected by the live agent to learn more optimal policies and more accurate value functions, and the learned weights for the policy neural network and value neural network are exported from the twin management-system agent for direct incorporation into the live management-system agent via a new-nets event, discussed above. In step 4031, the new mode is extracted from the mode-change event. When the new mode is learning and the current mode is update_only, as determined in step 4032, the global variables S and r are initialized to an initial state vector and reward, respectively, and mode is set to learning, in step 4033, followed by issuance of an initial action via a call to the routine “issue action,” in step 4034. Otherwise, when the new mode is update_only and the current mode is learning, as determined in step 4035, the global variable mode is set to update_only, in step 4036. For any other new-mode/current-mode combination, an error is returned.

FIG. 40D provides a control-flow diagram for the routine “issue action,” called in step 4034 of FIG. 40C and in step 4010 of FIG. 40A. In step 4038, the routine “issue action” calls a routine “next action,” which returns a next action a for the management-system to be emitted to the environment and the probability that this action is emitted when the current state is S. In step 4039, the management-system agent issues the action a to the controlled environment. A routine “get V(S)” is called, in step 4041, to get an estimated discounted value for the current state S. Then, in step 4042, a routine “add step” is called to add a next step to the current trace buffer.

FIG. 40E provides a control-flow diagram for the routine “add step,” called in step 4042 of FIG. 40D. In step 4044, the routine “add step” receives a reference tb to the current trace buffer and values to include in a step data structure. In step 4045, the received values are added to the step data structure referenced by the stp pointer associated with the current trace buffer. When the traceIndex of the current trace buffer stores a value greater than TS*m, as determined in step 4046, an update event is generated, in step 4047, and the routine “add step” then returns. The update event is generated as a result of the current trace buffer having been completely filled. Otherwise, in step 4048, the stepIndex associated with the current trace buffer is incremented. When the stepIndex associated with the current trace buffer is greater than T, as determined in step 4049, the stepIndex is set to 0 and the traceIndex associated with the current trace buffer is incremented, in step 4050. When the traceIndex associated with the current trace buffer is greater than TS*m, as determined in step 4051, the stp pointer associated with the current trace buffer is set to point to the last step data structure, in step 4052, and the routine “add step” returns. Otherwise, the stp pointer associated with the current trace buffer is set to point to the next step data structure to be filled with data by a next call to the routine “add step,” in step 4053, after which the routine “add step” returns.

FIG. 40F provides a control-flow diagram for the routine “next action,” called in step 4038 of FIG. 40D. In step 4056, the routine “next action” sets local variable rn to a random number in the range [0, 1]. In step 4057, the routine “next action” calls a routine “get action probabilities” to obtain the vector of action probabilities a for the current state S from the policy neural network. When the operational mode of the management-system agent is learning and when rn stores a value less than a constant F, as determined in step 4058, the routine “next action” selects an exploratory action, with control flowing to step 4060. In step 4060, local variable i is set to 0, local variable n is set to one less than the number of elements in the action-probabilities vector, a new random number is selected and stored in local variable rn, and local variable sum is set to 0. When local variable i is equal to local variable n, as determined in step 4061, the routine “next action” returns the index of the next action, i, and the probability associated with the next action, a[i], in step 4062. Otherwise, when the value stored in local variable rn is less than or equal to the sum of a[i] and the contents of local variable sum, as determined in step 4063, the routine “next action” returns the action indexed by local variable i and the probability associated with that action in step 4062. Otherwise, in step 4064, local variable sum is incremented by the probability a[i] and local variable i is incremented. Thus, in the loop of steps 4061-4064, the routine “next action” uses the random number generated in step 4062 to randomly select one of the possible actions as the next action to be emitted by the management-system agent, and thus implements the exploratory aspect of a reinforcement agent that learns from trying new actions in specific situations.

When the operational mode of the management-system agent is not learning or when the value stored in local variable rn is greater than or equal to the constant ε, as determined in step 4058, control flows to step 4065 in order to select the next action with highest probability for emission in the current state. In step 4065, an array best is initialized, local variable bestP is initialized to −1, local variable numBest is initialized to 0, local variable i is initialized to 0, and local variable n is initialized to one less than the size of the action-probability vector a. When the probability a[i] is greater than the contents of local variable bestP, as determined in step 4066, the first element in the array best is set to i, local variable numBest is set to 1, and local variable bestP is set to the probability a[i], in step 4067. Otherwise, when the probability a[i] is equal to the contents of local variable bestP, as determined in step 4068, the probability a[i] is added to the next free element in the array best and local variable numBest is incremented, in step 4069. In step 4070, local variable i is incremented and, when i remains less than the sum of the contents of local variable n and 1, as determined in step 4071, control returns to step 4066 to carry out an additional iteration of the loop of steps 4066-4071. When the loop terminates, one or more actions with the greatest probability for emission in the current state S are stored in the array best. Then, in steps 4072-4074, the random number stored in local variable rn is used to select one of the actions with the greatest probability for emission when there are multiple actions with the greatest probability for emission or used to select a single action with the greatest probability for emission.

FIG. 40G provides control-flow diagrams for the routine “get action probabilities,” called in step 4057 of FIG. 40F, and for the routine “update H.” These are routines for using the policy neural network to obtain an action-probability vector and for backpropagating an ascent gradient into the policy neural network. In step 4076 of the routine “get action probabilities,” the routine receives a state vector S. In step 4077, the state vector is input to the policy neural network and an unnormalized action-probability vector ã is output by the policy neural network. In step 4078, the function ƒ, discussed above with reference to FIG. 35, is used to convert the unnormalized action-probability vector ã to action-probability vector a, which is returned by the routine “get action probabilities.” In step 4079 of the routine “update Π,” an ascent gradient e is received. In step 4080, the inverse function ƒ⁻¹, discussed above with reference to FIG. 35, is used to transform the ascent gradient e into an unnormalized ascent gradient \tilde{e} which is then back propagated into the policy neural network in step 4081.

FIG. 40H provides control-flow diagrams for the routine “get V(S),” called in step 4041 of FIG. 40D, and for the routine “update V.” These routines access the value neural network to obtain a state value and to backpropagate a loss gradient into the value neural network. In step 4084 of the routine “get V(S),” a state vector S is received and, in step 4085, the state vector is input to the value neural network, which produces a state value vs that is returned by the routine. In step 4090 of the routine “update V,” a state value vs and an estimated state value R are received. In step 4091, local variable u is set to the difference between vs and R. In step 4092, the gradient of the squared difference, u², is back propagated into the value neural network.

FIG. 41A provides a control-flow diagram for the routine “update event,” called in step 4112 of FIG. 41A. There are two different types of update events in the described implementation: (1) internal update events generated from within the management-system agent; and (2) external update events generated by entities external from the management-system agent. The first type of update event occurs when the management-system agent is in learning mode and the second type of update event occurs when the management-system agent is in update_only mode. In step 4101, the routine “update event” determines whether the update event is being handled as an external update event. If not, then, in step 4102, the routine “update event” determines whether the current operational mode is controller. If so, then the routine “update event” returns. In fact, when the mode is controller, the management-system agent needs to transfer the collected traces to a data store, as further discussed below, but these details are not shown in FIG. 41A, since they are highly implementation specific. Otherwise, when the mode is learning, the routine “update event” sets local variable t to reference the current trace buffer referenced by global variable tb, in step 4103, and sets the global variable tb to reference the other trace buffer. In step 4104, a routine “update” is called to carry out incremental learning, following which the routine “update event” returns. When the currently handled update event is an external update event, as determined in step 4102, a dated-source pointer is extracted from the current event in step 4105. In step 4106, the routine “update event” asynchronously initiates a copy of traces from the data source to the first trace buffer and sets local variable t to reference the first trace buffer. In step 4107, the routine “update event” waits for completion of all currently executing asynchronous calls. When the last copy successfully completes, as determined in step 4108, the routine “update event,” in step 4109, asynchronously calls the routine “update” to carry out incremental learning, then switches local variable t to point to the other of the two trace buffers, and asynchronously initiates another copy of traces in the data source to the trace buffer referenced by local variable t. When the last copy failed, as determined in step 4108, a completion event is returned to the external caller of the routine “update event,” in step 4110, and the routine “update event” then terminates.

FIG. 41B provides a control-flow diagram for the routine “update,” called in steps 4104 and 4109 and FIG. 41A. In step 4112, the routine “update” receives a pointer t to a trace buffer. In an outer for-loop comprising steps 4113-4124, the routine “update” processes m trace sets, with the loop variable ts indicating the current trace set processed by the for-loop of steps 4113-4124. In step 4114, the routine “update” initializes three matrices X, Y₁, and Y₂ that will store training data for the policy neural network and value neural network generated from stored traces. These matrices are used for batch training of the neural networks as discussed above with reference to FIGS. 34A-F. Then, the routine “update” executes the inner for-loop of steps 4115-4121 to process all of the traces in the current trace set ts. Following completion of the for-loop of steps 4115-4121, the routine “update” calls, in step 4122, a routine “incremental update” to use the training data in matrices X, Y₁, Y₂ to train the policy neural network and value neural network, respectively, using a batch training method, as discussed in FIGS. 34A-F. In the for-loop of steps 4115-4121, the routine “update” initializes an array of estimated advantages A and an array of estimated rewards R to all zeros. The routine “update” then calls a routine “get trace,” in step 4117, to access the next trace in the currently considered trace set ts. The routine “update” next calls a routine “compute As and Rs” to compute estimated advantages and rewards for all of the steps in the currently considered trace tr, as discussed with reference to FIGS. 37B-C, above. Finally, in step 4119, the routine “update” calls a routine “add trace to X, Y₁, Y₂” to add training data to matrices X, Y₁, Y₂.

FIG. 41C provides a control-flow diagram for the routine “get trace,” called in step 4117 of FIG. 41B. In step 4126, the routine “get trace” receives a pointer to a trace buffer tb, the index of a trace set trace_set, and the index of a trace trace_no. When the trace-set index is less than 0 or the trace-number index is greater than or equal to m, as determined in step 4127, an error is returned. Otherwise, when the trace-number index is less than 0 or the trace-number index is greater than or equal to TS, as determined in step 4128, an error is returned. Otherwise, the local variable tIndex is set to point to the trace indexed by the received trace-set index and trace-number index and the local variable trace is set to point to the first step in the trace indexed by local variable tIndex, in step 4129. When the trace-set index is equal to m−1 and the trace-number index is equal to TS−1, as determined in step 4130, the local variable last_step is set to reference the step last (3906 in FIG. 39), in step 4131. Otherwise, the local variable last step is set to reference the first step in the trace following the trace referenced by local variable trace, in step 4132. The routine “get trace” returns local variables trace and last_step.

FIG. 41D provides a control-flow diagram for the routine “compute As and Rs,” called in step 4118 of FIG. 41B. In step 4134, the routine “compute As and Rs” receives an array A storing computed advantages, an array R for storing computed, estimated returns, the index of a trace, trace, and the final incomplete step used for computing advantages and estimated returns last_step, discussed above with reference to FIG. 39. In step 4135, the routine “compute As and Rs” computes and stores estimates for the return and advantage for the last step in the trace referenced by received trace reference trace. In the outer for-loop of steps 4136-4143, the routine “compute As and Rs” traverses backwards through the arrays A and R to compute the estimated returns and advantages for all of the steps in the currently considered trace, from the final step back to the first step of the trace. In step 4137, the routine “compute As and Rs” initializes the estimated return and estimated advantage for the currently considered step t of the currently considered trace to the non-discounted portions of the estimated return and estimated advantage, which depend only on values in the currently considered step and next step. Then, in the inner for-loop of steps 4138-4141, the routine “compute As and Rs” traverses forward back down the trace to compute the full discounted estimated return and estimated advantage. Again, details are provided in the discussion of FIGS. 36A-C.

FIG. 41E provides a control-flow diagram for the routine “add trace to X, Y₁, Y₂,” called in step 4119 of FIG. 41B. In step 4146, the routine “add trace to X, Y₁, Y₂” receives the arrays A, R, the pointers trace and last step, the matrices X and Y₁, and the array Y₂. It should be noted that, in the control-flow diagrams used in the current document, arguments may be passed either by reference or by value, depending on efficiency considerations. Arrays and other data structures are usually passed by reference while constants are passed by value. In the for-loop of steps 4147-4158, the objective-function value for each step t in the trace is computed, with the objective-function value used to modify the action-probability vector a, as discussed above with reference to expressions 3820, 3822, 3826, 3028, and 3830 in FIG. 38. During each iteration of the for-loop of steps 4148-4158, the ratio of the probability for the action of the current step in the trace is divided by the action probability contained in the step to generate an initial ratio r_{θ}, in step 4149, and the final modified, or clipped, ratio r′_{θ}, discussed above with reference to FIG. 38, is computed in steps 4150-4153. In step 4154, local variable vr is set to the squared value-function error, as also discussed above with reference to FIG. 38. Then, in step 4155, the objective-function value for the current step is computed and used to generate the desired policy-neural-network output for the training data. Finally, in step 4156, the state vector for the trace is added to matrix X, the desired output of the policy neural network is added to matrix Y₁, and the estimated value for the state corresponding to the state vector for the trace is added to array Y₂.

FIG. 41F provides a control-flow diagram for the routine “incremental update,” called in step 4122 of FIG. 41B. In step 4160, the routine “incremental update” receives the matrices X and Y₁, and the array Y₂. In step 4161, the routine “incremental update” carries out batch training of the policy neural network, as discussed above in FIGS. 34A-F, using the matrices X and Y₁. In step 4162, the routine “incremental update” carries out batch training of the value neural-network using the matrix X and the array Y₂. Note that batch-mode neural-network training can use various different loss functions in addition to squared-error losses.

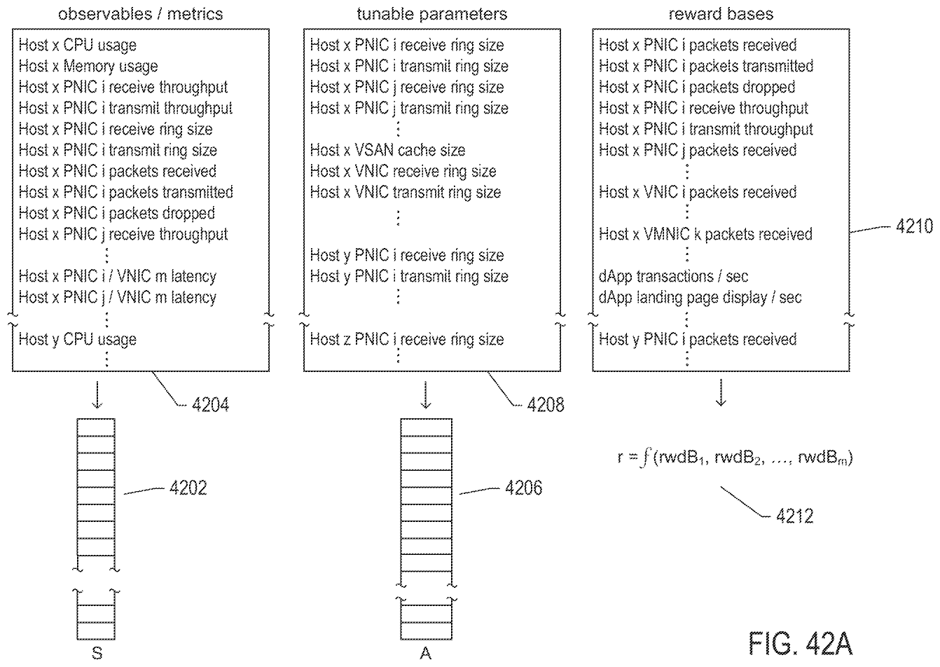

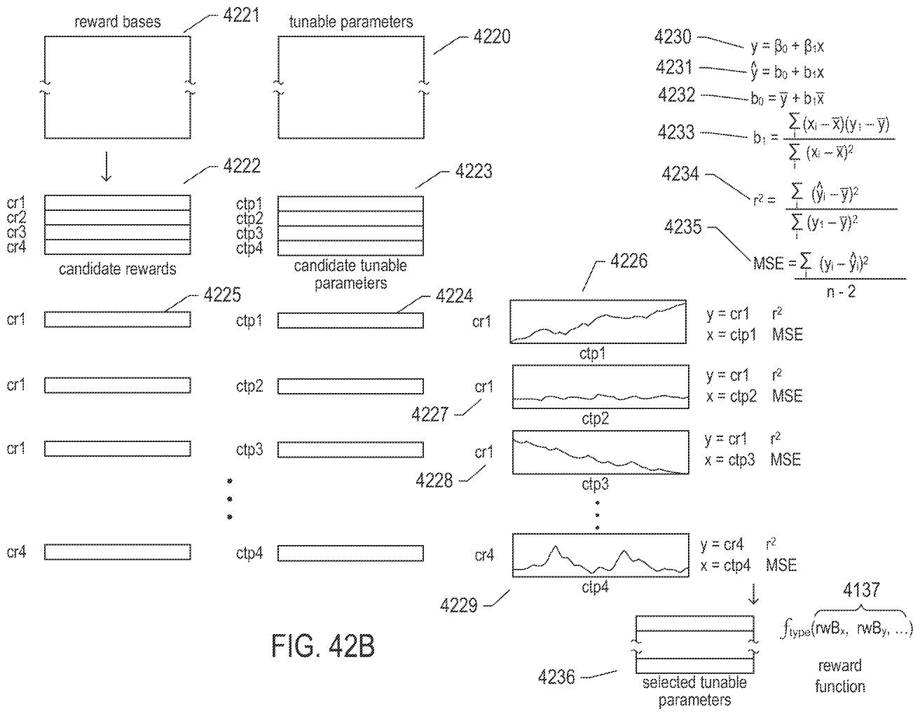

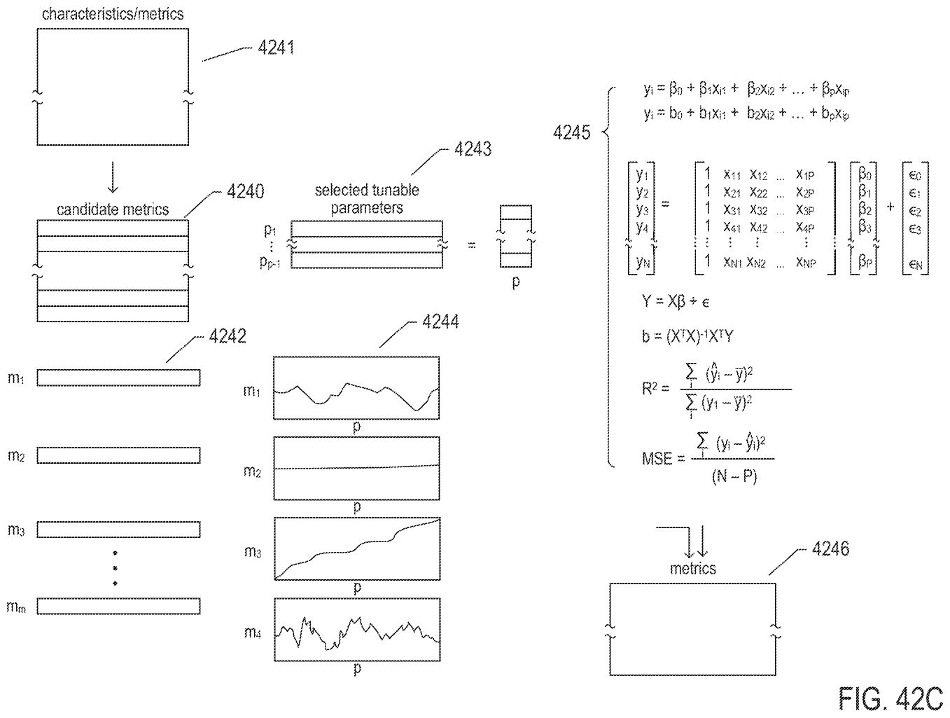

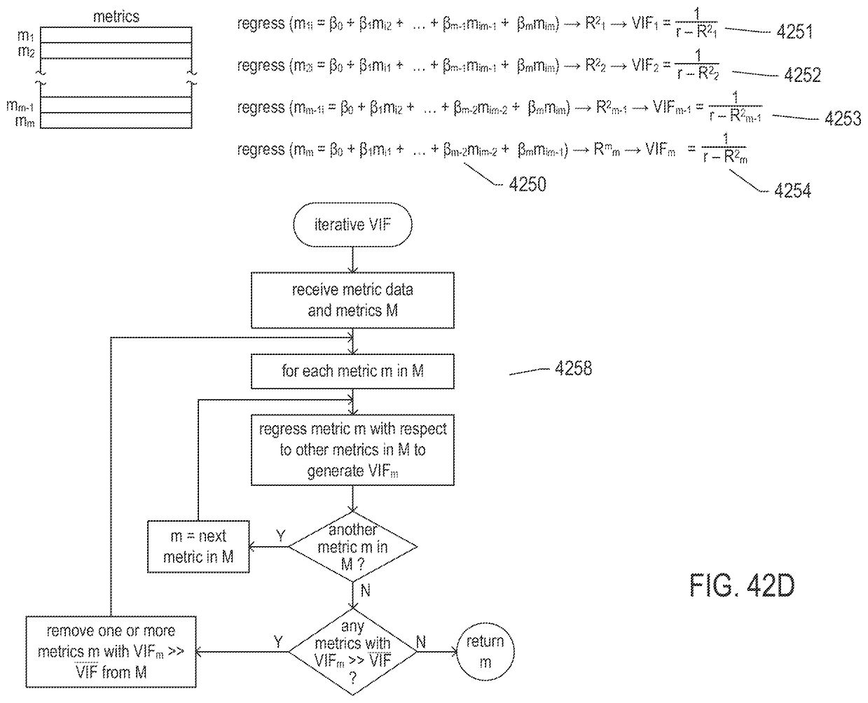

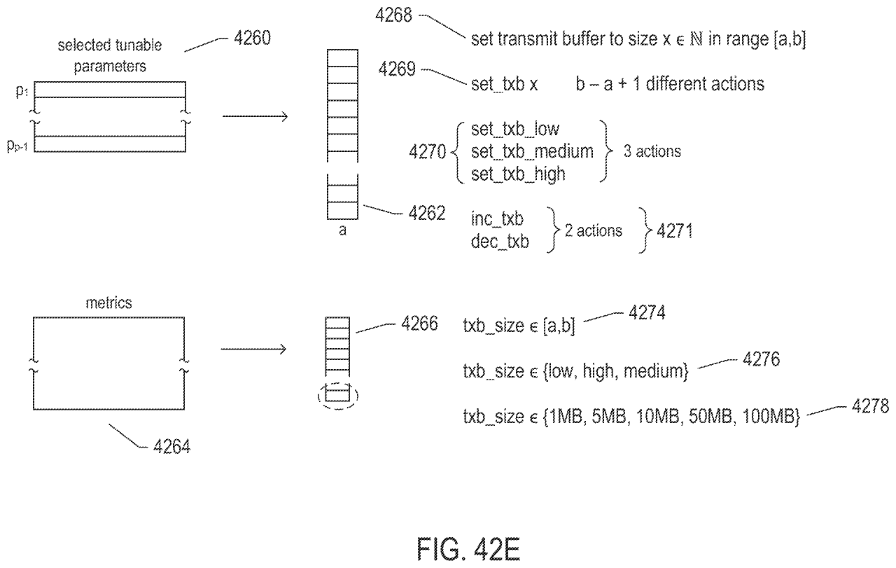

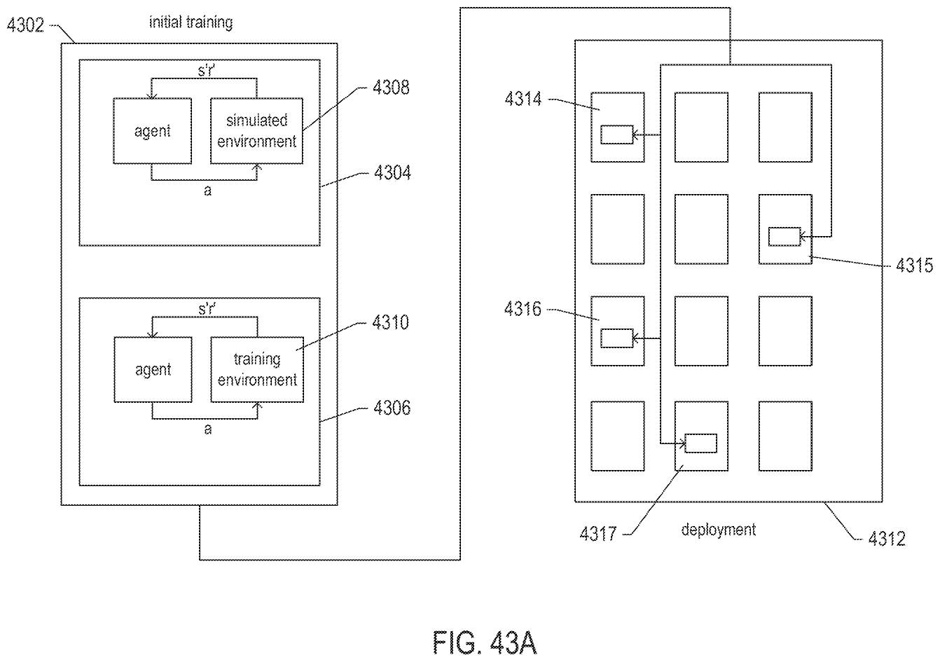

FIGS. 42A-E illustrate configuration of a management-system agent. The current discussion uses an example of a management-system agent that controls and manages virtual networks and VSANs, discussed in overview, above, with reference to FIGS. 23-29, for a distributed application. However, management-system agents can be considered to manage any of many different aspects of the execution environments in which a distributed application runs as well as operational parameters and characteristics of the distributed-application instances. In certain cases, management-system agents are used within a distributed-computer-system management system to control a wide variety of different characteristics and operational parameters of the distributed computer system. Different types of management systems may use multiple different sets of management-system agents operating in a variety of different local environments within a distributed computer system.

FIG. 42A illustrates the overall configuration process. A set of metrics is selected as the elements of a state vector 4202 from a set of potential metrics 4204 related to the system, system components, or other entities that are to be controlled by the management-system agent. Different metric values result in different state vectors, with the set of possible state vectors representing the different possible states of the controlled environment. A set of tunable parameters is selected for use in generating a set of actions 4206 from a set of potential tunable parameters 4208 related to the system, system components, or other entities that are to be controlled by the management-system agent. Finally, a set of reward bases is selected from a set of potential reward bases 4210 in order to generate a reward function 4212 for the management-system agent. As discussed above in a descriptive overview of reinforcement learning that refers to FIGS. 12-22 and in a description of an implementation of a management-system agent that employs proximal policy optimization that refers to FIGS. 35-41E, state vectors, an action set, and a reward function are fundamental components of the management-system agent, along with a policy neural network and a value neural-network. The sets of potential metrics, tunable parameters, and reward bases may substantially overlap one another. Example potential metrics shown in FIG. 42A include host CPU usage, host memory usage, physical network interface controller (“PNIC”) receive throughput, transmit throughput, received ring size, transmit ring size, packets received per unit time interval, packets transmitted per unit time interval, and packets dropped per unit time interval for one or more hosts, or servers, and one or more PNICs within the hosts. There are, of course, many additional types of metrics that can be used to determine the states of virtual-networking infrastructure and VSANs, including operational characteristics and configurations of virtual-network and VSAN components. Examples of tunable parameters that shown in FIG. 42A include the sizes of receive rings and transmit ratings for PNICs, cache sizes used by VSAN hosts, and VNIC receive-ring and transmit-rank sizes, but, as with the potential metrics, there are many additional examples of tunable parameters that may be used by a management-system agent for controlling virtual-network and VSAN infrastructure. Similar comments apply to the potential reward bases.

FIG. 42B illustrates an example of the process of selecting candidate rewards and candidate tunable parameters from which a final set of tunable parameters is selected for generating a set of actions and a final set of reward-function bases are selected for generating a reward function. Representations of the set of potential tunable parameters 4220 and the set of potential reward bases 4221, discussed above with reference to FIG. 42A, are shown at the top of FIG. 42B.

In a first step, a set of candidate root word bases 4222 and a set of candidate tunable parameters 4223 are selected from the potential reward bases 4221 and potential tunable parameters 4220, respectively. Various different criteria may be used for these selections. For example, both candidate reward bases and candidate tunable parameters should be available to the management-system agent and/or the environment of the management-system agent. Thus, while certain potential tunable parameters might indeed provide effective actions for the management-system agent, the management-system agent may not be able to control these parameters in the environment in which the management-system agent is intended to operate. For example, the virtualization layer of a host computer for the management-system agent may not provide access to certain virtual-network and VSAN parameters. Furthermore, the initial selection of candidate reward bases and candidate tunable parameters is often guided by a desire to have a set of reasonably orthogonal reward bases and tunable parameters that reflect, and that can be manipulated to control, the goals for management-system-agent operation.

In a second step, a test system is used to monitor the response of the reward bases to variations in the tunable parameters for all possible reward-basis/tunable-parameter pairs selected from the candidate reward bases and candidate tunable parameters. For example, in a first monitoring exercise, the first candidate tunable parameter 4224 is varied during operation of the test system while the current value of the first reward basis 4225 is monitored. This produces a data set represented by the two-dimensional plot 4226 of reward-bases value vs. the tunable-parameter setting. Similar data sets 4227-4229 are generated for the other possible reward-basis/tunable-parameter pairs. In one evaluation approach, a linear regression is used to attempt to fit the reward-basis response to the tunable-parameter setting. The linear regression models the reward-basis response as a linear function of the tunable-parameter setting 4230 and then computes estimated coefficients for the linear model, as shown in expressions 4231-4233. The linear regression produces several different statistics, including the r² statistic 4234, which indicates the fraction of observed variance between the observed responses and the responses computed using the derived linear function 4231 that is explained by linear relationship 4231, and the mean squared error (“MSE”) statistic 4235 that indicates the variance of the estimated responses with respect to the observed responses. In general, it is desirable that the candidate tunable parameters include at least one tunable parameter for which each candidate reward shows a linear response, such as the response shown in plots 4226 and 4228. Such plots are characterized by relatively large values of the r² statistic and relatively low values of the MSE statistic. When there is at least one tunable parameter for which each reward basis shows a linear response, then a reward function can be generated from the reward bases to steer effective operation of the management-system agent by emitting actions corresponding to the tunable parameters. It is also possible to evaluate the reward bases for non-linear responses when the non-linear responses are deterministic and useful for generating reward functions. Using these criteria, and additional criteria including removing redundant tunable parameters, the set of candidate reward bases 4222 and the set of candidate tunable parameters 4223 can be filtered in order to produce a final, selected set of tunable parameters 4236 and a final set of reward bases 4237 from which an effective reward function can be generated.

Similarly, as shown in FIG. 42C, a set of candidate metrics 4240 is selected from the potential metrics 4241, and then each candidate metric, such as the first candidate metric 4242, is evaluated with respect to the set of tunable parameters 4243 by using a test system to monitor the metric value as the parameters are varied to generate test data, as represented by plot 4244 for the first candidate metric 4242. In this case, multiple linear regression 4245 can be used to generate R² and MSE statistics in order to evaluate whether or not the candidate metrics show a linear response to the tunable parameters. Using this criterion, a final set of candidate metrics 4246 are selected. There are, of course, many evaluation approaches that can be used in addition to, or instead of, the above-discussed regression methods.

In a next step, variance-inflation-factor analysis can be used to remove redundant metrics from the selected set of metrics, as shown in FIG. 42D. In this process, test data is used to regress each metric against the other metrics, as indicated by the set of expressions 4250, in order to generate a VIF statistic for each metric 4251-4254. The larger the VIF statistic for a metric, the greater the correlation in response of the metric and one or more other metrics. An iterative process, represented by the small control-flow diagram 4258, iteratively computes VIF statistics for the currently remaining metrics and a set of metrics and then removes one or more of the metrics with relatively large VIF statistics.

In a final step, shown in FIG. 42E, the selected tunable parameters 4260 are used to generate a set of actions 4262 and the selected metrics 4264 are used to generate a state-vector-generation function that generates the state vectors 4266 returned by the environment to the management-system agent. In many cases, a tunable parameter is set, or adjusted, by using application-programming-interface (“API”) calls to one or more of a virtualization layer, guest operating system, and distributed-computer-system manager. These API calls may include integer or floating-point arguments. A single API call could then correspond to a very large number of different, discrete actions corresponding to the different values of the integer and floating-point arguments. In one approach to generating a set of actions from a set of selected tunable parameters, the arguments for API calls corresponding to the actions may be quantized or the actions may be defined to make relative changes to the parameter values. For example, there may be an API call that sets a transmit buffer to a particular size within a range of integers 4268. This could therefore result in a very large number of actions 4269—one for each possible argument value. Alternatively, the different possible sizes might be quantized into three different settings: low, medium, and high. This would, in turn, produce three different actions 4270. Alternatively, two actions might be generated 4271 that increase and decrease the transmit buffer size by a fixed increment and decrement, respectively. Similarly, where the transmit-buffer size is selected as a metric, possible values for the metric might include all of the different buffer sizes 4274, one of the three quantized settings low, medium, and high 4276, or a set of fixed numeric sizes 4278. As the number of possible state-vector-element values and the number of actions increase, the learning rate of a reinforcement-learning agent generally decreases, due to exponential expansion of the control-state space that the reinforcement-learning agent needs to search in order to devise optimal or near-optimal control strategies. Therefore, careful selection of actions and state-vector elements can significantly improve the performance of management systems which use reinforcement-learning-based management-system agents.

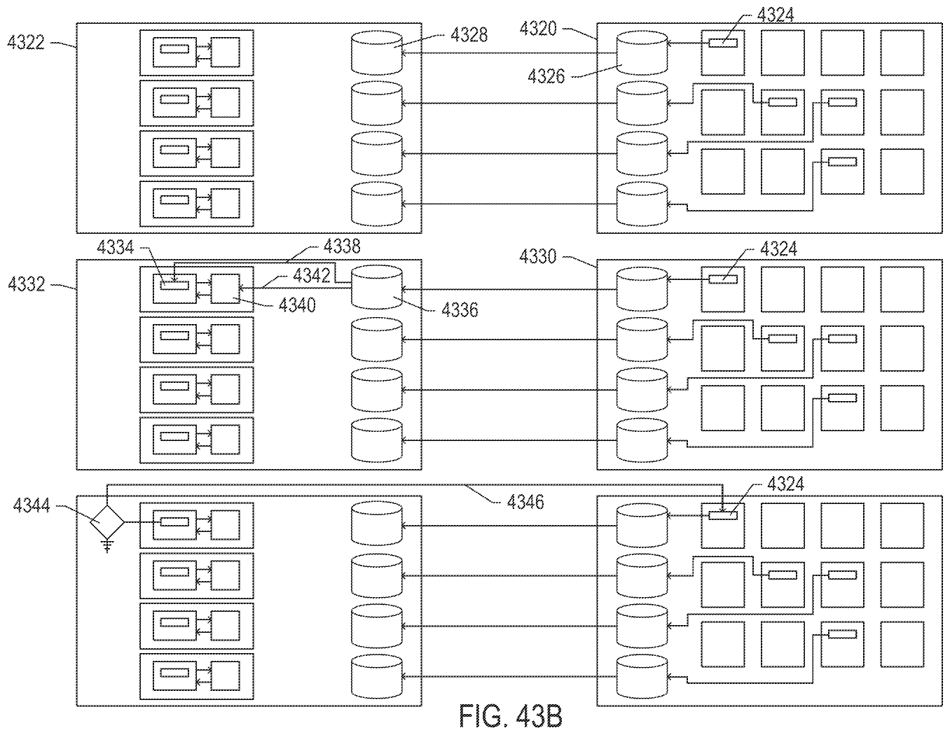

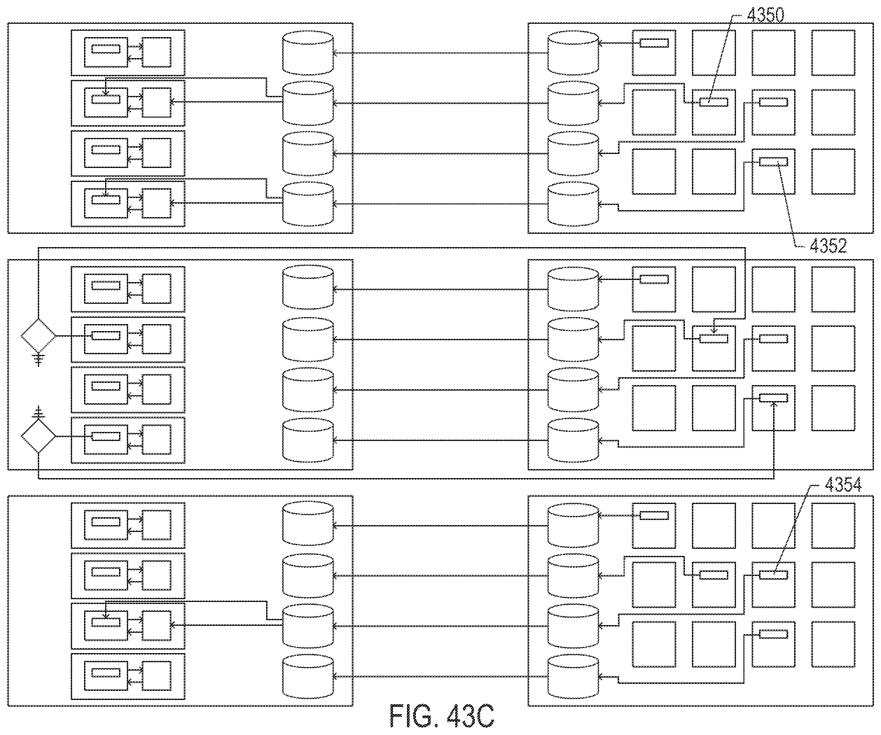

FIGS. 43A-C illustrate how a management-system agent learns optimal or near-optimal policies and optimal or near-optimal value functions, in certain implementations of the currently disclosed methods and systems. FIG. 43A illustrates initial training of a management-system agent. Management-system-agent training is carried out in a training environment 4302. In this training environment, the agent may operate to control a simulated environment 4304 and may also operate to control a special-purpose training environment 4306 that includes a distributed computer system. A simulated environment 4308 essentially implements a state-transition function, such as that illustrated in expression 1430 in FIG. 14B, that takes, as input, a state/action pair and returns, as output, a result state. The state-transition function can be implemented as a neural network and trained using operational data, such as traces, received from a variety of different operational systems. The training environment 4310 may be a distributed computer system configured to operate similar to a target distributed computer system into which the management-system agent is deployed following training. The initial training can involve multiple sessions of simulated-environment control and training-environment control in order that the agent learns an initial policy that is robust and effective. Once the management-system agent has learned an initial policy, and is validated to provide safe and robust, if not optimal, control, the management-system is deployed to a target system 4312. In the example shown in FIG. 43A, instances of a trained management agent are deployed into four hosts 4314-4317 of a target distributed computer system. Deployed management-system agents operate exclusively as controllers. They do not attempt to learn to optimize a policy and do not attempt to optimize a value function. Because of the complexities of a management-systems control tasks and the highly critical nature of control operations in a live distributed computer system, it is generally infeasible to allow a management-system agent explore the control-state space in order to optimize its policy and value function.

FIGS. 43B-C illustrate how management-system agents continue to be updated with improved policies and value functions as they operate within the target distributed-computer system. In FIGS. 43B-C, a sequence of representations of the deployed management-system agents, discussed above with reference to FIG. 43A, operating within the target distributed-computer system while twin training agents corresponding to the deployed management-system agents are continuously or iteratively trained in the training environment. The target distributed-computer system is represented by a large rectangle, such as rectangle 4320, on the right-hand sides of the figures and the training environment is represented by a large rectangle, such as large rectangle 4322, on the left-hand sides of the figures. Each deployed management-system agent, such as management-system agent 4324, generates traces that are locally stored within the target distributed-computer system 4326 and either continuously or iteratively transferred to storage in the training system 4328. In the current example, the traces stored in the training environment are used, at training intervals, to allow the twin training agents to learn more optimal policies and value functions. For example, in the next set of representations 4330 and 4332 in FIG. 43B, the training interval for the twin training agent 4334 corresponding to deployed management-system agent 4324 has commenced, with the locally stored traces 4036 generated during operation of the deployed management-system agent 4324 used for learning, by the twin training agent 4334, as indicated by arrow 4338, and also used to update a training simulator 4340, as indicated by arrow 4342. Following processing of the stored traces, the new policy and value function learned by the twin training agent is evaluated, as indicated by conditional-step representation 4344. When the new policy and value function meet the evaluation criteria, the policy-neural-network weights and value-neural-network weights are extracted from the twin training agent, exported to the deployed management-system agent 4324, as indicated by arrow 4346, and installed into the policy neural network and value neural-network of the deployed management-system agent. However, when the new policy and value function fail to meet the evaluation criteria, the deployed management-system agent continues to operate within the target distributed computer system with its current policy and value function. In this way, exploration of the control state space is carried out entirely by the twin training agents within the training environment, ensuring that exploration of the control-state space is carried out without risking damage to the target distributed computer system. In many cases, the training environment is maintained within a vendor facility on behalf of customers of the vendor who deploy management-system agents in their distributed computer systems. However, training environments may be provided by third-party service providers or may be incorporated into client distributed-computer systems. In all cases, the training environment is meant to allow twin training agents to safely explore the control-state space and to provide updated policies and value functions to operational management-system agents deployed in live distributed computer systems. FIG. 43C illustrates the occurrence of concurrent training periods for deployed management-system agents 4350 and 4352 followed by the occurrence of a training period for deployed management-system agent 4354.

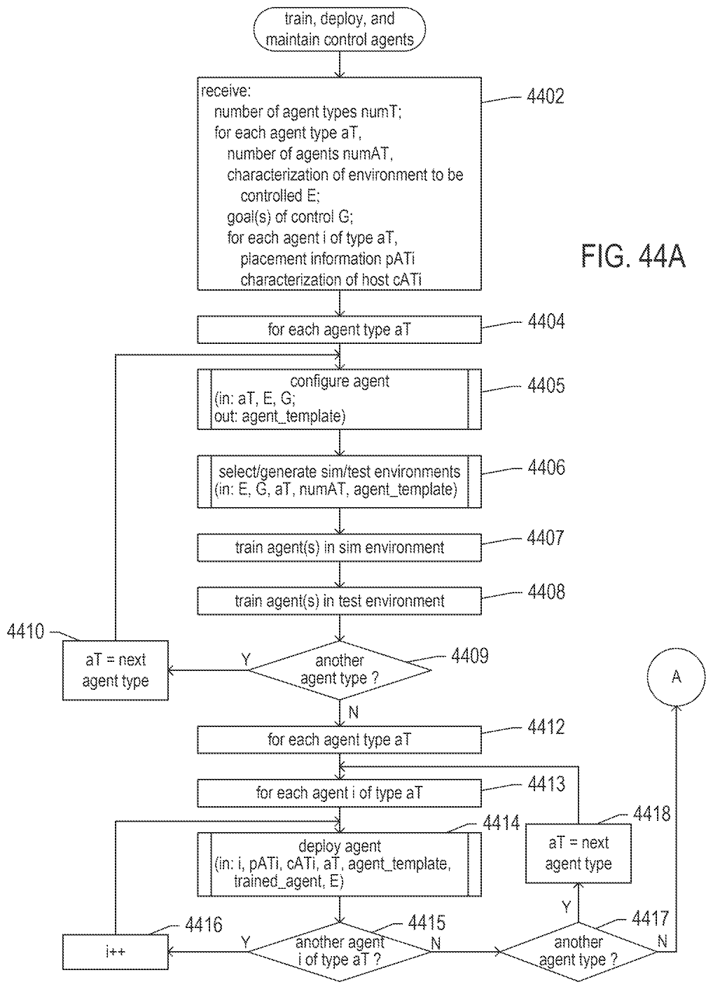

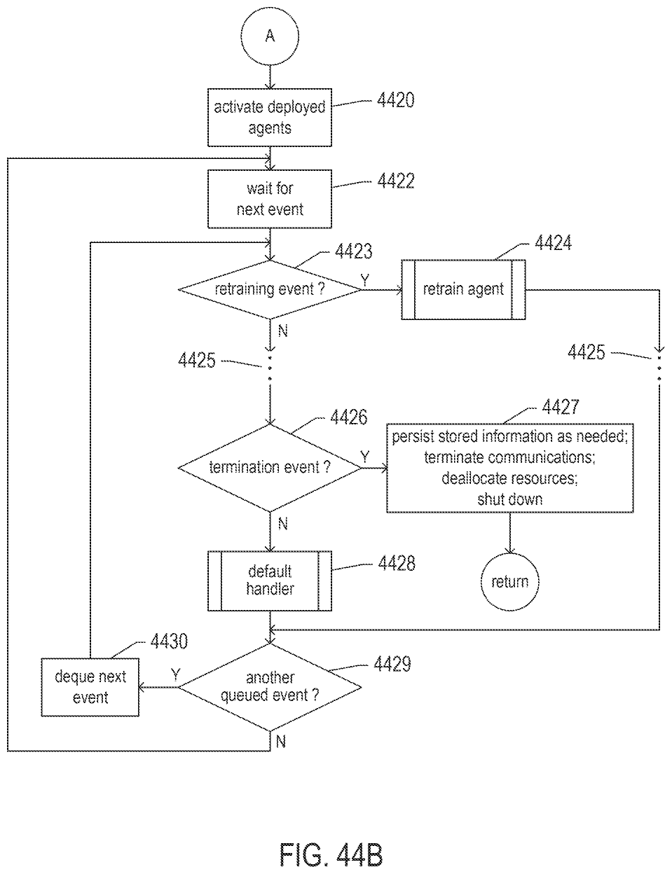

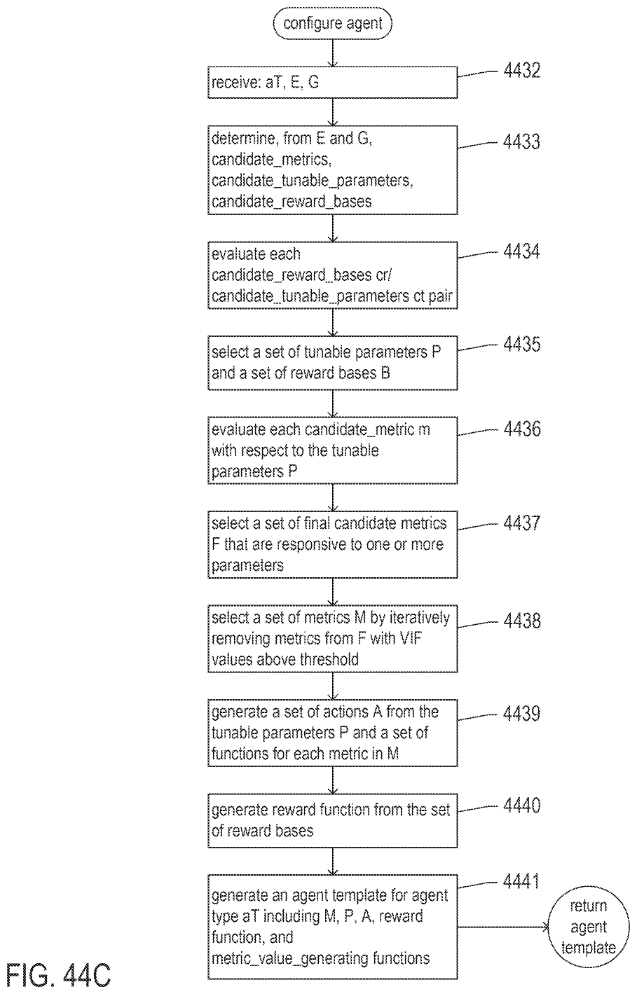

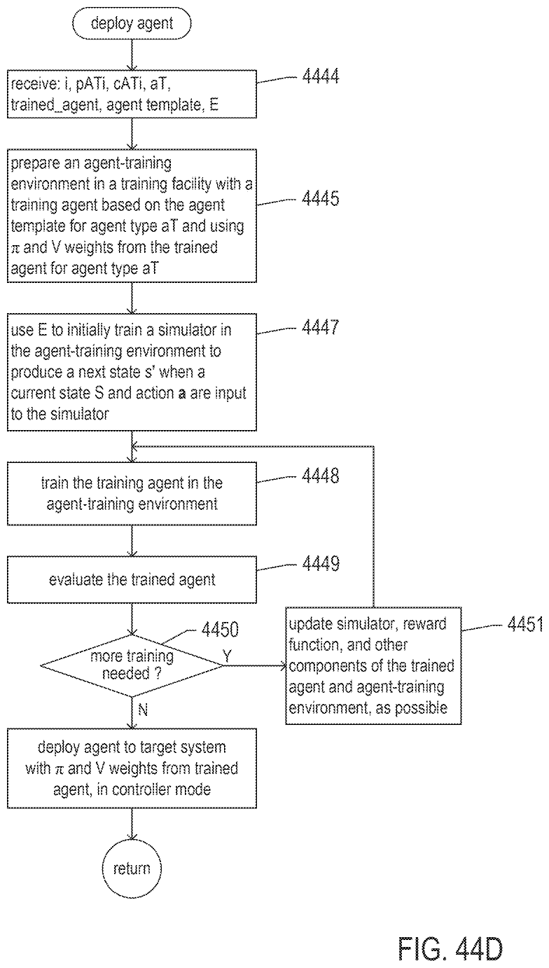

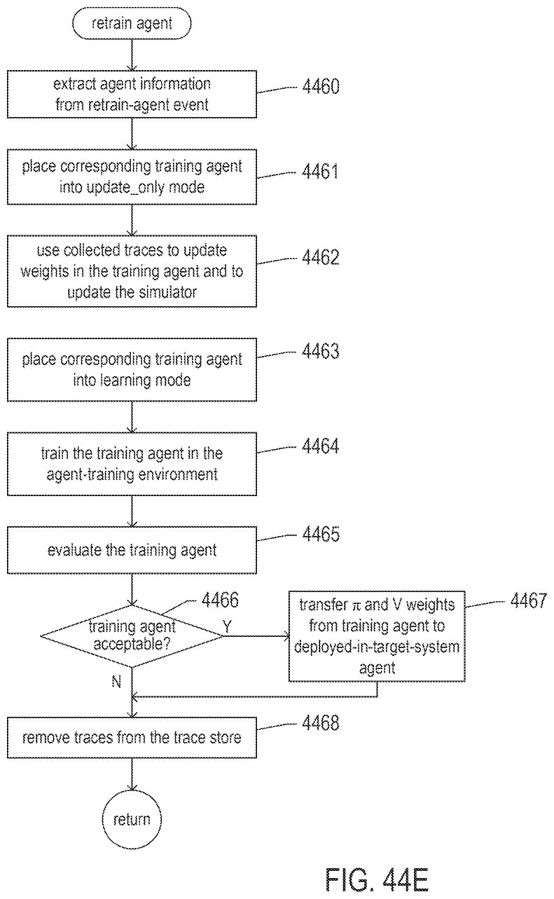

FIGS. 44A-E provide control-flow diagrams that illustrate one implementation of the management-system-agent configuration and training methods and systems discussed above with reference to FIGS. 43A-C for management-system agents discussed above with reference to FIGS. 35-41F. In step 4402 of FIG. 44A, the routine “train, deploy, and maintain control agents” receives numT, an indication of the number of agent types. For each different agent type aT, routine “train, deploy, and maintain control agents” receives: (1) numAT, an indication of the number of agents of type aT to configure and deploy; (2) data E that characterizes the environment to be controlled by the agents of type aT; and (3) data G that defines the goal or goals for control of the environment E by agents of type aT. For each different agent i of type aT, the routine “train, deploy, and maintain control agents” receives: (1) pATᵢ, placement information for the agent; and (2) cATᵢ, data that characterizes the host and/or execution environment for the agent. The formats and content of the data and information E, G, pATᵢ, and cATᵢ varies from implementation to implementation and from agent type to agent type.

In the for-loop of steps 4404-4410, each agent type aT is iteratively considered. In step 4405, a routine “configure agent” is called to generate an agent template for agents of the currently considered type. In step 4406, a routine “sim/test environments” is called to set up and configure the training environments for agents of type aT discussed above with reference to FIGS. 43A-C. In steps 4407-4408, a twin training agent is deployed in the generated simulation-and-test environments and initially trained, as discussed above with reference to FIG. 43A. The initial training of a twin training agent for the agent type provides initial weights for the policy neural network and value neural-network for agents of that type to facilitate later instantiation of twin training agents for deployed management-system agents of that type.

In the outer for-loop of steps 4412-4418, each agent type aT is again considered. In the inner for-loop of steps 4413-4416, each agent i of the currently considered agent type is deployed to a target, live distributed computer system via a call to a routine “deploy agent,” in step 4414. The nested for-loops of steps 4412-4418 thus carry out initially-trained management-system-agent deployment, as discussed above with reference to FIG. 43A. Continuing to FIG. 44B, the deployed management-system agents are activated, in step 4420. Then, the routine “train, display, and maintain control agents” enters an event loop of steps 4422-4430. The routine “train, display, and maintain control agents” waits, in step 4422, for the occurrence of a next event. When the next occurring event is a retraining event, as determined in step 4423, a routine “retain agent” is called, in step 4424, to carry out the retraining of the twin training agent for the agent discussed above with reference to FIGS. 43 B-C. Ellipses 4425 indicate that various additional types of events not shown in FIG. 44 B can be handled by the event loop of steps 4422-4430. When the next occurring event is a termination event, as determined in step 4426, various types of termination operations are performed, in step 4427, before the routine “train, display, and maintain control agents” terminates. A default event handler, called in step 4428, handles any rare and unexpected events. When there is another queued event to handle, as determined in step 4429, a next event is dequeued, in step 4430, and control then returns to step 4423 for processing the next event. Otherwise, control returns to step 4422, where the routine “train, display, and maintain control agents” waits for the occurrence of a next event.

FIG. 44C provides a control-flow diagram for the routine “configure agent,” called in step 4405 of FIG. 44A. In step 4432, the routine “configure agent” receives an indication of the agent type and the environment and goal data. In step 4433, the routine “configure agent” determines a set of candidate metrics, a set of candidate tunable parameters, and a set of candidate reward bases, as discussed above with reference to FIGS. 42A-C. In step 4434, the routine “configure agent” evaluates each candidate-reward-bases/candidate-tunable-parameter pair, as discussed above with reference to FIG. 42B, and selects a set of tunable parameters and a set of reward bases based on these evaluations in step 4435, as discussed above with reference to FIG. 42B. In step 4436, the routine “configure agent” evaluates each candidate metric with respect to the selected tunable parameters, as discussed above with reference to FIG. 42C, and then selects a set of final candidate metrics based on these evaluations, in step 4437. In step 4438, the routine “configure agent” selects a final set of metrics by iteratively removing metrics from the set of final candidate metrics based on computed VIF metrics, as discussed above with reference to FIG. 42D. In step 4439, the routine “configure agent” generates a set of actions A from the selected set of tunable parameters and a set of functions for generating the elements of a state vector from the selected set of metrics. In step 4440, the routine “configure agent” generates a reward function from the selected set of reward bases. Finally, in step 4441, the routine “configure agent” generates an agent template for the agent type aT including the selected sets of metrics, tunable parameters, and actions along with the reward function and metric-value-generating functions for generating state vectors.

FIG. 44D provides a control-flow diagram for the routine “deploy agent,” called in step 4414 of FIG. 44A. In step 4444, the routine “deploy agent” receives an indication of the agent, placement information and information about the execution environment for the agent, an indication of the type of the agent, a reference to an initially trained agent for that type, an agent template, and environment data for the environment to be controlled by the agent. Next, in step 4445, a training environment is configured for the twin training agent for the management-system agent, with the twin training agent initialized with weights for the policy neural network and value neural-network learned by the trained agent for the agent type and configured according to information in the agent template. In step 4447, a simulator for the twin training agent is trained. In the loop of steps 4448-4451, the twin training agent is trained in the agent-training environment prepared in steps 4445 and 4447, followed by evaluation of the trained agent in step 4449. When more training is needed, as determined in step 4450, the training environment and training agent are updated, in step 4451, before control returns to step 4448 for additional training. The simulator may be additionally trained, the reward function may be modified, and other components of the twin training agent and the agent-and training environment may also be modified in order to facilitate further training, in step 4451. Finally, when the twin training agent has been satisfactorily initially trained, a management-system agent is configured based on the twin training agent and deployed in a target system, using the placement information and execution-environment information received in step 4444.

FIG. 44E provides a control-flow diagram for the routine “retrain agent,” called in step 4424 of FIG. 44B. In step 4460, the routine “retrain agent” extracts information about the agent for which retraining is needed from the retrain-agent event. In step 4461, the routine “retrain agent” places the twin training agent for the management-system agent into update_only mode and then, in step 4462, uses the traces collected from the management-system agent to update the weights in the twin training agent and to update the state-transition neural-network on which the simulator is based using batch backpropagation. In step 4463, the routine “retrain agent” places the twin training agent into learning mode and then, in step 4464, continues to train the twin training agent in the agent-training environment using the updated simulator. Following training, the twin training agent is evaluated, in step 4465. When the current policy and value function of the twin training agent is found to be acceptable, in step 4466, the weights of the policy neural network and value neural-network are transferred from the twin training agent to the management-system agent in step 4467, as discussed above with reference to FIGS. 43B-C. In step 4468, the local trace store is updated to remove the traces employed for training the twin training agent and updated simulator. It is also possible, in one or both of steps 4462 and 4464, for the twin training agent to be further modified by modifying the reward function, the action set, and the definition of the state vector and the functions for transforming metric values to state-vector-element values, as well as modifying the tunable parameters, metrics, and reward bases. In the case that these modifications are made, the modified components are also transferred, along with the policy-neural-network and value-neural-network weights, to the management-system agent in step 4467. It is also possible that the twin-training agent may be completely reinitialized and retrained when the environment in which the management-system agent operates has been sufficiently altered to render iterative retraining and update of the twin training agent ineffectual.

Although the present invention has been described in terms of particular embodiments, it is not intended that the invention be limited to these embodiments. Modification within the spirit of the invention will be apparent to those skilled in the art. For example, any of a variety of different implementations of the currently disclosed methods and systems can be obtained by varying any of many different design and implementation parameters, including modular organization, programming language, underlying operating system, control structures, data structures, and other such design and implementation parameters. There are many different possible specific implementations of proximal-policy-optimization reinforcement-learning agents that may be used for the currently disclosed management-system agent. There are additionally many different possible specific implementations of the training environment and methods used to train twin training agents in order to optimize policies and value functions for deployed management-system agents.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A reinforcement-learning-based controller that controls an environment consisting of one or more of a distributed application, distributed-application instances, distributed-computer-system infrastructure, a distributed computer system, and distributed-computer-system components, the reinforcement-learning-based controller comprising:
a deployed system-management agent that executes within a distributed computer system, the deployed controller comprising
processor, memory, data-storage, and communications resources provided by the distributed computer system;
a set of actions;
a current state vector;
a current reward;
a policy neural network;
a value neural network;
one or more trace buffers; and
controller logic that iteratively
selects a next action using the policy neural network,
issues the selected action to the controlled environment,
stores a trace step in one of the one or more trace buffers,
receives a next state vector and a next reward, and
replaces the current state vector with the next state vector and the current reward with the next reward; and
a twin training agent that executes within a training environment and that receives and processes traces comprising trace steps stored by the deployed system-management agent.

2. The reinforcement-learning-based controller of claim 1 wherein each action of the set of actions is a command that is received and executed by one of a guest operating system, an operating system, a virtualization layer, a distributed application, a distributed-application instance, a distributed-computer management system, and a distributed-computer management-system agent.

3. The reinforcement-learning-based controller of claim 1 wherein the current state vector comprises multiple elements, each element storing a value corresponding to a metric value associated with the controlled environment or a value generated by a function that receives one or more metric values as arguments.

4. The reinforcement-learning-based controller of claim 1 wherein the policy neural network includes a layer of input nodes, one or more hidden layers of nodes, and a layer of output nodes and wherein the input nodes each receive a different element of a state vector and, in response to input of the state vector to the input layer of nodes, the output nodes output elements of an action probability vector that is normalized to a normalized action-probability vector that represents a distribution of action probabilities for the management-system agent in a current state represented by the input state vector.

5. The reinforcement-learning-based controller of claim 1 wherein the value neural network includes a layer of input nodes, one or more hidden layers of nodes, and an output node and wherein the input nodes each receive a different element of a state vector and, in response to input of the state vector to the input layer of nodes, the output node outputs a state value.

6. The reinforcement-learning-based controller of claim 1 wherein a trace step includes:
a state,
an action,
a reward,
a probability that the action was taken by the management-system agent when in the state; and
an estimated value of the state generated by the value neural network.

7. The reinforcement-learning-based controller of claim 6 wherein a trace includes a time-ordered set of steps.

8. The reinforcement-learning-based controller of claim 1 wherein the twin training agent comprises:
processor, memory, data-storage, and communications resources provided by the training environment;
a set of actions;
a current state vector;
a current reward;
a policy neural network;
a value neural network;
one or more trace buffers; and
controller logic that
when in a learning mode, iteratively
selects a next action using the policy neural network,
issues the selected action to the controlled environment,
stores a trace step in one of the one or more trace buffers and, when a threshold number of traces are available in one of the trace buffers, uses the number of traces to backpropagate loss gradients through the policy neural network and value neural network,
receives a next state vector and a next reward, and
replaces the current state vector with the next state vector and the current reward with the next reward, and
when in an update mode, iteratively
receives a threshold number of traces generated by the management-system agent, and
uses the number of traces to backpropagate loss gradients through the policy neural network and value neural network.

9. The reinforcement-learning-based controller of claim 1 wherein weights are periodically extracted from the policy neural network and value neural network of the twin training agent and substituted for the current weights in the policy neural network and value neural network of the management-system agent.

10. The reinforcement-learning-based controller of claim 1 wherein the management-system agent controls virtual-networking infrastructure and virtual-storage infrastructure within a distributed computer system in order to optimize performance of a distributed application.

11. The reinforcement-learning-based controller of claim 10 wherein the current state vector, the set of actions, and the current reward of the management-system agent are derived from one or more parameters of the virtual-networking infrastructure and the virtual-storage infrastructure including:
host CPU usage;
host memory usage;
PNIC and VNIC receive throughput, transmit throughput, receive ring size, transmit ring size, number of packets dropped, number of packets received, number of packets transmitted, and packet-transmission latency;
packet round-trip times and retransmission rates,
virtual-storage-infrastructure cache size; and
distributed-application parameters, including transactions per second and connections per second.

12. A method that configures a reinforcement-learning-based controller for controlling an environment consisting of one or more of a distributed application, distributed-application instances, distributed-computer-system infrastructure, a distributed computer system, and distributed-computer-system components, the method comprising:
selecting a set of potential metrics, a set of potential tunable parameters, and a set of reward bases from parameters of an environment to be controlled by the management-system agent;
evaluating and filtering the selected sets of potential metrics, potential tunable parameters, and reward bases to generate final sets of potential metrics, potential parameters, and reward bases;
generating a set of actions from the final set of tunable parameters;
generating a set of one or more functions to generate a state vector from the final set of metrics;
generating a reward function from the final set of reward bases;
configuring a twin training agent with the set of actions, one or more functions that generate a state vector, and reward function;
executing the twin training agent in a training environment using a simulator; and
executing the twin training agent in a training-environment distributed computer system.

13. The method of claim 12 wherein the potential metrics, the set of potential tunable parameters, and the set of reward bases are selected from possible metrics, tunable parameters, and reward bases associated with the environment to be controlled by the reinforcement-learning-based controller according to criteria that include:
accessibility, via API calls and distributed-computer-system interface;
relevance to control goals; and
orthogonality.

14. The method of claim 13 wherein evaluating and filtering the selected sets of potential tunable parameters and reward bases to generate final sets of parameters and reward bases further comprises:
comparing different pairs consisting of a potential tunable parameter and a potential reward basis to determine whether the reward basis exhibits a linear response with low variance to systematic varying of the tunable-parameter setting;
removing, from the set of reward bases, those reward bases which fail to exhibit a linear response with low variance to at least one tunable parameter; and
removing redundant tunable parameters from the set of tunable parameters.

15. The method of claim 13 wherein evaluating and filtering the selected set of potential metrics further comprises:
removing, from the set of metrics, those metrics which fail to exhibit a linear response with low variance to the set of tunable parameters; and
removing collinear metrics by iteratively generating variance-inflation-factor statistics for the set of metrics and removing metrics with comparatively large variance-inflation-factor statistics.

16. The method of claim 13 further comprising:
configuring a management-system agent with the set of actions, one or more functions that generate a state vector, reward function, and neural-network weights extracted from a policy neural network and a value neural network in the twin training agent.

17. The method of claim 16 further comprising:
deploying the management management-system agent to a target distributed computing system in a controller mode, in which the management-system agent does not learn, but stores traces;
periodically using the stored traces to update the policy neural network and value neural network in the twin training agent; and
exporting weights of the updated policy neural network and value neural network in the twin training agent to the management-system agent.

18. The method of claim 13 wherein the management-system agent controls virtual-networking infrastructure and virtual-storage infrastructure within a distributed computer system in order to optimize performance of a distributed application.

19. The method of claim 18 wherein the current state vector, the set of actions, and the current reward of the management-system agent are derived from one or more parameters of the virtual-networking infrastructure and the virtual-storage infrastructure including:
host CPU usage;
host memory usage;
PNIC and VNIC receive throughput, transmit throughput, receive ring size, transmit ring size, number of packets dropped, number of packets received, number of packets transmitted, and packet-transmission latency;
packet round-trip times and retransmission rates,
virtual-storage-infrastructure cache size; and
distributed-application parameters, including transactions per second and connections per second.

20. A physical data-storage device encoded with computer instructions that, when executed by one or more processors of a computer system, control the computer system to:
configure a reinforcement-learning-based controller for controlling a computational environment by
selecting a set of potential metrics, a set of potential tunable parameters, and a set of reward bases from parameters of an environment to be controlled by the management-system agent,
evaluating and filtering the selected sets of potential metrics, potential tunable parameters, and reward bases to generate final sets of potential metrics, potential parameters, and reward bases,
generating a set of actions from the final set of tunable parameters,
generating a set of one or more functions to generate a state vector from the final set of metrics,
generating a reward function from the final set of reward bases,
configuring a twin training agent with the set of actions, one or more functions that generate a state vector, and reward function,
executing the twin training agent in a training environment using a simulator, and
executing the twin training agent in a training-environment distributed computer system.
